(19) United States
(12) Patent Application Publication
(10) Pub. No.: US 2025/0245287 A1
(43) Pub. Date: Jul. 31, 2025

(54) INTERFACE CIRCUIT FOR STACK COMPRISING A PLURALITY OF VECTOR-BY-MATRIX MULTIPLICATION ARRAYS

(71) Applicant: Silicon Storage Technology, Inc., San Jose, CA (US)

(72) Inventor: Hieu Van Tran, San Jose, CA (US)

(21) Appl. No.: 18/623,985

(22) Filed: Apr. 1, 2024

Related U.S. Application Data
(60) Provisional application No. 63/625,200, filed on Jan. 25, 2024.

(51) Int. Cl. G06F 17/16

(52) U.S. Cl. CPC G06F 17/16

(57) ABSTRACT

In one example, a system comprises a first device; a first interface coupled to the first device and comprising one or more device control lines to identify a second device within a plurality of devices for which a communication is intended, the plurality of devices respectively containing vector-by-matrix multiplication arrays; and a stack comprising an interface circuit coupled to the first interface, the plurality of devices, and a second interface comprising lines compliant with a legacy standard, the second interface coupled between the interface circuit and the plurality of devices.

### PRIORITY CLAIM

This application claims priority to U.S. Provisional Patent Application No. 63/625,200, filed on Jan. 25, 2024, and titled “Interface for Artificial Neural Network Comprising a Three-Dimensional Integrated Circuit,” which is incorporated by reference herein.

### FIELD OF THE INVENTION

Numerous examples are disclosed of an interface circuit for an artificial neural network comprising a three-dimensional integrated circuit.

### BACKGROUND OF THE INVENTION

Artificial neural networks mimic biological neural networks (the central nervous systems of animals, in particular the brain) and are used to estimate or approximate functions that can depend on a large number of inputs and are generally unknown. Artificial neural networks generally include layers of interconnected “neurons” which exchange messages between each other.

FIG. 1 illustrates an artificial neural network, where the circles represent the inputs or layers of neurons. The connections (called synapses) are represented by arrows and have numeric weights that can be tuned based on experience. This makes neural networks adaptive to inputs and capable of learning. Typically, neural networks include a layer of multiple inputs. There are typically one or more intermediate layers of neurons, and an output layer of neurons that provide the output of the neural network. The neurons at each level individually or collectively make a decision based on the received data from the synapses.

One of the major challenges in the development of artificial neural networks for high-performance information processing is a lack of adequate hardware technology. Indeed, practical neural networks rely on a very large number of synapses, enabling high connectivity between neurons, i.e., a very high computational parallelism. In principle, such complexity can be achieved with digital supercomputers or specialized graphics processing unit clusters. However, in addition to high cost, these approaches also suffer from mediocre energy efficiency as compared to biological networks, which consume much less energy primarily because they perform low-precision analog computation. CMOS analog circuits have been used for artificial neural networks, but most CMOS-implemented synapses have been too bulky given the high number of neurons and synapses.

Applicant previously disclosed an artificial (analog) neural network that utilizes one or more non-volatile memory arrays as the synapses in U.S. Patent Application Publication 2017/0337466A1, which is incorporated by reference. The non-volatile memory arrays operate as an analog neural memory and comprise non-volatile memory cells arranged in rows and columns. The neural network includes a first plurality of synapses configured to receive a first plurality of inputs and to generate therefrom a first plurality of outputs, and a first plurality of neurons configured to receive the first plurality of outputs. The first plurality of synapses includes a plurality of memory cells, wherein each of the memory cells includes spaced apart source and drain regions formed in a semiconductor substrate with a channel region extending there between, a floating gate disposed over and insulated from a first portion of the channel region and a non-floating gate disposed over and insulated from a second portion of the channel region. Each of the plurality of memory cells store a weight value corresponding to a number of electrons on the floating gate. The plurality of memory cells multiply the first plurality of inputs by the stored weight values to generate the first plurality of outputs.

### Non-Volatile Memory Cells

Non-volatile memories are well known. For example, U.S. Pat. No. 5,029,130 (“the '130 patent”), which is incorporated herein by reference, discloses an array of split gate non-volatile memory cells, which are a type of flash memory cells. Such a memory cell 210 is shown in FIG. 2. Each memory cell 210 includes source region 14 and drain region 16 formed in semiconductor substrate 12, with channel region 18 there between. Floating gate 20 is formed over and insulated from (and controls the conductivity of) a first portion of the channel region 18, and over a portion of the source region 14. Word line terminal 22 (which is typically coupled to a word line) has a first portion that is disposed over and insulated from (and controls the conductivity of) a second portion of the channel region 18, and a second portion that extends up and over the floating gate 20. The floating gate 20 and word line terminal 22 are insulated from the substrate 12 by a gate oxide. Bitline 24 is coupled to drain region 16.

Memory cell 210 is erased (where electrons are removed from the floating gate) by placing a high positive voltage on the word line terminal 22, which causes electrons on the floating gate 20 to tunnel through the intermediate insulation from the floating gate 20 to the word line terminal 22 via Fowler-Nordheim (FN) tunneling.

Memory cell 210 is programmed by source side injection (SSI) with hot electrons (where electrons are placed on the floating gate) by placing a positive voltage on the word line terminal 22, and a positive voltage on the source region 14. Electron current will flow from the drain region 16 towards the source region 14. The electrons will accelerate and become heated when they reach the gap between the word line terminal 22 and the floating gate 20. Some of the heated electrons will be injected through the gate oxide onto the floating gate 20 due to the attractive electrostatic force from the floating gate 20.

Memory cell 210 is read by placing positive read voltages on the drain region 16 and word line terminal 22 (which turns on the portion of the channel region 18 under the word line terminal). If the floating gate 20 is positively charged (i.e., erased of electrons), then the portion of the channel region 18 under the floating gate 20 is turned on as well, and current will flow across the channel region 18, which is sensed as the erased or “1” state. If the floating gate 20 is negatively charged (i.e., programmed with electrons), then the portion of the channel region under the floating gate 20 is mostly or entirely turned off, and current will not flow (or there will be little flow) across the channel region 18, which is sensed as the programmed or “0” state.

Table No. 1 depicts typical voltage and current ranges that can be applied to the terminals of memory cell 210 for performing read, erase, and program operations:

TABLE NO 1
Operation of Flash Memory Cell 210 of FIG. 2

| | | |
|---|---|---|
| WL | BL | SL |

| | | | | | | |
|---|---|---|---|---|---|---|
| Read | 2-3 | V | 0.6-2 | V | 0 | V |
| Erase | ~11-13 | V | 0 | V | 0 | V |
| Program | 1-2 | V | 10.5-3 | μA | 9-10 | V |

Other split gate memory cell configurations, which are other types of flash memory cells, are known. For example, FIG. 3 depicts a four-gate memory cell 310 comprising source region 14, drain region 16, floating gate 20 over a first portion of channel region 18, a select gate 22 (typically coupled to a word line, WL) over a second portion of the channel region 18, a control gate 28 over the floating gate 20, and an erase gate 30 over the source region 14. This configuration is described in U.S. Pat. No. 6,747,310, which is incorporated herein by reference for all purposes. Here, all gates are non-floating gates except floating gate 20, meaning that they are electrically connected or connectable to a voltage source. Programming is performed by heated electrons from the channel region 18 injecting themselves onto the floating gate 20. Erasing is performed by electrons tunneling from the floating gate 20 to the erase gate 30.

Table No. 2 depicts typical voltage and current ranges that can be applied to the terminals of memory cell 310 for performing read, erase, and program operations:

TABLE NO 2
Operation of Flash Memory Cell 310 of FIG. 3

| | WL/SG | | BL | | CG | EG | | SL | |
|---|---|---|---|---|---|---|---|---|---|
| Read | 1.0-2 | V | 0.6-2 | V | 0-2.6 V | 0-2.6 | V | 0 | V |
| Erase | −0.5 V/0 V | | 0 | V | 0 V/−8 V | 8-12 | V | 0 | V |
| Program | 1 | V | 0.1-1 | μA | 8-11 V | 4.5-9 | V | 4.5-5 | V |

FIG. 4 depicts a three-gate memory cell 410, which is another type of flash memory cell. Memory cell 410 is identical to the memory cell 310 of FIG. 3 except that memory cell 410 does not have a separate control gate. The erase operation (whereby erasing occurs through use of the erase gate) and read operation are similar to that of the FIG. 3 except there is no control gate bias applied. The programming operation also is done without the control gate bias, and as a result, a higher voltage is applied on the source line during a program operation to compensate for a lack of control gate bias.

Table No. 3 depicts typical voltage and current ranges that can be applied to the terminals of memory cell 410 for performing read, erase, and program operations:

TABLE NO 3
Operation of Flash Memory Cell 410 of FIG. 4

| | | | |
|---|---|---|---|
| WL/SG | BL | EG | SL |

| | | | | | | | | |
|---|---|---|---|---|---|---|---|---|
| Read | 0.7-2.2 | V | 0.6-2 | V | 0-2.6 | V | 0 | V |

| | | | | | | | |
|---|---|---|---|---|---|---|---|
| Erase | −0.5 V/0 V | 0 | V | 11.5 | V | 0 | V |

| | | | | | | | | |
|---|---|---|---|---|---|---|---|---|
| Program | 1 | V | 0.2-3 | μA | 4.5 | V | 7-9 | V |

FIG. 5 depicts stacked gate memory cell 510, which is another type of flash memory cell. Memory cell 510 is similar to memory cell 210 of FIG. 2, except that floating gate 20 extends over the entire channel region 18, and control gate 22 (which here will be coupled to a word line) extends over floating gate 20, separated by an insulating layer (not shown). The erase is done by FN tunneling of electrons from FG to substrate, programming is by channel hot electron (CHE) injection at region between the channel 18 and the drain region 16, by the electrons flowing from the source region 14 towards to drain region 16 and read operation which is similar to that for memory cell 210 with a higher control gate voltage.

Table No. 4 depicts typical voltage ranges that can be applied to the terminals of memory cell 510 and substrate 12 for performing read, erase, and program operations:

TABLE NO 4
Operation of Flash Memory Cell 510 of FIG. 5

| | CG | BL | | SL | Substrate |
|---|---|---|---|---|---|
| Read | 2-5 V | 0.6-2 | V | 0 V | 0 V |
| Erase | −8 to −10 V/0 V | FLT | | FLT | 8-10 V/15-20 V |
| Program | 8-12 V | 3-5 | V | 0 V | 0 V |

The methods and means described herein may apply to other non-volatile memory technologies such as FINFET split gate flash or stack gate flash memory, NAND flash, SONOS (silicon-oxide-nitride-oxide-silicon, charge trap in nitride), MONOS (metal-oxide-nitride-oxide-silicon, metal charge trap in nitride), ReRAM (resistive random access memory), PCM (phase change memory), MRAM (magnetic ram), FeRAM (ferroelectric ram), CT (charge trap) memory, CN (carbon-tube) memory, OTP (bi-level or multi-level one time programmable), and CeRAM (correlated electron ram), without limitation.

In order to utilize the memory arrays comprising one of the types of non-volatile memory cells described above in an artificial neural network, two modifications are made. First, the lines are configured so that each memory cell can be individually programmed, erased, and read without adversely affecting the memory state of other memory cells in the array, as further explained below. Second, continuous (analog) programming of the memory cells is provided.

Specifically, the memory state (i.e., charge on the floating gate) of each memory cell in the array can be continuously changed from a fully erased state to a fully programmed state, and vice-versa, independently and with minimal disturbance of other memory cells. This means the cell storage is effectively analog or at the very least can store one of many discrete values (such as 16 or 64 different values), which allows for very precise and individual tuning of all the memory cells in the memory array, and which makes the memory array ideal for storing and making fine tuning adjustments to the synapsis weights of the neural network.

### Neural Networks Employing Non-Volatile Memory Cell Arrays

FIG. 6 conceptually illustrates a non-limiting example of a neural network utilizing a non-volatile memory array of the present examples. This example uses the non-volatile memory array neural network for a facial recognition application, but any other appropriate application could be implemented using a non-volatile memory array based neural network.

S0 is the input layer, which for this example is a 32×32 pixel RGB image with 5 bit precision (i.e. three 32×32 pixel arrays, one for each color R, G and B, each pixel being 5 bit precision). The synapses CB1 going from input layer S0 to layer C1 apply different sets of weights in some instances and shared weights in other instances and scan the input image with 3×3 pixel overlapping filters (kernel), shifting the filter by 1 pixel (or more than 1 pixel as dictated by the model). Specifically, values for 9 pixels in a 3×3 portion of the image (i.e., referred to as a filter or kernel) are provided to the synapses CB1, where these 9 input values are multiplied by the appropriate weights and, after summing the outputs of that multiplication, a single output value is determined and provided by a first synapse of CB1 for generating a pixel of one of the feature maps of layer C1. The 3×3 filter is then shifted one pixel to the right within input layer S0 (i.e., adding the column of three pixels on the right, and dropping the column of three pixels on the left), whereby the 9 pixel values in this newly positioned filter are provided to the synapses CB1, where they are multiplied by the same weights and a second single output value is determined by the associated synapse. This process is continued until the 3×3 filter scans across the entire 32×32 pixel image of input layer S0, for all three colors and for all bits (precision values). The process is then repeated using different sets of weights to generate a different feature map of layer C1, until all the features maps of layer C1 have been calculated.

In layer C1, in the present example, there are 16 feature maps, with 30×30 pixels each. Each pixel is a new feature pixel extracted from multiplying the inputs and kernel, and therefore each feature map is a two dimensional array, and thus in this example layer C1 constitutes 16 layers of two dimensional arrays (keeping in mind that the layers and arrays referenced herein are logical relationships that may or may not correspond to physical relationships—i.e., the arrays may not be oriented in physical two dimensional arrays). Each of the 16 feature maps in layer C1 is generated by one of sixteen different sets of synapse weights applied to the filter scans. The C1 feature maps could all be directed to different aspects of the same image feature, such as boundary identification. For example, the first map (generated using a first weight set, shared for all scans used to generate this first map) could identify circular edges, the second map (generated using a second weight set different from the first weight set) could identify rectangular edges, or the aspect ratio of certain features, and so on.

An activation function P1 (pooling) is applied before going from layer C1 to layer S1, which pools values from consecutive, non-overlapping 2×2 regions in each feature map. The purpose of the pooling function P1 is to average out the nearby location (or a max function can also be used), to reduce the dependence of the edge location for example and to reduce the data size before going to the next stage. At layer S1, there are 16 15×15 feature maps (i.e., sixteen different arrays of 15×15 pixels each). The synapses CB2 going from layer S1 to layer C2 scan maps in layer S1 with 4×4 filters, with a filter shift of 1 pixel. At layer C2, there are 22 12×12 feature maps. An activation function P2 (pooling) is applied before going from layer C2 to layer S2, which pools values from consecutive non-overlapping 2×2 regions in each feature map. At layer S2, there are 22 6×6 feature maps. An activation function (pooling) is applied at the synapses CB3 going from layer S2 to layer C3, where every neuron in layer C3 connects to every map in layer S2 via a respective synapse of CB3. At layer C3, there are 64 neurons. The synapses CB4 going from layer C3 to the output layer S3 fully connects C3 to S3, i.e. every neuron in layer C3 is connected to every neuron in layer S3. The output at S3 includes 10 neurons, where the highest output neuron determines the class. This output could, for example, be indicative of an identification or classification of the contents of the original image.

Each layer of synapses is implemented using an array, or a portion of an array, of non-volatile memory cells.

FIG. 7 is a block diagram of an array that can be used for that purpose. Vector-by-matrix multiplication (VMM) array 32 includes non-volatile memory cells and is utilized as the synapses (such as CB1, CB2, CB3, and CB4 in FIG. 6) between one layer and the next layer. Specifically, VMM array 32 includes an array of non-volatile memory cells 33, erase gate and word line gate decoder 34, control gate decoder 35, bit line decoder 36 and source line decoder 37, which decode the respective inputs for the non-volatile memory cell array 33. Input to VMM array 32 can be from the erase gate and wordline gate decoder 34 or from the control gate decoder 35. Source line decoder 37 in this example also decodes the output of the non-volatile memory cell array 33. Alternatively, bit line decoder 36 can decode the output of the non-volatile memory cell array 33.

Non-volatile memory cell array 33 serves two purposes. First, it stores the weights that will be used by the VMM array 32. Second, the non-volatile memory cell array 33 effectively multiplies the inputs by the weights stored in the non-volatile memory cell array 33 and adds them up per output line (source line or bit line) to produce the output, which will be the input to the next layer or input to the final layer. By performing the multiplication and addition function, the non-volatile memory cell array 33 negates the need for separate multiplication and addition logic circuits and is also power efficient due to its in-situ memory computation.

The output of non-volatile memory cell array 33 is supplied to a differential summer (such as a summing op-amp or a summing current mirror) 38, which sums up the outputs of the non-volatile memory cell array 33 to create a single value for that convolution. The differential summer 38 is arranged to perform summation of positive weight and negative weight.

The summed-up output values of differential summer 38 are then supplied to an activation function block 39, which rectifies the output. The activation function block 39 may provide sigmoid, tan h, or ReLU functions. The rectified output values of activation function block 39 become an element of a feature map as the next layer (e.g. C1 in FIG. 6), and are then applied to the next synapse to produce the next feature map layer or final layer. Therefore, in this example, non-volatile memory cell array 33 constitutes a plurality of synapses (which receive their inputs from the prior layer of neurons or from an input layer such as an image database), and summing op-amp 38 and activation function block 39 constitute a plurality of neurons.

The input to VMM array 32 in FIG. 7 (WLx, Egx, CGx, and optionally BLx and SLx) can be analog level, binary level, or digital bits (in which case a DAC is provided to convert digital bits to appropriate input analog level) and the output can be analog level, binary level, or digital bits (in which case an output ADC is provided to convert output analog level into digital bits).

FIG. 8 is a block diagram depicting the usage of numerous layers of VMM arrays 32, here labeled as VMM arrays 32a, 32b, 32c, 32d, and 32e. As shown in FIG. 8, the input, denoted Inputx, is converted from digital to analog by a digital-to-analog converter 31 and provided to input VMM array 32a. The converted analog inputs could be voltage or current. The input D/A conversion for the first layer could be done by using a function or a LUT (look up table) that maps the inputs Inputx to appropriate analog levels for the matrix multiplier of input VMM array 32a. The input conversion could also be done by an analog to analog (A/A) converter to convert an external analog input to a mapped analog input to the input VMM array 32a.

The output generated by input VMM array 32a is provided as an input to the next VMM array (hidden level 1) 32b, which in turn generates an output that is provided as an input to the next VMM array (hidden level 2) 32c, and so on. The various layers of VMM array 32 function as different layers of synapses and neurons of a convolutional neural network (CNN). Each VMM array 32a, 32b, 32c, 32d, and 32e can be a stand-alone, physical non-volatile memory array, or multiple VMM arrays could utilize different portions of the same physical non-volatile memory array, or multiple VMM arrays could utilize overlapping portions of the same physical non-volatile memory array. The example shown in FIG. 8 contains five layers (32a,32b,32c,32d,32e): one input layer (32a), two hidden layers (32b,32c), and two fully connected layers (32d,32e). One of ordinary skill in the art will appreciate that this is merely an example and that a system instead could comprise more than two hidden layers and more than two fully connected layers.

### Vector-by-Matrix Multiplication (VMM) Arrays

FIG. 9 depicts neuron VMM array 900, which is particularly suited for memory cells 310 as shown in FIG. 3 and is utilized as the synapses and parts of neurons between an input layer and the next layer. VMM array 900 comprises memory array 901 of non-volatile memory cells and reference array 902 (at the top of the array) of non-volatile reference memory cells. Alternatively, another reference array can be placed at the bottom.

In VMM array 900, control gate lines, such as control gate line 903, run in a vertical direction (hence reference array 902 in the row direction is orthogonal to control gate line 903), and erase gate lines, such as erase gate line 904, run in a horizontal direction. Here, the inputs to VMM array 900 are provided on the control gate lines (CG0, CG1, CG2, CG3), and the output of VMM array 900 emerges on the source lines (SL0, SL1). In one example, only even rows are used, and in another example, only odd rows are used. The current placed on each source line (SL0, SL1, respectively) performs a summing function of all the currents from the memory cells connected to that particular source line.

As described herein for neural networks, the non-volatile memory cells of VMM array 900, i.e., the memory cells 310 of VMM array 900, may be configured to operate in a sub-threshold region.

The non-volatile reference memory cells and the non-volatile memory cells described herein are biased in weak inversion (sub threshold region):

$$Ids = Io * {e}^{( Vg - Vth ) / nVt} = w * Io * {e}^{( Vg ) / nVt} ,$$

$$where w = {e}^{( - Vth ) / nVt}$$

where Ids is the drain to source current; Vg is gate voltage on the memory cell; Vth is threshold voltage of the memory cell; Vt is thermal voltage=k*T/q with k being the Boltzmann constant, T the temperature in Kelvin, and q the electronic charge; n is a slope factor=1+ (Cdep/Cox) with Cdep=capacitance of the depletion layer, and Cox capacitance of the gate oxide layer; Io is the memory cell current at gate voltage equal to threshold voltage, Io is proportional to (Wt/L)*u*Cox*(n−1)*Vt² where u is carrier mobility and Wt and L are width and length, respectively, of the memory cell.

For an I-to-V log converter using a memory cell (such as a reference memory cell or a peripheral memory cell) or a transistor to convert input current into an input voltage:

$$Vg = n * Vt * log [ Ids / wp * Io ]$$

where, wp is w of a reference or peripheral memory cell.

For a memory array used as a vector matrix multiplier VMM array with the current input, the output current is:

$$Iout = wa * Io * {e}^{( Vg ) / nVt} , namely$$

$$Iout = ( wa / wp ) * Iin = W * Iin$$

$$W = {e}^{( Vthp - Vtha ) / nVt}$$

Here, wa=w of each memory cell in the memory array.
Vthp is effective threshold voltage of the peripheral memory cell and Vtha is effective threshold voltage of the main (data) memory cell. Note that the threshold voltage of a transistor is a function of substrate body bias voltage and the substrate body bias voltage, denoted Vsb, can be modulated to compensate for various conditions, on such temperature. The threshold voltage Vth can be expressed as:

$$Vth = Vth 0 + gamma ( SQRT \vert Vsb - 2 * φ F ) - SQRT \vert 2 * φ F )$$

where Vth0 is threshold voltage with zero substrate bias, oF is a surface potential, and gamma is a body effect parameter.

A wordline or control gate can be used as the input for the memory cell for the input voltage.

Alternatively, the flash memory cells of VMM arrays described herein can be configured to operate in the linear region:

$$Ids = beta * ( Vgs - Vth ) * Vds ; beta = u * Cox * Wt / L$$

$$W = α ( Vgs - Vth )$$

meaning weight W in the linear region is proportional to (Vgs-Vth)

A wordline or control gate or bitline or sourceline can be used as the input for the memory cell operated in the linear region. The bitline or sourceline can be used as the output for the memory cell.

For an I-to-V linear converter, a memory cell (such as a reference memory cell or a peripheral memory cell) or a transistor operating in the linear region can be used to linearly convert an input/output current into an input/output voltage.

Alternatively, the memory cells of VMM arrays described herein can be configured to operate in the saturation region:

$$Ids = 1 / 2 * beta * {( Vgs - Vth )}^{2} ; beta = u * Cox * Wt / L$$

$$W {α ( Vgs - Vth )}^{2} , meaning weight W is proportional to {( Vgs - Vth )}^{2}$$

A wordline, control gate, or erase gate can be used as the input for the memory cell operated in the saturation region. The bitline or sourceline can be used as the output for the output neuron.

Alternatively, the memory cells of VMM arrays described herein can be used in all regions or a combination thereof (sub threshold, linear, or saturation) for each layer or multi layers of a neural network.

Other examples for VMM array 32 of FIG. 7 are described in U.S. Pat. No. 10,748,630, which is incorporated by reference herein. As described in that application. A sourceline or a bitline can be used as the neuron output (current summation output).

FIG. 10 depicts neuron VMM array 1000, which is particularly suited for memory cells 210 as shown in FIG. 2 and is utilized as the synapses between an input layer and the next layer. VMM array 1000 comprises a memory array 1003 of non-volatile memory cells, reference array 1001 of first non-volatile reference memory cells, and reference array 1002 of second non-volatile reference memory cells. Reference arrays 1001 and 1002, arranged in the column direction of the array, serve to convert current inputs flowing into terminals BLR0, BLR1, BLR2, and BLR3 into voltage inputs WL0, WL1, WL2, and WL3. In effect, the first and second non-volatile reference memory cells are diode-connected through multiplexors 1014 (partially depicted) with current inputs flowing into them. The reference cells are tuned (e.g., programmed) to target reference levels. The target reference levels are provided by a reference mini-array matrix (not shown).

Memory array 1003 serves two purposes. First, it stores the weights that will be used by the VMM array 1000 on respective memory cells thereof. Second, memory array 1003 effectively multiplies the inputs (i.e. current inputs provided in terminals BLR0, BLR1, BLR2, and BLR3, which reference arrays 1001 and 1002 convert into the input voltages to supply to wordlines WL0, WL1, WL2, and WL3) by the weights stored in the memory array 1003 and then adds all the results (memory cell currents) to produce the output on the respective bit lines (BL0-BLN), which will be the input to the next layer or input to the final layer. By performing the multiplication and addition function, memory array 1003 negates the need for separate multiplication and addition logic circuits and is also power efficient. Here, the voltage inputs are provided on the word lines WL0, WL1, WL2, and WL3, and the output emerges on the respective bit lines BL0-BLN during a read (inference) operation. The current placed on each of the bit lines BL0-BLN performs a summing function of the currents from all non-volatile memory cells connected to that particular bitline.

Table No. 5 depicts operating voltages and currents for VMM array 1000. The columns in the table indicate the voltages placed on word lines for selected cells, word lines for unselected cells, bit lines for selected cells, bit lines for unselected cells, source lines for selected cells, and source lines for unselected cells. The rows indicate the operations of read, erase, and program.

TABLE NO 5
Operation of VMM Array 1000 of FIG. 10:

| | WL | WL -unsel | BL | | BL -unsel | SL | SL -unsel |
|---|---|---|---|---|---|---|---|
| Read | 1-3.5 V | −0.5 V/0 V | 0.6-2 V | | 0.6 V-2 V/0 V | 0 V | 0 V |
| | | | (Ineuron) | | | | |
| Erase | ~5-13 V | 0 V | 0 | V | 0 V | 0 V | 0 V |
| Program | 1-2 V | −0.5 V/0 V | 0.1-3 | uA | Vinh ~2.5 V | 4-10 V | 0-1 V/FLT |

FIG. 11 depicts neuron VMM array 1100, which is particularly suited for memory cells 210 as shown in FIG. 2 and is utilized as the synapses and parts of neurons between an input layer and the next layer. VMM array 1100 comprises a memory array 1103 of non-volatile memory cells, reference array 1101 of first non-volatile reference memory cells, and reference array 1102 of second non-volatile reference memory cells. Reference arrays 1101 and 1102 run in row direction of the VMM array 1100. VMM array is similar to VMM 1000 except that in VMM array 1100, the word lines run in the vertical direction. Here, the inputs are provided on the word lines (WLA0, WLB0, WLA1, WLB2, WLA2, WLB2, WLA3, WLB3), and the output emerges on the source line (SL0, SL1) during a read operation. The current placed on each source line performs a summing function of all the currents from the memory cells connected to that particular source line.

Table No. 6 depicts operating voltages and currents for VMM array 1100. The columns in the table indicate the voltages placed on word lines for selected cells, word lines for unselected cells, bit lines for selected cells, bit lines for unselected cells, source lines for selected cells, and source lines for unselected cells. The rows indicate the operations of read, erase, and program.

TABLE NO 6
Operation of VMM Array 1100 of FIG. 11

| | WL | WL -unsel | BL | | BL -unsel | SL | | SL -unsel |
|---|---|---|---|---|---|---|---|---|
| Read | 1-3.5 V | −0.5 V/0 V | 0.6-2 | V | 0.6 V-2 V/0 V | ~0.3-1 V | | 0 V |
| | | | | | | (Ineuron) | | |
| Erase | ~5-13 V | 0 V | 0 | V | 0 V | 0 | V | SL-inhibit |
| | | | | | | | | (~4-8 V) |
| Program | 1-2 V | −0.5 V/0 V | 0.1-3 | uA | Vinh ~2.5 V | 4-10 | V | 0-1 V/FLT |

FIG. 12 depicts neuron VMM array 1200, which is particularly suited for memory cells 310 as shown in FIG. 3 and is utilized as the synapses and parts of neurons between an input layer and the next layer. VMM array 1200 comprises a memory array 1203 of non-volatile memory cells, reference array 1201 of first non-volatile reference memory cells, and reference array 1202 of second non-volatile reference memory cells. Reference arrays 1201 and 1202 serve to convert current inputs flowing into terminals BLR0, BLR1, BLR2, and BLR3 into voltage inputs CG0, CG1, CG2, and CG3. In effect, the first and second non-volatile reference memory cells are diode-connected through multiplexors 1212 (partially shown) with current inputs flowing into them through BLR0, BLR1, BLR2, and BLR3. Multiplexors 1212 each include a respective multiplexor 1205 and a cascoding transistor 1204 to ensure a constant voltage on the bitline (such as BLR0) of each of the first and second non-volatile reference memory cells during a read operation. The reference cells are tuned to target reference levels.

Memory array 1203 serves two purposes. First, it stores the weights that will be used by the VMM array 1200. Second, memory array 1203 effectively multiplies the inputs (current inputs provided to terminals BLR0, BLR1, BLR2, and BLR3, for which reference arrays 1201 and 1202 convert these current inputs into the input voltages to supply to the control gates (CG0, CG1, CG2, and CG3) by the weights stored in the memory array and then add all the results (cell currents) to produce the output, which appears on BL0-BLN, and will be the input to the next layer or input to the final layer. By performing the multiplication and addition function, the memory array negates the need for separate multiplication and addition logic circuits and is also power efficient. Here, the inputs are provided on the control gate lines (CG0, CG1, CG2, and CG3), and the output emerges on the bit lines (BL0-BLN) during a read operation. The current placed on each bitline performs a summing function of all the currents from the memory cells connected to that particular bitline.

VMM array 1200 implements uni-directional tuning for non-volatile memory cells in memory array 1203. That is, each non-volatile memory cell is erased and then partially programmed until the desired charge on the floating gate is reached. If too much charge is placed on the floating gate (such that the wrong value is stored in the cell), the cell is erased and the sequence of partial programming operations starts over. As shown, two rows sharing the same erase gate (such as EG0 or EG1) are erased together (which is known as a page erase), and thereafter, each cell is partially programmed until the desired charge on the floating gate is reached.

Table No. 7 depicts operating voltages and currents for VMM array 1200. The columns in the table indicate the voltages placed on word lines for selected cells, word lines for unselected cells, bit lines for selected cells, bit lines for unselected cells, control gates for selected cells, control gates for unselected cells in the same sector as the selected cells, control gates for unselected cells in a different sector than the selected cells, erase gates for selected cells, erase gates for unselected cells, source lines for selected cells, and source lines for unselected cells. The rows indicate the operations of read, erase, and program.

TABLE NO 7
Operation of VMM Array 1200 of FIG. 12

| | | | | | | | CG - | | | | | |
|---|---|---|---|---|---|---|---|---|---|---|---|---|
| | | | | | | | unsel | | | | | |
| | | WL - | | | BL - | | same | CG - | | EG - | | SL - |
| | WL | unsel | BL | | unsel | CG | sector | unsel | EG | unsel | SL | unsel |
| Read | 1.0-2 V | −0.5 V/0 V | 0.6-2 V | | 0 V | 0-2.6 V | 0-2.6 V | 0-2.6 V | 0-2.6 V | 0-2.6 V | 0 V | 0 V |
| | | | (Ineuron) | | | | | | | | | |
| Erase | 0 V | 0 V | 0 | V | 0 V | 0 V | 0-2.6 V | 0-2.6 V | 5-12 V | 0-2.6 V | 0 V | 0 V |
| Program | 0.7-1 V | −0.5 V/0 V | 0.1-1 | uA | Vinh | 4-11 V | 0-2.6 V | 0-2.6 V | 4.5-5 V | 0-2.6 V | 4.5-5 V | 0-1 V |
| | | | | | (1-2 V) | | | | | | | |

FIG. 13 depicts neuron VMM array 1300, which is particularly suited for memory cells 310 as shown in FIG. 3, and is utilized as the synapses and parts of neurons between an input layer and the next layer. VMM array 1300 comprises a memory array 1303 of non-volatile memory cells, reference array 1301 or first non-volatile reference memory cells, and reference array 1302 of second non-volatile reference memory cells. EG lines EGR0, EG0, EG1 and EGR1 are run vertically while CG lines CG0, CG1, CG2 and CG3 and SL lines WL0, WL1, WL2 and WL3 are run horizontally. VMM array 1300 is similar to VMM array 1400, except that VMM array 1300 implements bi-directional tuning, where each individual cell can be completely erased, partially programmed, and partially erased as needed to reach the desired amount of charge on the floating gate due to the use of separate EG lines. As shown, reference arrays 1301 and 1302 convert input current in the terminal BLR0, BLR1, BLR2, and BLR3 into control gate voltages CG0, CG1, CG2, and CG3 (through the action of diode-connected reference cells through multiplexors 1314) to be applied to the memory cells in the row direction. The current output (neuron) is in the bit lines BL0-BLN, where each bit line sums all currents from the non-volatile memory cells connected to that particular bitline.

Table No. 8 depicts operating voltages and currents for VMM array 1300. The columns in the table indicate the voltages placed on word lines for selected cells, word lines for unselected cells, bit lines for selected cells, bit lines for unselected cells, control gates for selected cells, control gates for unselected cells in the same sector as the selected cells, control gates for unselected cells in a different sector than the selected cells, erase gates for selected cells, erase gates for unselected cells, source lines for selected cells, and source lines for unselected cells. The rows indicate the operations of read, erase, and program.

TABLE NO 8
Operation of VMM Array 1300 of FIG. 13

| | | | | | | | CG -unsel | | | | | |
|---|---|---|---|---|---|---|---|---|---|---|---|---|
| | | WL - | | | BL - | | same | CG - | | EG - | | SL - |
| | WL | unsel | BL | | unsel | CG | sector | unsel | EG | unsel | SL | unsel |
| Read | 1.0-2 V | −0.5 V/0 V | 0.6-2 V | | | | 0-2.6 V | 0-2.6 V | 0-2.6 V | 0-2.6 V | 0 V | 0 V |
| | | | (Ineuron) | | 0 V | 0-2.6 V | | | | | | |
| Erase | 0 V | 0 V | 0 | V | 0 V | 0 V | 4-9 V | 0-2.6 V | 5-12 V | 0-2.6 V | 0 V | 0 V |
| Program | 0.7-1 V | −0.5 V/0 V | 0.1-1 | uA | Vinh | 4-11 V | 0-2.6 V | 0-2.6 V | 4.5-5 V | 0-2.6 V | 4.5-5 V | 0-1 V |
| | | | | | (1-2 V) | | | | | | | |

FIG. 22 depicts neuron VMM array 2200, which is particularly suited for memory cells 210 as shown in FIG. 2 and is utilized as the synapses and parts of neurons between an input layer and the next layer. In VMM array 2200, the inputs INPUT₀ . . . , INPUT_{N} are received on bit lines BL₀, . . . . BL_{N}, respectively, and the outputs OUTPUT₁, OUTPUT₂, OUTPUT₃, and OUTPUT₄ are generated on source lines SL₀, SL₁, SL₂, and SL₃, respectively.

FIG. 23 depicts neuron VMM array 2300, which is particularly suited for memory cells 210 as shown in FIG. 2 and is utilized as the synapses and parts of neurons between an input layer and the next layer. In this example, the inputs INPUT₀, INPUT₁, INPUT₂, and INPUT₃ are received on source lines SL₀, SL₁, SL₂, and SL₃, respectively, and the outputs OUTPUT₀, . . . . OUTPUT_{N} are generated on bit lines BL₀, . . . , BL_{N}.

FIG. 24 depicts neuron VMM array 2400, which is particularly suited for memory cells 210 as shown in FIG. 2, and is utilized as the synapses and parts of neurons between an input layer and the next layer. In this example, the inputs INPUT₀, . . . , INPUT_{M} are received on word lines WL₀, . . . , WL_{M}, respectively, and the outputs OUTPUT₀, . . . . OUTPUT_{N} are generated on bit lines BL₀, . . . , BL_{N}.

FIG. 25 depicts neuron VMM array 2500, which is particularly suited for memory cells 310 as shown in FIG. 3, and is utilized as the synapses and parts of neurons between an input layer and the next layer. In this example, the inputs INPUT₀, . . . , INPUT_{M} are received on word lines WL₀, . . . , WL_{M}, respectively, and the outputs OUTPUT₀, . . . . OUTPUT_{N} are generated on bit lines BL₀, . . . , BL_{N}.

FIG. 26 depicts neuron VMM array 2600, which is particularly suited for memory cells 410 as shown in FIG. 4, and is utilized as the synapses and parts of neurons between an input layer and the next layer. In this example, the inputs INPUT₀, . . . , INPUTₙ are received on vertical control gate lines CG₀, . . . , CG_{N}, respectively, and the outputs OUTPUT₁ and OUTPUT₂ are generated on source lines SL₀ and SL₁.

FIG. 27 depicts neuron VMM array 2700, which is particularly suited for memory cells 410 as shown in FIG. 4 and is utilized as the synapses and parts of neurons between an input layer and the next layer. In this example, the inputs INPUT₀, . . . , INPUT_{N} are received on the gates of bit line control gates 2701-1, 2701-2, . . . , 2701-(N−1), and 2701-N, respectively, which are coupled to bit lines BL₀, . . . , BL_{N}, respectively. Example outputs OUTPUT₁ and OUTPUT₂ are generated on source lines SL₀ and SL₁.

FIG. 28 depicts neuron VMM array 2800, which is particularly suited for memory cells 310 as shown in FIG. 3, memory cells 510 as shown in FIG. 5, and memory cells 710 as shown in FIG. 7, and is utilized as the synapses and parts of neurons between an input layer and the next layer. In this example, the inputs INPUT₀, . . . , INPUT_{M} are received on word lines WL₀, . . . , WL_{M}, and the outputs OUTPUT₀, . . . , OUTPUT_{N} are generated on bit lines BL₀, . . . , BL_{N}, respectively.

FIG. 29 depicts neuron VMM array 2900, which is particularly suited for memory cells 310 as shown in FIG. 3, memory cells 510 as shown in FIG. 5, and memory cells 710 as shown in FIG. 7, and is utilized as the synapses and parts of neurons between an input layer and the next layer. In this example, the inputs INPUT₀, . . . , INPUT_{M} are received on control gate lines CG₀, . . . , CG_{M}. Outputs OUTPUT₀, . . . , OUTPUT_{N} are generated on vertical source lines SL₀, . . . , SL_{N}, respectively, where each source line SLᵢ is coupled to the source lines of all memory cells in column i.

FIG. 30 depicts neuron VMM array 3000, which is particularly suited for memory cells 310 as shown in FIG. 3, memory cells 510 as shown in FIG. 5, and memory cells 710 as shown in FIG. 7, and is utilized as the synapses and parts of neurons between an input layer and the next layer. In this example, the inputs INPUT₀, . . . , INPUT_{M} are received on control gate lines CG₀, . . . , CG_{M}. Outputs OUTPUT₀, . . . , OUTPUT_{N} are generated on vertical bit lines BL₀, . . . , BL_{N}, respectively, where each bit line BLᵢ is coupled to the bit lines of all memory cells in column i.

### Long Short-Term Memory

The prior art includes a concept known as long short-term memory (LSTM). LSTM units often are used in neural networks. LSTM allows a neural network to remember information over predetermined arbitrary time intervals and to use that information in subsequent operations. A conventional LSTM unit comprises a cell, an input gate, an output gate, and a forget gate. The three gates regulate the flow of information into and out of the cell and the time interval that the information is remembered in the LSTM. VMMs are particularly useful in LSTM units.

FIG. 14 depicts an example LSTM 1400. LSTM 1400 in this example comprises cells 1401, 1402, 1403, and 1404. Cell 1401 receives input vector x₀ and generates output vector h₀ and cell state vector c₀. Cell 1402 receives input vector x₁, the output vector (hidden state) h₀ from cell 1401 and cell state c₀ from cell 1401 and generates output vector h₁ and cell state vector c₁. Cell 1403 receives input vector x₂, the output vector (hidden state) h₁ from cell 1402, and cell state c₁ from cell 1402 and generates output vector h₂ and cell state vector c₂. Cell 1404 receives input vector x₃, the output vector (hidden state) h₂ from cell 1403, and cell state c₂ from cell 1403 and generates output vector h₃. Additional cells can be used, and an LSTM with four cells is merely an example.

FIG. 15 depicts an example implementation of an LSTM cell 1500, which can be used for cells 1401, 1402, 1403, and 1404 in FIG. 14. LSTM cell 1500 receives input vector x(t), cell state vector c(t−1) from a preceding cell, and output vector h(t−1) from a preceding cell, and generates cell state vector c(t) and output vector h(t).

LSTM cell 1500 comprises sigmoid function devices 1501, 1502, and 1503, each of which applies a number between 0 and 1 to control how much of each component in the input vector is allowed through to the output vector. LSTM cell 1500 also comprises tan h devices 1504 and 1505 to apply a hyperbolic tangent function to an input vector, multiplier devices 1506, 1507, and 1508 to multiply two vectors together, and addition device 1509 to add two vectors together. Output vector h (t) can be provided to the next LSTM cell in the system, or it can be accessed for other purposes.

FIG. 16 depicts an LSTM cell 1600, which is an example of an implementation of LSTM cell 1500. For the reader's convenience, the same numbering from LSTM cell 1500 is used in LSTM cell 1600. Sigmoid function devices 1501, 1502, and 1503 and tan h device 1504 each comprise multiple VMM arrays 1601 and activation function blocks 1602. Thus, it can be seen that VMM arrays are particular useful in LSTM cells used in certain neural network systems. The multiplier devices 1506, 1507, and 1508 and the addition device 1509 are implemented in a digital manner or in an analog manner. The activation function blocks 1602 can be implemented in a digital manner or in an analog manner.

An alternative to LSTM cell 1600 (and another example of an implementation of LSTM cell 1500) is shown in FIG. 17. In FIG. 17, sigmoid function devices 1501, 1502, and 1503 and tan h device 1504 share the same physical hardware (VMM arrays 1701 and activation function block 1702) in a time-multiplexed fashion. LSTM cell 1700 also comprises multiplier device 1703 to multiply two vectors together, addition device 1708 to add two vectors together, tan h device 1505 (which comprises activation function block 1702), register 1707 to store the value i(t) when i(t) is output from sigmoid function block 1702, register 1704 to store the value f(t)*c(t−1) when that value is output from multiplier device 1703 through multiplexor 1710, register 1705 to store the value i(t)*u(t) when that value is output from multiplier device 1703 through multiplexor 1710, and register 1706 to store the value o(t)*c˜(t) when that value is output from multiplier device 1703 through multiplexor 1710, and multiplexor 1709.

Whereas LSTM cell 1600 contains multiple sets of VMM arrays 1601 and respective activation function blocks 1602, LSTM cell 1700 contains one set of VMM arrays 1701 and activation function block 1702, which are used to represent multiple layers in the example of LSTM cell 1700. LSTM cell 1700 will require less space than LSTM 1600, as LSTM cell 1700 will require ¼ as much space for VMMs and activation function blocks compared to LSTM cell 1600.

It can be further appreciated that LSTM units will typically comprise multiple VMM arrays, each of which uses functionality provided by certain circuit blocks outside of the VMM arrays, such as a summer and activation function block and high voltage generation blocks. Providing separate circuit blocks for each VMM array would require a significant amount of space within the semiconductor device and would be somewhat inefficient. The examples described below therefore reduce the circuitry present outside of the VMM arrays themselves.

### Gated Recurrent Units

An analog VMM implementation can be utilized for a GRU (gated recurrent unit) system. GRUs are a gating mechanism in recurrent neural networks. GRUs are similar to LSTMs, except that GRU cells generally contain fewer components than an LSTM cell.

FIG. 18 depicts an example GRU 1800. GRU 1800 in this example comprises cells 1801, 1802, 1803, and 1804. Cell 1801 receives input vector x₀ and generates output vector h₀. Cell 1802 receives input vector x₁, the output vector h₀ from cell 1801 and generates output vector h₁. Cell 1803 receives input vector x₂ and the output vector (hidden state) h₁ from cell 1802 and generates output vector h₂. Cell 1804 receives input vector x₃ and the output vector (hidden state) h₂ from cell 1803 and generates output vector h₃. Additional cells can be used, and an GRU with four cells is merely an example.

FIG. 19 depicts an example implementation of a GRU cell 1900, which can be used for cells 1801, 1802, 1803, and 1804 of FIG. 18. GRU cell 1900 receives input vector x(t) and output vector h(t−1) from a preceding GRU cell and generates output vector h(t). GRU cell 1900 comprises sigmoid function devices 1901 and 1902, each of which applies a number between 0 and 1 to components from output vector h(t−1) and input vector x(t). GRU cell 1900 also comprises a tan h device 1903 to apply a hyperbolic tangent function to an input vector, a plurality of multiplier devices 1904, 1905, and 1906 to multiply two vectors together, an addition device 1907 to add two vectors together, and a complementary device 1908 to subtract an input from 1 to generate an output.

FIG. 20 depicts a GRU cell 2000, which is an example of an implementation of GRU cell 1900. For the reader's convenience, the same numbering from GRU cell 1900 is used in GRU cell 2000. As can be seen in FIG. 20, sigmoid function devices 1901 and 1902, and tan h device 1903 each comprise multiple VMM arrays 2001 and activation function blocks 2002. Thus, it can be seen that VMM arrays are of particular use in GRU cells used in certain neural network systems. The multiplier devices 1904, 1905, 1906, the addition device 1907, and the complementary device 1908 are implemented in a digital manner or in an analog manner. The activation function blocks 2002 can be implemented in a digital manner or in an analog manner.

An alternative to GRU cell 2000 (and another example of an implementation of GRU cell 1900) is shown in FIG. 21. In FIG. 21, GRU cell 2100 utilizes VMM arrays 2101 and activation function block 2102, which when configured as a sigmoid function applies a number between 0 and 1 to control how much of each component in the input vector is allowed through to the output vector. In FIG. 21, sigmoid function devices 1901 and 1902 and tan h device 1903 share the same physical hardware (VMM arrays 2101 and activation function block 2102) in a time-multiplexed fashion. GRU cell 2100 also comprises multiplier device 2103 to multiply two vectors together, addition device 2105 to add two vectors together, complementary device 2109 to subtract an input from 1 to generate an output, multiplexor 2104, register 2106 to hold the value h(t−1)*r(t) when that value is output from multiplier device 2103 through multiplexor 2104, register 2107 to hold the value h(t−1)*z(t) when that value is output from multiplier device 2103 through multiplexor 2104, and register 2108 to hold the value h\hat{ }(t)*(1−z(t)) when that value is output from multiplier device 2103 through multiplexor 2104.

Whereas GRU cell 2000 contains multiple sets of VMM arrays 2001 and activation function blocks 2002, GRU cell 2100 contains one set of VMM arrays 2101 and activation function block 2102, which are used to represent multiple layers in the example of GRU cell 2100. GRU cell 2100 will require less space than GRU cell 2000, as GRU cell 2100 will require ⅓ as much space for VMMs and activation function blocks compared to GRU cell 2000.

It can be further appreciated that GRU systems will typically comprise multiple VMM arrays, each of which uses functionality provided by certain circuit blocks outside of the VMM arrays, such as a summer and activation function block and high voltage generation blocks. Providing separate circuit blocks for each VMM array would require a significant amount of space within the semiconductor device and would be somewhat inefficient. The examples described below therefore reduce the circuitry present outside of the VMM arrays themselves.

### Transformer

The prior art includes a concept known as a transformer neural network, which is another architecture for a neural network. FIG. 63 depicts an example of transformer neural network 6300. The transformer neural network was discussed in “Attention is All You Need” by Ashish Vaswani, et al. The transformer connects and encoder and a decoder through an attention function. An example of an attention function is:

$$Attention ( Q , K , V ) = soft max ( {QK}^{T} / \sqrt{dk} ) V$$

Notably, the transformer neural network can be implemented using VMMs. Specifically, a VMM can be used to perform a multiplication (Q*K_{T})*V, where Q is a matrix representing a query, K is a matrix of keys, V is a matrix of values where each value forms a key-value pair with a key in K. Optionally, the VMM is a dynamic matrix multiplier.

### Other Architectural Aspects

The input to the VMM arrays can be an analog level, a binary level, a pulse, a time modulated pulse, or digital bits (in this case a DAC is used to convert digital bits to appropriate input analog level) and the output can be an analog level, a binary level, a timing pulse, pulses, or digital bits (in this case an output ADC is used to convert output analog level into digital bits).

In general, for each memory cell in a VMM array, each weight W can be implemented by a single memory cell or by a differential cell or by two blend memory cells (average of 2 cells). In the differential cell case, two memory cells are used to implement a weight W as a differential weight (W=W+−W−). In the two blend memory cells, two memory cells are used to implement a weight W as an average of two cells.

FIG. 31 depicts VMM system 3100. In some examples, the weights, W, stored in a VMM array are stored as differential pairs, W+ (positive weight) and W− (negative weight), where W=(W+)−(W−). In VMM system 3100, half of the bit lines are designated as W+ lines, that is, bit lines connecting to memory cells that will store positive weights W+, and the other half of the bit lines are designated as W-lines, that is, bit lines connecting to memory cells implementing negative weights W−. The W− lines are interspersed among the W+ lines in an alternating fashion. The subtraction operation is performed by a summation circuit that receives current from a W+ line and a W− line, such as summation circuits 3101 and 3102. The output of a W+ line and the output of a W− line are combined together to give effectively W=W+−W− for each pair of (W+, W−) cells for all pairs of (W+, W−) lines. While the above has been described in relation to W− lines interspersed among the W+ lines in an alternating fashion, in other examples W+ lines and W− lines can be arbitrarily located anywhere in the array.

FIG. 32 depicts another example. In VMM system 3210, positive weights W+ are implemented in first array 3211 and negative weights W− are implemented in a second array 3212, second array 3212 separate from the first array, and the resulting weights are appropriately combined together by summation circuits 3213.

FIG. 33 depicts VMM system 3300. The weights, W, stored in a VMM array are stored as differential pairs, W+ (positive weight) and W− (negative weight), where W=(W+)−(W−). VMM system 3300 comprises array 3301 and array 3302. Half of the bit lines in each of array 3301 and 3302 are designated as W+ lines, that is, bit lines connecting to memory cells that will store positive weights W+, and the other half of the bit lines in each of array 3301 and 3302 are designated as W− lines, that is, bit lines connecting to memory cells implementing negative weights W−. The W− lines are interspersed among the W+ lines in an alternating fashion. The subtraction operation is performed by a summation circuit that receives current from a W+ line and a W− line, such as summation circuits 3303, 3304, 3305, and 3306. The output of a W+ line and the output of a W-line from each array 3301, 3302 are respectively combined together to give effectively W=W+−W− for each pair of (W+, W−) cells for all pairs of (W+, W−) lines. In addition, the W values from each array 3301 and 3302 can be further combined through summation circuits 3307 and 3308, such that each W value is the result of a W value from array 3301 minus a W value from array 3302, meaning that the end result from summation circuits 3307 and 3308 is a differential value of two differential values.

Artificial neural networks often operate on massive amounts of data and perform massive numbers of calculations involving vector-by-matrix multiplication. There is a demand to provide many arrays for vector-by-matrix multiplication in a relatively small space. Applicant previously filed U.S. patent application Ser. No. 17/848,371 on Jun. 23, 2022, tiled “Artificial Neural Network Comprising a Three-Dimensional Integrated Circuit,” which is incorporated by reference herein. This application describes aspects of a three-dimensional integrated circuit that can be used to implement an artificial neural network. Some of those aspects will be repeated here.

FIG. 34 depicts a block diagram of a VMM system 3400. VMM system 3400 comprises VMM array 3401, row decoder 3402, high voltage decoder 3403, column decoders 3404, bit line drivers 3405, input circuit 3406, output circuit 3407, control logic 3408, and bias generator 3409. VMM system 3400 further comprises high voltage generation block 3410, which comprises charge pump 3411, charge pump regulator 3412, and high voltage analog precision level generator 3413. VMM system 3400 further comprises (program/erase, or weight tuning) algorithm controller 3414, analog circuitry 3415, control engine 3416 (that may include functions such as arithmetic functions, activation functions, embedded microcontroller logic, without limitation), and test control logic 3417.

The input circuit 3406 may include circuits such as a DAC (digital to analog converter), DPC (digital to pulses converter, digital to time modulated pulse converter), AAC (analog to analog converter, such as a current to voltage converter, logarithmic converter), PAC (pulse to analog level converter), or any other type of converters. The input circuit 3406 may implement one or more of normalization, linear or non-linear up/down scaling functions, or arithmetic functions. The input circuit 3406 may implement a temperature compensation function for input levels. The input circuit 3406 may implement an activation function such as ReLU or sigmoid.

The output circuit 3407 may include circuits such as an ADC (analog to digital converter, to convert neuron analog output to digital bits), AAC (analog to analog converter, such as a current to voltage converter, logarithmic converter), APC (analog to pulse(s) converter, analog to time modulated pulse converter), or any other type of converters. The output circuit 3407 may implement an activation function such as rectified linear activation function (ReLU) or sigmoid. The output circuit 3407 may implement one or more of statistic normalization, regularization, up/down scaling/gain functions, statistical rounding, or arithmetic functions (e.g., add, subtract, divide, multiply, shift, log) for neuron outputs. The output circuit 3407 may implement a temperature compensation function for neuron outputs or array outputs (such as bitline output) so as to keep power consumption of the array approximately constant or to improve precision of the array (neuron) outputs such as by keeping the IV slope approximately the same.

### 3D VMM System Architecture

FIG. 35 depicts 3D VMM system 3500, which comprises a plurality of dies, such as dies 3501, 3502, 3503, 3504, 3505, and 3506, which are stacked vertically within package 3522 to form a packaged integrated circuit. 3D VMM system 3500 comprises certain functional blocks that are functionally similar to blocks contained in VMM system 3400 in FIG. 34, but the blocks may be located on different dies. Here, components contained in dies 3501 and 3502 share the components contained in dies 3503, 3504, 3505, and 3506.

In this example, die 3501 contains a respective VMM array 3507 (functionally similar to VMM 3401 in FIG. 34), a respective input multiplexor 3509, a respective row buffer 3523 (which can provide, for example, sampled-and-held buffered voltages to array inputs), a respective high voltage decoder 3508 (functionally similar to high voltage decoder 3403 in FIG. 34), and a respective neuron circuit 3510 (which can perform, for example, a scaling function of array output current, min/max limit function, differential output conversion, buffering, without limitation). Input multiplexor 3509 receives and applies analog input signals to VMM array 3507, and neuron circuit 3510 receives analog output signals that represent neuron outputs from VMM array 3507. The output signals can be sent to other blocks within 3D VMM system 3500.

Die 3502 also contains a respective VMM array 3507, a respective input multiplexor 3509, a respective row buffer 3522, a respective high voltage decoder 3508, and a respective neuron circuit 3510.

In this example, two dies (dies 3501 and 3502) contain respective VMM arrays 3507, but it is to be understood that additional dies that contain respective VMM arrays can be included.

Die 3503 contains high voltage generator 3511 (functionally similar to high voltage generation block 3410 in FIG. 34), analog circuitry 3512 (functionally similar to analog circuitry 3415 in FIG. 34), and temperature compensation circuit 3513. 3D VMM system 3500 may have thermal challenges that 2D VMM system 3400 does not have. Because dies 3501, 3502, 3503, 3504, 3505, and 3506 are stacked in a vertical configuration and contain different types of circuits, each die may experience different thermal operating conditions during operation. For example, certain die will become hotter than other die, and the rate of temperature increase may vary among dies. This introduces the possibility of inaccuracies due to thermal changes. Temperature compensation circuit 3513 compensates for changes in temperature that are experienced among the various dies. Optionally, one or more thermal sensors is located on each respective die to provide temperature data to temperature compensation circuit 3513. Temperature compensation circuit 3513 then alters trim or configuration settings to compensate for any changes in temperature. Temperature compensation circuit 3513 also compensates the temperature changes for each die, for example to compensate for cell current changes over temperature such as making resulting bitline (neuron) current approximately the same over temperature. Temperature compensation circuit 3513 is also used to for the neuron circuit 3510, DAC, and ADC circuits such as to make the operating dynamic range (e.g., output range for DAC, input range for the ADC, output range for the neuron circuit 3510) approximately the same over the temperature.

Die 3504 contains input circuit 3514 (functionally similar to input circuit 3406), which includes address decoding circuit 3524, row register 3525 (holding activation input values for array rows), and digital-to-analog converter (DAC) 3515. DAC 3515 receives digital signals from the row register 3525 and converts them into analog signals.

Die 3505 contains analog-to-digital converter (ADC) 3516. ADC 3516 receives analog signals and converts them into digital signals.

Die 3506 contains digital circuits 3517, static random access memory (SRAM) 3518, registers 3519, physical I/O connections 3520, digital accelerator 3531, and a network-on-chip (NOC) 3715. Die 3506 provides control functions for other dies. Digital circuits 3517 can include digital logic, micro-controllers, SIMD (single instruction multiple data) processor, and processors. SRAM 3518 and registers 3519 can be used to store system information and configuration information used by digital circuits 3517 or other circuits, or blocks in 3D VMM system 3500. Physical I/O connections 3520 provide IO interfaces to devices outside of VMM system 3500 (such as an external processing unit) or to another package 3522. Digital accelerator 3531 is used for certain neural networks or certain layers within a neural network where additional processing may be required, such as when a small activation size is present, where the weights stored in the cells are dynamic and not fixed, where a MAC operation is to be performed, without limitation._. NOC 3715 provides network routing functionality within 3D VMM system 3500, for example, by generating control signals to cause signals to be routed from one block to another block.

Respective ones of the plurality of dies are connected to one or more other dies within the plurality of dies through vertical interfaces 3521, which vertical interfaces 3521 respectively connect two or more dies together. In one example, vertical interfaces 3521 are implemented as a through-silicon via (TSV).

During a read operation of 3D VMM system 3500, a digital input is received by input circuit 3514. The digital input enables row registers 3525, which store activation inputs and applies a selected activation input in response to the digital input to DAC 3515 which DAC 3515 converts the digital outputs from the row registers 3525 into respective analog signals. The analog signal produced by DAC 3515 is provided by input circuit 3514 over one or more vertical interfaces 3521 to input multiplexor 3509 and row buffer 3523 on one, or more of dies 3501, 3502, which then applies the signals to one or more rows in the respective VMM array 3507, resulting in an output being generated by VMM array 3507. The output from the respective VMM array 3507 is received by the respective neuron circuit 3510, which provides a buffer function to drive the parasitic capacitance of the one or more vertical interfaces 3521 to which it connects. Neuron circuit 3510 provides analog signals over one or more vertical interfaces 3521 to ADC 3516 on die 3505, which ADC 3516 converts the analog signals into digital signals. Alternatively, the analog signals can bypass ADC 3516 and remain in analog form. The output of ADC 3516 is provided to a device external to 3D VMM system 3500 (such as a processing unit or graphics processing unit) through physical I/O 3520 or applied as inputs to a respective VMM array 3507 (representing another layer in the artificial neural network). Alternatively, the analog signals from neuron circuit 3510 can bypass ADC 3516 and remain in analog form and be applied as inputs to a respective VMM array 3507.

FIG. 36 depicts 3D VMM system 3600 comprising package 3622. 3D VMM system 3600 is similar to 3D VMM system 3500 and contains many of the same components, except for some differences in the placement of components and certain additional components. Items that are the same as in FIG. 35 contain the same item number as in FIG. 36. Here, components contained in dies 3601 and 3602 share the components contained in dies 3603, 3604, 3605, and 3606.

3D VMM system 3600 comprises a plurality of dies, such as dies 3601, 3602, 3603, 3604, 3605, and 3606, which are stacked vertically within common package 3522 to form a packaged integrated circuit.

In this example, die 3601 contains a respective VMM array 3507, a respective input multiplexor 3509, respective registers 3524 (holding the activation input values for array rows), respective row buffers 3523, a respective high voltage multiplexor 3608, and a respective column multiplexor 3610.

Die 3602 also contains a respective VMM array 3507, a respective input multiplexor 3509, respective registers 3524, respective row buffers 3523, a respective high voltage multiplexor 3608, and column multiplexor 3610.

In this example, two dies (dies 3601 and 3602) contain respective VMM arrays 3507, but it is to be understood that additional dies that contain VMM arrays can be included.

Die 3603 contains high voltage generator 3511, analog circuitry 3512, temperature compensation circuit 3513, and high voltage multiplexor 3608.

Die 3604 contains input circuit 3614 which includes address decoding 3524 and DAC 3515.

Die 3605 contains neuron circuit 3510 and ADC 3516.

Die 3606 contains digital circuits 3517, SRAM 3518, registers 3519, and physical I/O connections 3520.

Respective ones of the plurality of dies are connected to one or more other dies within the plurality of dies through respective vertical interfaces 3521.

During a read operation of 3D VMM system 3600, an input is received and an address is received by input circuit 3614. Address decoder 3524 decodes the address and provides the input over one or more vertical interfaces 3521 to a respective row register 3525 corresponding to the decoded address. The output of the respective row register 3525 is coupled over one or more vertical interfaces 3521 to DAC 3515 which converts the digital output bits received from row register 3525 into an analog signal, and provides the analog signal over one or more vertical interfaces 3521 to a respective input multiplexor 3509 and row buffer 3523. Row buffer 3523 applies the analog signal, buffered, to row inputs of the respective VMM array 3507 for the selected rows (such as array control gates or wordlines). The output from the respective VMM array 3507 (such as from array bitlines) is received by the respective column multiplexor 3610, and the output of the respective column multiplexor 3610 provides signals over one or more vertical interfaces 3521 to ADC 3516, on die 3605, which converts the analog signals into digital signals. Alternatively, the signals can bypass ADC 3516 and remain in analog form. The output of ADC 3516 is provided over one or more vertical interfaces 3521 to digital circuits 3517 (which can perform an activation function, a pooling function, or other network function) on die 3606, and the output of digital circuits 3517 may be provided to a device external to 3D VMM system 3600 (such as a processing unit or graphics processing unit) through physical I/O 3520 on die 3606 or to input circuit 3614 on die 3604, over a respective vertical interface 3521, as inputs to another respective VMM array 3507 (representing another layer in the artificial neural network).

FIG. 37A depicts 3D VMM system 3700, which comprises a plurality of dies in two or more vertical stacks. In this example, the first vertical stack comprises dies 3701, 3702, 3703, 3704, 3705, and 3706, and the second vertical stack comprises dies 3707, 3708, 3709, 3710, 3711, and 3712, all of which are contained in a common package 3522 to form a single packaged integrated circuit. In one example, the dies in the first vertical stack are physical separate dies from the dies in the second vertical stack. In another example, the dies in the first vertical stack and the dies in the second vertical stack are the same physical dies (meaning, for example, die 3701 and 3707 are the same die). Here, components contained in dies 3701 and 3702 share the components contained in dies 3703, 3704, 3705, and 3706, and components contained in dies 3707 and 3708 share the components contained in dies 3709, 3710, 3711, and 3712.

In the example shown, die 3701 and die 3707 each contain a respective VMM array 3507, a respective array input 3729 (which includes a respective input multiplexor 3509, a respective address decoder 3713, a respective row register 3525, and a respective row buffer 3523), a respective high voltage multiplexor 3608, and a respective neuron circuit 3510.

Die 3702 and die 3708 also each contain a respective VMM array 3507, a respective array input 3729 (which includes a respective input multiplexor 3509, a respective address decoder 3713, a respective row register 3525, and a respective row buffer 3523), a respective high voltage multiplexor 3608, and a respective neuron circuit 3510.

In this example, four dies (dies 3701, 3702, 3707, and 3708) contain respective VMM arrays 3507, but it is to be understood that additional dies that contain VMM arrays can be included.

Die 3703 and die 3709 each contain a respective high voltage decoder 3714, a respective high voltage generator 3511, a respective analog circuitry 3512, and a respective temperature compensation circuit 3513.

Die 3704 and die 3710 each contain a respective input circuit 3514 which includes a respective DAC 3515.

Die 3705 and die 3711 each contain a respective ADC 3516.

Die 3706 and die 3712 each contain respective digital circuits 3517, a respective SRAM 3518, respective registers 3519, respective physical I/O connections 3520, and respective NOC (network-on-chip) connections 3715.

Respective ones of the plurality of dies are connected to one or more other dies within the plurality of dies through one or more vertical interfaces 3521 or horizontal interfaces 3716, which respectively connect two or more dies together. In one example, vertical interfaces 3521 are respectively a through-silicon via (TSV). In one example, horizontal interfaces 3716 are respectively a redistribution layer (RDL) connection.

During a read operation of 3D VMM system 3700, a digital input is received by a respective input circuit 3514, which converts the digital input to an analog signal via its respective DAC 3515, and the output of the respective DAC 3515 is coupled to the row register 3525 of the respective array input 3729 via the respective vertical interface(s) 3521 and/or horizontal interface(s) 3716. The output of row register 3525 of the respective array input 3729 is provided to input multiplexor 3509 and row buffer 3523, which then applies the signals to one or more rows in VMM array 3507. The output from the respective VMM array 3507 is received by the respective neuron circuit 3510, which neuron circuit 3510 provides a buffer function to drive the parasitic capacitance of the one or more vertical interfaces 3521 or horizontal interfaces 3716 to which it connects. Neuron circuit 3510 provides buffered analog signals over one or more vertical interfaces 3521 or horizontal interfaces 3716 to a respective ADC 3516, which converts the analog signals into digital signals. The output of ADC 3516 is provided to respective digital circuits 3517 (which performs an activation function, pooling function, or network function) and the output of the respective digital circuits 3517 may be provided to a device external to 3D VMM system 3700 (such as a processing unit or graphics processing unit) through respective physical I/O 3520 or to a respective input circuit 3514 to be converted by the respective DAC 3515, and the output of the respective input circuit 3514 is coupled to another VMM array 3507 (representing another layer in the artificial neural network) or to another package 3522 through a respective physical I/O 3520.=

FIG. 37B depicts 3D VMM system 3750 which is similar to the 3D VMM system 3750 except it has another type of VMM array, shown on die 3758 as VMM array 3557, which VMM array 3557 comprises static RAM cells or dynamic RAM cells.

FIG. 38 depicts 3D VMM system 3800, which comprises a plurality of dies in two vertical stacks. It is possible to have more than two stacks. In this example, the first vertical stack comprises dies 3801, 3802, 3803, 3804, 3805, and 3806, and the second vertical stack comprises dies 3807, 3808, 3809, 3810, 3811, and 3812, all of which are contained in common package 3522 to form a single packaged integrated circuit. In one example, the dies in the first vertical stack are physical separate dies from the dies in the second vertical stack. In another example, the dies in the first vertical stack and the dies in the second vertical stack are the same physical dies (meaning, for example, die 3801 and 3807 are the same die). Here, components contained in dies 3801 and 3802 share the components contained in dies 3803, 3804, 3805, and 3806, and components contained in dies 3807 and 3808 share the components contained in dies 3809, 3810, 3811, and 3812.

In the example shown, die 3801, 3802, 3807 and die 3808 each contain a respective VMM array 3507, a respective array input 3729, a respective high voltage multiplexor 3608, a respective column multiplexor 3610, and a respective array input circuit 3729. Respective array inputs 3729 comprise an input multiplexor 3509, and address decoder 3713, a row register 3524 and a row buffer 3523.

In this example, four dies (dies 3801, 3802, 3807, and 3808) contain VMM arrays, but it is to be understood that additional dies that contain VMM arrays can be included.

Die 3803 and die 3809 respectively contain a high voltage decoder 3714, a high voltage generator 3511, an analog circuitry 3512, and a temperature compensation circuit 3513.

Die 3804 and die 3810 respectively contain an input circuit 3514 which includes DAC 3515.

Die 3805 and die 3811 respectively contain ADC 3516, and neuron circuit 3510.

Die 3806 and die 3812 respectively contain digital circuits 3517, an SRAM 3518, registers 3519, physical I/O connections 3520, and NOC connections 3715.

The plurality of dies are respectively connected to one or more other dies within the plurality of dies through one or more vertical interfaces 3521 or horizontal interfaces 3716, which respectively connect two or more dies together. In one example, respective vertical interfaces 3521 are implemented as a through-silicon via (TSV). In one example, respective horizontal interface 3716 are implemented as a redistribution layer (RDL) connection.

During a read operation of 3D VMM system 3800, a digital input is received by input circuit 3514, which uses DAC 3515 to convert the digital input into analog form and provide the analog signal to the respective array input circuit 3729 via the respective vertical interface(s) 3521 and/or horizontal interface(s) 3716. Array input circuit 3729 receives the analog signals from the input circuit and addresses and then applies the analog signal to the selected rows, responsive to the addresses, in VMM array 3507. The output from VMM array 3507 is received by column multiplexor 3610, which provides analog signals over one or more vertical interfaces 3521 or horizontal interfaces 3716 to ADC 3516, which converts the analog signals into digital signals. Alternatively, the analog signals can bypass ADC 3516 and remain in analog form. The output of ADC 3516 is provided over one or more vertical interfaces 3521 or horizontal interfaces 3716 to digital circuit 3517 (which can perform an activation function, a pooling function, or other network function) and the output of digital circuit 3517 can be provided to a device external to 3D VMM system 3800 (such as a processing unit or graphics processing unit) through physical I/O 3520 or to input circuits 3514 of other VMM array 3507 (representing another layer in the artificial neural network) or to another package 3522 through physical I/O 3520.

FIG. 39A depicts 3D VMM system 3900, which comprises a plurality of dies in two vertical stacks. In this example, the first vertical stack comprises dies 3901, 3902, 3903, and 3904, and the second vertical stack comprises dies 3905, 3906, 3907, and 3908, all of which are contained in common package 3522 to form a single packaged integrated circuit. In one example, the dies in the first vertical stack are physical separate dies from the dies in the second vertical stack. In another example, the dies in the first vertical stack and the dies in the second vertical stack are the same physical dies (meaning, for example, die 3901 and 3905 are the same die). Here, components contained in dies 3901 and 3902 share the components contained in dies 3903 and 3904, and components contained in dies 3905 and 3906 share the components contained in dies 3907 and 3908.

In the example shown, die 3901, 3902, 3905 and die 3906 respectively contain a VMM array 3507, an array input 3729, a high voltage multiplexor 3608, and a column multiplexor 3610.

In this example, four dies (dies 3901, 3902, 3903, and 3904) contain VMM arrays, but it is to be understood that additional dies that contain VMM arrays can be included.

Die 3903 and die 3907 respectively contain a high voltage decoder 3714, a high voltage generator 3511, an analog circuitry 3512, a temperature compensation circuit 3513, an input circuit 3514 which includes DAC 3515, a neuron circuit 3510, and ADC 3516.

Die 3904 and die 3908 respectively contain digital circuits 3517, an SRAM 3518, registers 3519, physical I/O connections 3520, and NOC connections 3715.

The plurality of dies are respectively connected to one or more other dies within the plurality of dies through one or more vertical interfaces 3521 or horizontal interfaces 3716, which respectively connect two or more dies together.

During a read operation of 3D VMM system 3900, a digital input is received by input circuit 3514, which input circuit 3514 uses DAC 3515 to convert the digital input into analog form and provide the analog signal to the respective array input circuit 3729 via the respective vertical interface(s) 3521 and/or horizontal interface(s) 3716. Array input circuit 3729 receives analog signals from the input circuit and addresses, and, responsive to the received addresses, applies the analog signal to the selected rows in VMM array 3507. The output from VMM array 3507 is received by column multiplexor 3610, which provides analog signals over one or more vertical interfaces 3521 or horizontal interfaces 3716 to ADC 3516, which converts the analog signals into digital signals. Alternatively, the analog signals can bypass ADC 3516 and remain in analog form. The output of ADC 3516 is provided to digital circuits 3517 via the respective vertical interface(s) 3521 and/or horizontal interface(s) 3716, and then provided to a device external to 3D VMM system 3900 (such as a processing unit or graphics processing unit) through physical I/O 3520 or to input circuit 3514 to be applied as inputs to VMM array 3507 (representing another layer in the artificial neural network) or to another package 3522 through physical I/O 3520.

FIG. 39B depicts 3D VMM system 3950 which is similar to that of the FIG. 39A except that dies 3951, 3952, 3955, and 3956 now has both input circuits 3514 and array input 3729. 3D VMM system 3950 comprises package 3522 and dies 3951, 3952, 3953, 3954, 3955, 3956, 3957, and 3958. The plurality of dies are respectively connected to one or more other dies within the plurality of dies through one or more vertical interfaces 3521 or horizontal interfaces 3716, which respectively connect two or more dies together.

FIG. 39C depicts 3D VMM system 3980, which comprises a plurality of dies in two vertical stacks. In this example, the first vertical stack comprises dies 3981, 3982, 3983, and the second vertical stack comprises dies 3984, 3985, and 3986, all of which are contained in common package 3522 to form a single packaged integrated circuit. In one example, the dies in the first vertical stack are physical separate dies from the dies in the second vertical stack. In another example, the dies in the first vertical stack and the dies in the second vertical stack are the same physical dies (meaning, for example, die 3981 and 3984 are the same die). Here, components contained in dies 3981 and 3982 share the components contained in dies 3983, and components contained in dies 3984 and 3985 share the components contained in dies 3986.

In the example shown, die 3981, 3982, 3984 and die 3985 respectively contain a VMM array 3507, a high voltage block 3991, an input block 3990, an output block 3992 and an analog block 3993. Input block 3990 may include input circuit 3514, DAC 3515, array input circuit 3729. High voltage block 3991 may include high voltage multiplexor 3608 and high voltage decoder 3714. Output block 3992 may include column multiplexor 3610, neuron circuit 3510, and ADC 3516. Analog block 3993 may include high voltage generator 3511, analog circuitry 3512, and temperature compensation circuitry 3513.

Die 3983 and die 3986 each contains digital circuits 3517, SRAM 3518, registers 3519, physical I/O connections 3520, digital accelerator 3521 (used for multiple and accumulate (MAC) function digitally) and NOC connections 3715.

The plurality of dies are respectively connected to one or more other dies within the plurality of dies through one or more vertical interfaces 3521 or horizontal interfaces 3716, each of which respectively connects two or more dies together.

FIG. 40 depicts 3D VMM system 4000, which comprises a plurality of dies in two vertical stacks. In this example, the first vertical stack comprises dies 4001, 4002, 4003, and 4004, and the second vertical stack comprises dies 4005, 4006, 4007, and 4008, all of which are contained in common package 3522 to form a single packaged integrated circuit. In one example, the dies in the first vertical stack are physical separate dies from the dies in the second vertical stack. In another example, the dies in the first vertical stack and the dies in the second vertical stack are the same physical dies (meaning, for example, die 4001 and 4005 are the same die). Here, components contained in dies 4001 and 4002 share the components contained in dies 4003 and 4004, and components contained in dies 4005 and 4006 share the components contained in dies 4007 and 4008.

In the example shown, die 4001, 4002, 4005 and 4006 respectively contain a VMM array 3507, an array input 4029 (which includes input multiplexor 3509 and/or decoder 3713—not shown), a high voltage multiplexor 3608, and a column multiplexor 3610.

In this example, four dies (dies 4001, 4002, 4003, and 4004) contain VMM arrays, but it is to be understood that additional dies that contain VMM arrays can be included.

Die 4003 and die 4007 respectively contain a high voltage decoder 3714, a high voltage generator 3511, an analog circuitry 3512, a temperature compensation circuit 3513, and a neuron circuit 3510.

Die 4004 and die 4008 respectively contain a digital circuits 3517, an SRAM 3518, registers 3519, physical I/O connections 3520, and NOC connections 3715.

Unlike VMM system 3900, VMM system 4000 does not contain DAC 3515, and ADC 3516 because the inputs and outputs are kept in analog form and not converted between analog and digital form.

The plurality of dies are respectively connected to one or more other dies within the plurality of dies through one or more vertical interfaces 3521 or horizontal interfaces 3716, which respectively connect two or more dies together.

During a read operation of 3D VMM system 4000, an analog input (such as a voltage, a current, or a timed based entity such as a sequence of pulses) is received by a respective array input 4029 which then applies the signals to one or more rows in respective VMM array 3507. The output from the respective VMM array 3507 is received by column multiplexor 3610, which provides analog signals (such as a voltage, a current, or a timed based entity) over one or more vertical interfaces 3521 or horizontal interfaces 3716 to a respective neuron circuit 3510, which neuron circuit 3510 provides a buffered signal to a device external to 3D VMM system 4000 (such as a processing unit or graphics processing unit), or to another package 3522, through physical I/O 3520 or to array input 4029 of other VMM array 3507 (representing another layer in the artificial neural network).

FIGS. 41-44 depict additional detail regarding example configurations of VMM arrays 3507. FIG. 41-44 depict 3D VMM systems 4100, 4200, 4300, and 4400, respectively. Each of 3DD VMM systems 4100, 4200, 4300, and 4400 comprises VMM array 3507-1 on a first die and VMM array 3507-2 on a second die in a common package (not shown). VMM arrays 3507-1 and 3507-2 respectively contain an array of non-volatile memory cells arranged in m+1 rows and n+1 columns. Respective rows are coupled to one of the control gate lines labeled CG0, . . . , CGm, and respective columns are coupled to one of the bit lines labeled BL0, . . . ,BLn. Cells are located at the intersection of a bit line and a control gate line. For example, cell 4101mn is located in row m and column n and coupled to CGm and BLn in VMM array 3507-1, and cell 4102mn is located in row m and column n and coupled to CGm and BLn in VMM array 3507-2. Because VMM array 3507-1 and 3507-2 are located on different dies, they optionally can be manufactured using different semiconductor processes. Regardless of whether the same or a different semiconductor process is used to manufacture VMM arrays 3507-1 and 3507-2, the cells in VMM array 3507-1 can store a different number of bits than the cells in VMM array 3507-2. For example, the cells in VMM array 3507-1 such as cell 4101mn can store i bits, whereas the cells in VMM array 3507-2 such as cell 4102mn can store j bits, where i and j are integers of different values. For example, i can be 3 (meaning that cells in VMM array 3507-1 respectively store a 3-bit value) and j can be 5 (meaning that cells in VMM array 3507-2 respectively store a 5-bit value).

In FIG. 41, inputs are provided separately to VMM arrays 3507-1 and 3507-2 through the control gate lines, and outputs are obtained separately on the bit lines. FIG. 41 depicts example cells 4101mn and 4102mn. Optionally, the outputs can be combined elsewhere if desired, such as by converting them into digital form using ADC 3516 (shown in previous Figures) and adding them together using digital circuits 3517 (shown in previous Figures).

In FIG. 42, inputs are provided separately to VMM arrays 3507-1 and 3507-2 through the control gate lines. The outputs of VMM array 3507-1 are obtained on a first set of bit lines and the outputs of VMM array 3507-2 are obtained on a second set of bit lines, where the first set of bit lines are coupled to the second set of bit lines by respective vertical interfaces 3521 which effectively adds the output signals together in analog form. Optionally, the combined analog output can be digitized elsewhere if desired, such as by converting them into digital form using ADC 3516 (shown in previous Figures).

In FIG. 43, inputs are provided through a first set of control gate lines to VMM array 3507-1 and a second set of control gate lines to VMM array 3507-2, wherein the first set of control gate lines are coupled to the second set of control gate lines by respective vertical interfaces 3521, and outputs are obtained separately on the bit lines. Optionally, the outputs can be combined elsewhere if desired, such as by converting them into digital form using ADC 3516 (shown in previous Figures) and adding them together using digital circuits 3517 (shown in previous Figures).

In FIG. 44, inputs are provided in common, through the control gate lines, to VMM arrays 3507-1 and 3507-2 through vertical interfaces 3521. The outputs are obtained on the bit lines, which are combined together through vertical interfaces 3521, which effectively adds the signals together in analog form. Optionally, the combined analog output can be digitized elsewhere if desired, such as by converting them into digital form using ADC 3516 (shown in previous Figures).

FIGS. 45 to 48 depict examples of structural layout options for dies, vertical interfaces, and horizontal interfaces.

FIG. 45 depicts 3D VMM system 4500, which comprises a first set of dies arranged in a vertical configuration (dies 4501, 4502, 4503, and 4504) and connected by vertical interfaces 3521, and a second set of dies arranged in a vertical configuration (dies 4505, 4506, 4507, and 4508) and connected by vertical interfaces 3521. Here one die can connect to two other dies by respective ones of the vertical interfaces 3521.

FIG. 46 depicts 3D VMM system 4600, which comprises four levels of dies arranges in a vertically staggered configuration, where the first level comprises dies 4601 and 4602, the second level comprises dies 4603, 4604, and 4605, the third level comprises dies 4606 and 4607, and the fourth level comprises dies 4608, 4609, and 4610. Dies in different levels are connected to dies in a level above, and to dies in a level below, by respective vertical interfaces 3521. Here one die can connect to four other dies by respective ones of the vertical interfaces 3521.

FIG. 47 depicts 3D VMM system 4700, which comprises four levels of dies arranges in a vertically staggered configuration, where the first level comprises dies 4701 and 4702, the second level comprises dies 4703, 4704, and 4705, the third level comprises dies 4706 and 4707, and the fourth level comprises dies 4708, 4709, and 4710. Dies in different levels are connected by respective vertical interfaces 3521, and dies in the same level are connected by respective horizontal interfaces 3716. Here one die can connect to six other dies by respective ones of the vertical interfaces 3521 and by respective ones of the horizontal interfaces 3716.

FIG. 48 depicts an example of a physical layout of 3D VMM system 4800, where connectors 4801 are shown. Connectors 4801 are located in a die and connect to one or more vertical interfaces 3521 and horizontal interfaces 3716. As can be seen, the dies and interfaces can be arranged such that the connectors 4801 are located in a vertically staggered configuration.

As three-dimensional integrated circuits become larger to satisfy the computation demand of artificial neural networks, there is a need for a new interface circuit to enable efficient communication among the various dies in the three-dimensional structure and between the dies and devices outside the three-dimensional structure such as a server or processor.

### SUMMARY OF THE INVENTION

Numerous examples are disclosed of an interface circuit for an artificial neural network comprising a three-dimensional integrated circuit.

In one example, a system comprises a first device; a first interface coupled to the first device and comprising one or more device control lines to identify a second device within a plurality of devices for which a communication is intended, the plurality of devices respectively containing vector-by-matrix multiplication arrays; and a stack comprising an interface circuit coupled to the first interface, the plurality of devices, and a second interface comprising lines compliant with a legacy standard, the second interface coupled between the interface circuit and the plurality of devices.

In another example, a method comprises receiving, by an interface circuit, a first communication from a first device over a first interface comprising one or more device control lines to identify a second device within a plurality of devices for which a communication is intended, the plurality of devices respectively containing vector-by-matrix multiplication arrays; translating, by the interface circuit, the first communication into a second communication; and sending, by the interface circuit, the second communication to one or more of the plurality of devices over a second interface comprising lines compliant with a legacy standard.

### BRIEF DESCRIPTION OF THE DRAWINGS

FIG. 1 is a diagram that illustrates an artificial neural network.

FIG. 2 depicts a prior art split gate flash memory cell.

FIG. 3 depicts another prior art split gate flash memory cell.

FIG. 4 depicts another prior art split gate flash memory cell.

FIG. 5 depicts another prior art split gate flash memory cell.

FIG. 6 is a diagram illustrating the different levels of an example artificial neural network utilizing one or more non-volatile memory arrays.

FIG. 7 is a block diagram illustrating a VMM system.

FIG. 8 is a block diagram illustrates an example artificial neural network utilizing one or more VMM systems.

FIG. 9 depicts another example of a VMM system.

FIG. 10 depicts another example of a VMM system.

FIG. 11 depicts another example of a VMM system.

FIG. 12 depicts another example of a VMM system.

FIG. 13 depicts another example t of a VMM system.

FIG. 14 depicts a prior art long short-term memory system.

FIG. 15 depicts an example cell for use in a long short-term memory system.

FIG. 16 depicts an example implementation of the cell of FIG. 15.

FIG. 17 depicts another example implementation of the cell of FIG. 15.

FIG. 18 depicts a prior art gated recurrent unit system.

FIG. 19 depicts an example cell for use in a gated recurrent unit system.

FIG. 20 depicts an example implementation t of the cell of FIG. 19.

FIG. 21 depicts another example implementation of the cell of FIG. 19.

FIG. 22 depicts another example of a VMM system.

FIG. 23 depicts another example of a VMM system.

FIG. 24 depicts another example of a VMM system.

FIG. 25 depicts another example of a VMM system.

FIG. 26 depicts another example of a VMM system.

FIG. 27 depicts another example of a VMM system.

FIG. 28 depicts another example of a VMM system.

FIG. 29 depicts another example of a VMM system.

FIG. 30 depicts another example of a VMM system.

FIG. 31 depicts another example of a VMM system.

FIG. 32 depicts another example of a VMM system.

FIG. 33 depicts another example of a VMM system.

FIG. 34 depicts an example of a 2D VMM system.

FIG. 35 depicts an example of a 3D VMM system.

FIG. 36 depicts an example of a 3D VMM system.

FIGS. 37A and 37B depict examples of a 3D VMM system.

FIG. 38 depicts an example of a 3D VMM system.

FIGS. 39A, 39B, and 39C depict examples of a 3D VMM system.

FIG. 40 depicts an example of a 3D VMM system.

FIG. 41 depicts an example of a 3D VMM system.

FIG. 42 depicts an example of a 3D VMM system.

FIG. 43 depicts an example of a 3D VMM system.

FIG. 44 depicts an example of a 3D VMM system.

FIG. 45 depicts an example of a 3D VMM system.

FIG. 46 depicts an example of a 3D VMM system.

FIG. 47 depicts an example of a 3D VMM system.

FIG. 48 depicts an example of a 3D VMM system FIG. 49 depicts a 2D VMM system.

FIG. 50 depicts a device coupled to a plurality of VMM systems over an interface.

FIG. 51 depicts a system comprising plurality of stacks of VMM systems.

FIG. 52 depicts a system comprising a plurality of stacks of VMM systems.

FIG. 53 depicts an example of a stack of VMM systems.

FIG. 54A depicts a memory system.

FIG. 54B depicts a VMM system.

FIG. 55 depicts details of an interface.

FIG. 56 depicts an interface coupled to a plurality of VMM systems,

FIG. 57 depicts a VMM system coupled to a parallel interface.

FIG. 58 depicts a VMM system coupled to a serial interface.

FIG. 59A depicts a VMM system comprising a VMM array.

FIG. 59B depicts a VMM system comprising a plurality of VMM arrays.

FIG. 59C depicts a VMM system comprising a plurality of VMM arrays.

FIG. 60 depicts a system coupled to an AXI interface.

FIG. 61 depicts an array of VMM systems.

FIG. 62 depicts a system comprising a plurality of chips.

FIG. 63 depicts a prior art transformer.

FIG. 64 depicts a method performed by an interface circuit.

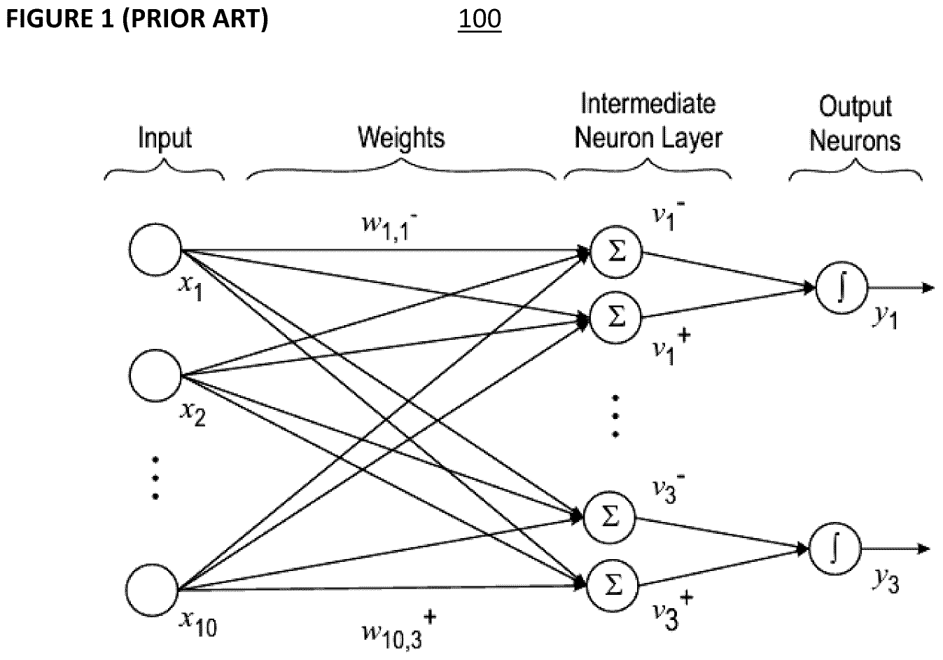

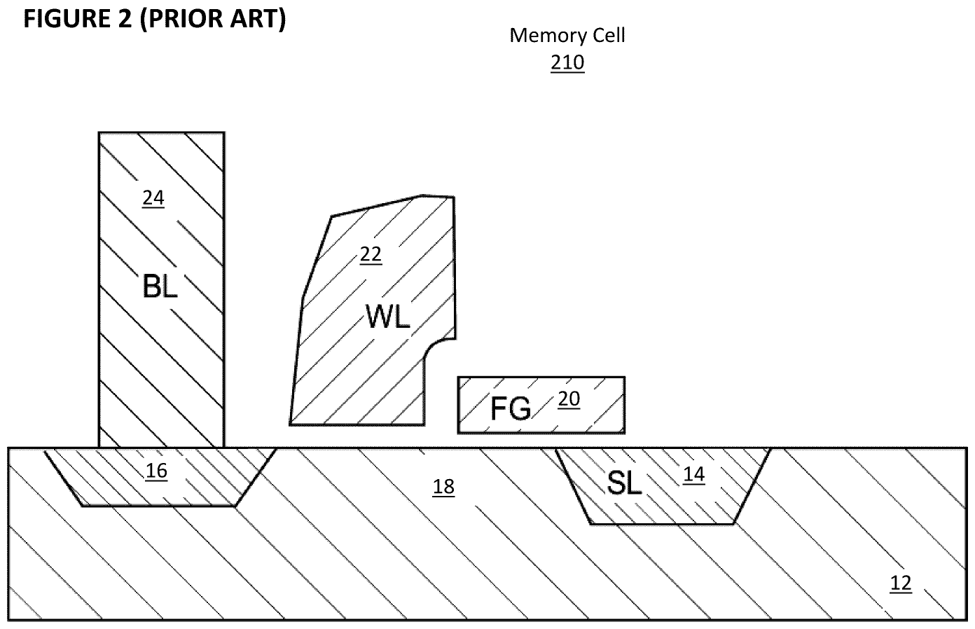

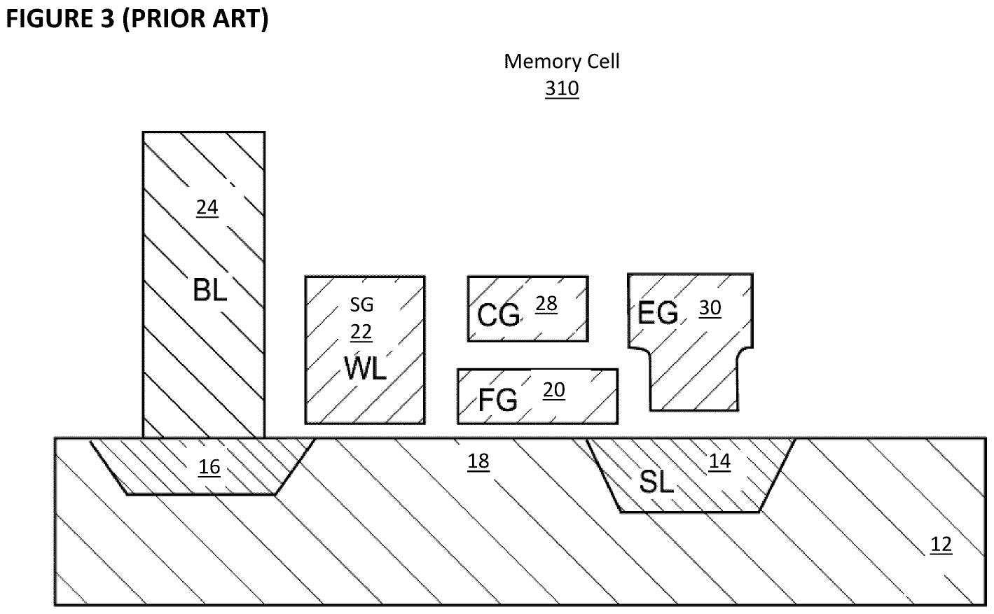

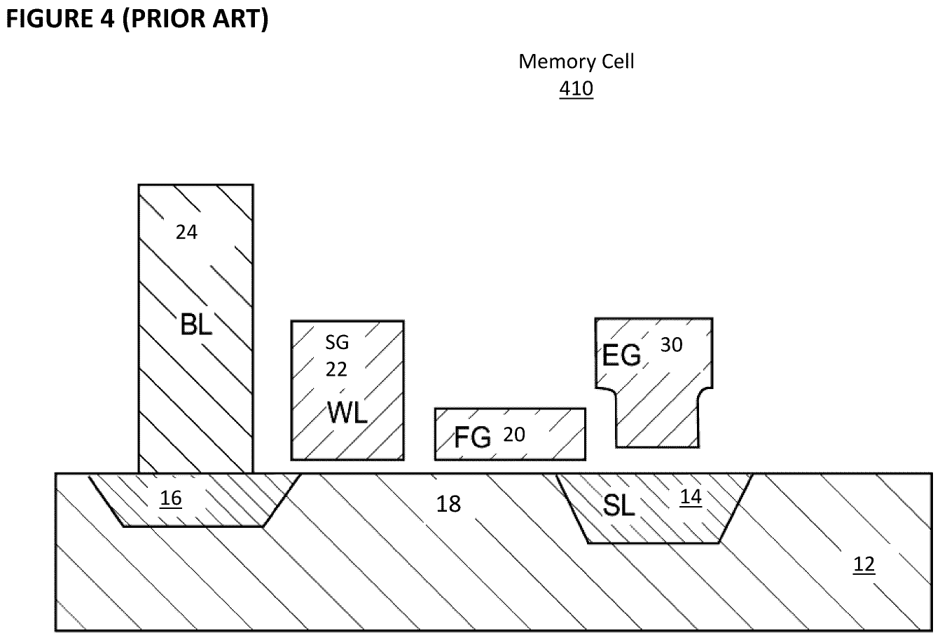

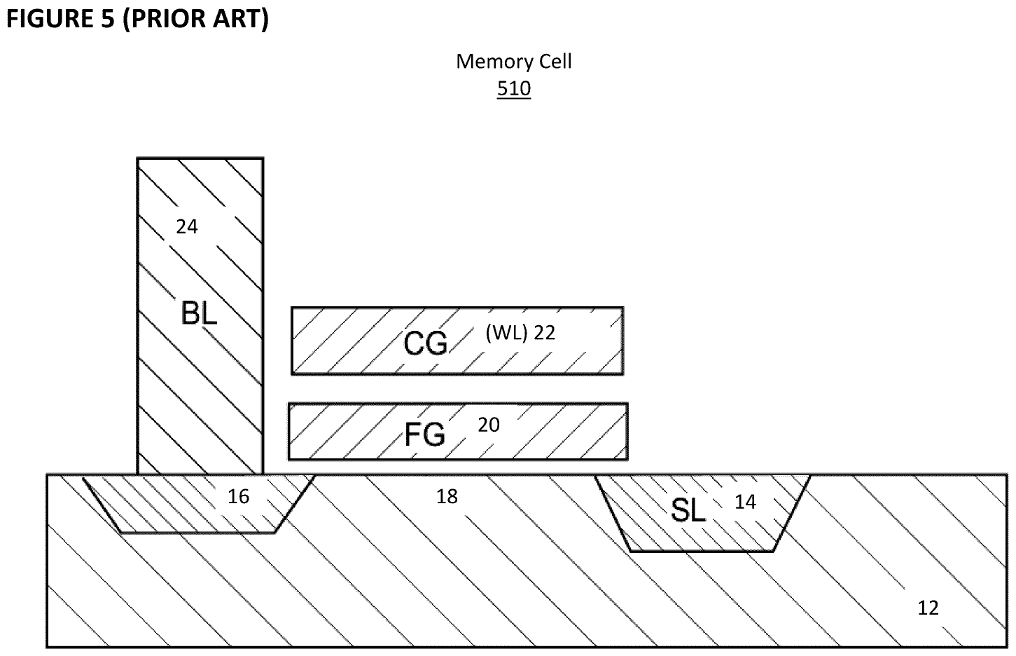

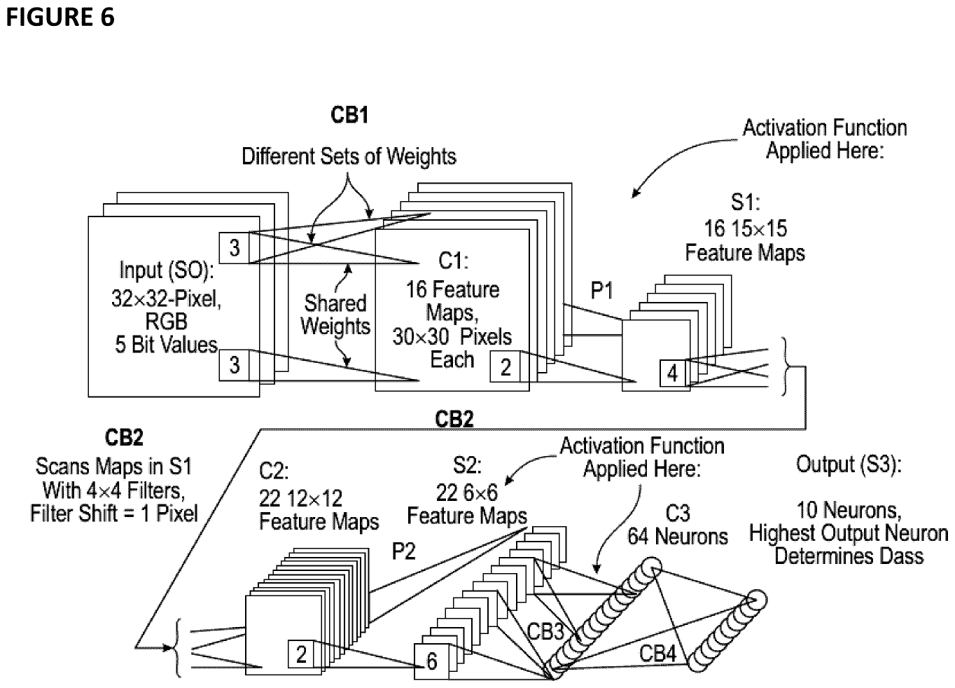

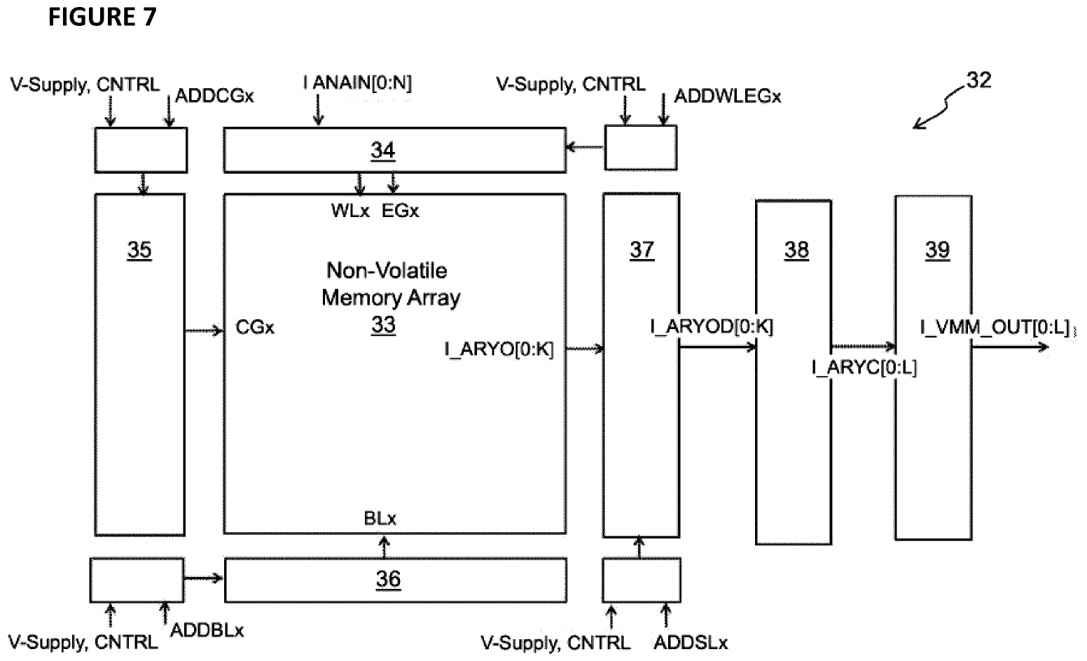

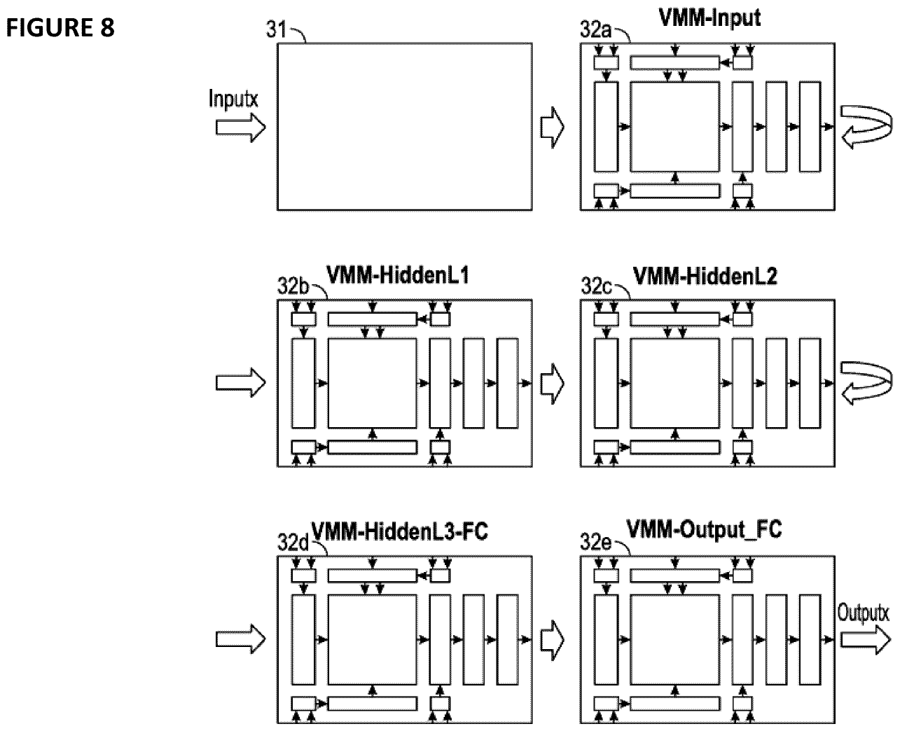

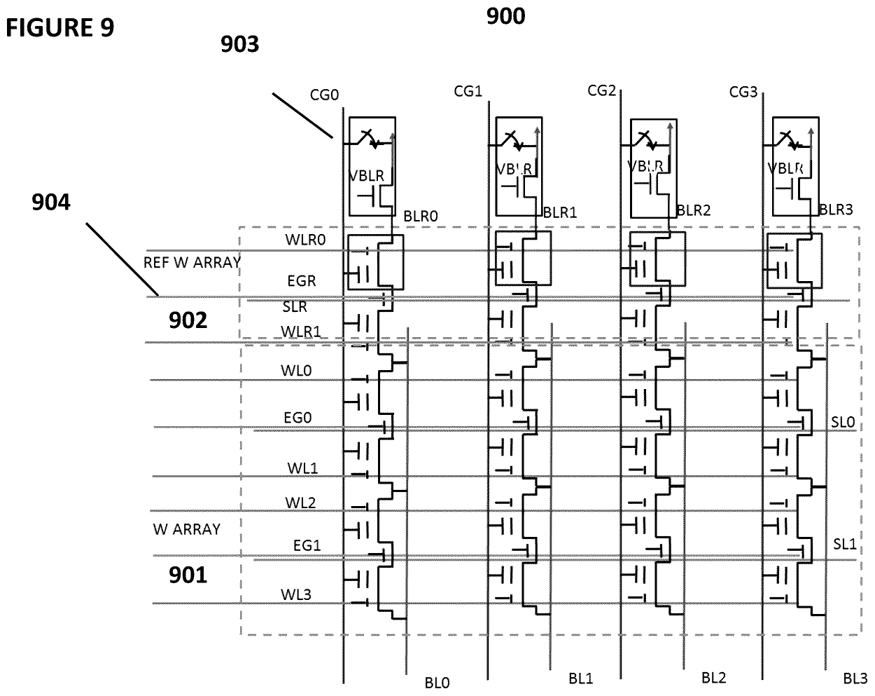

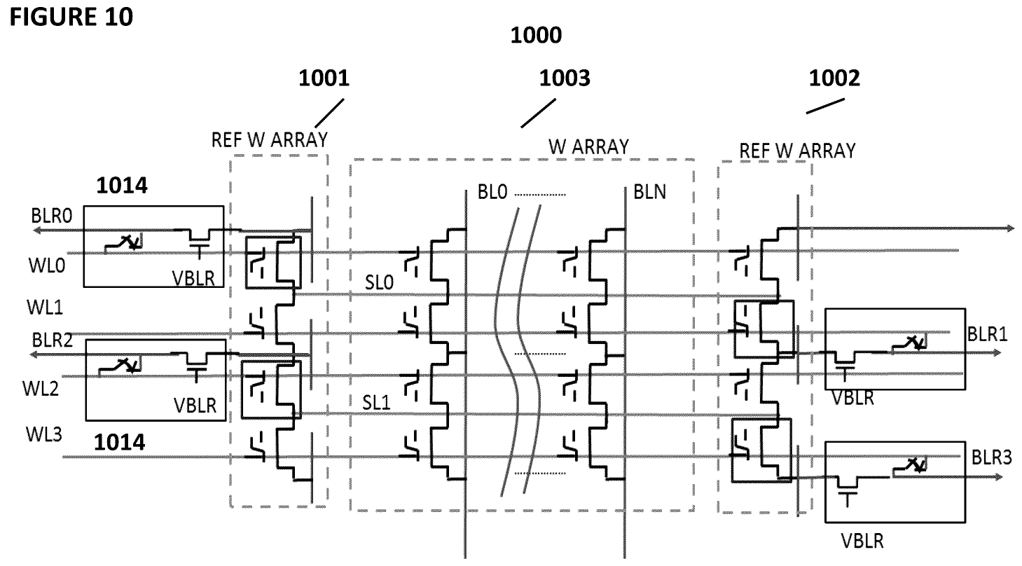

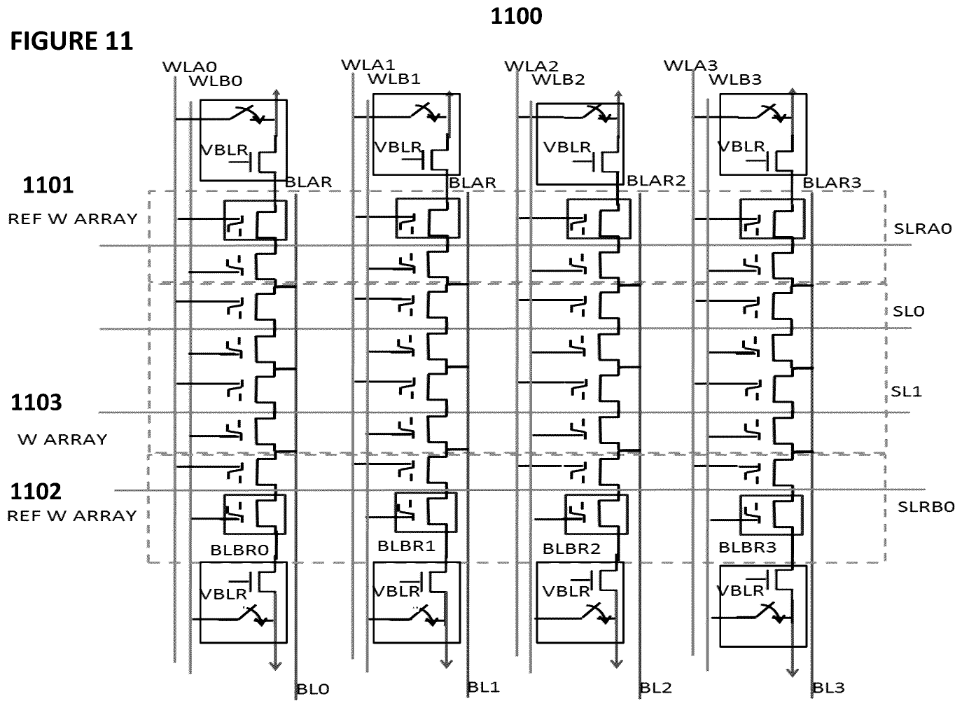

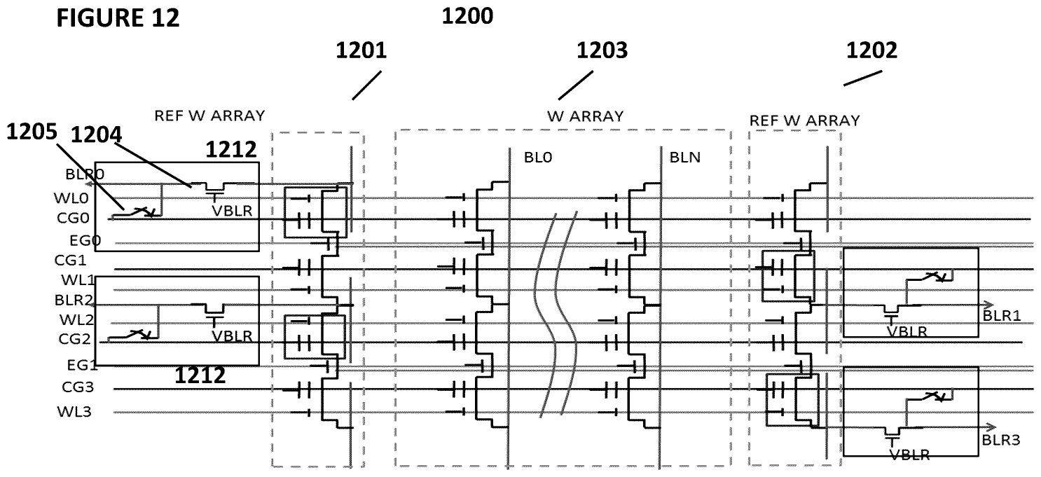

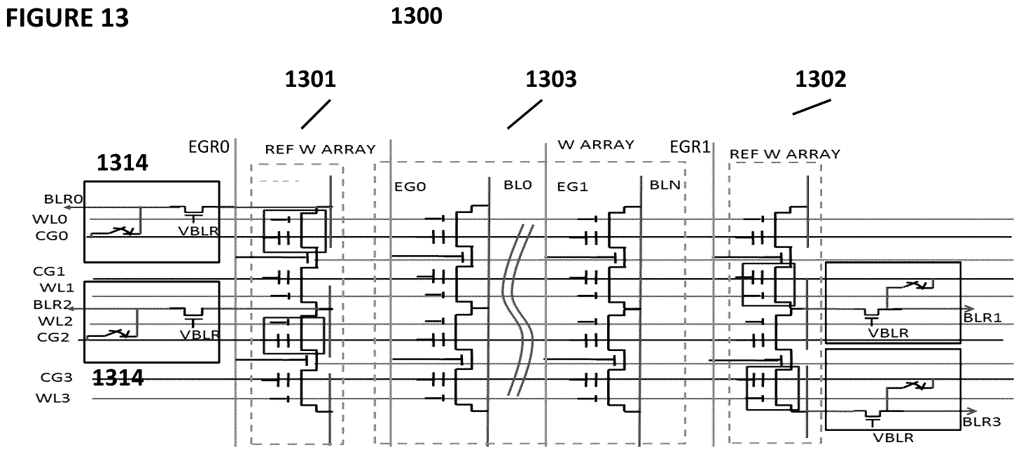

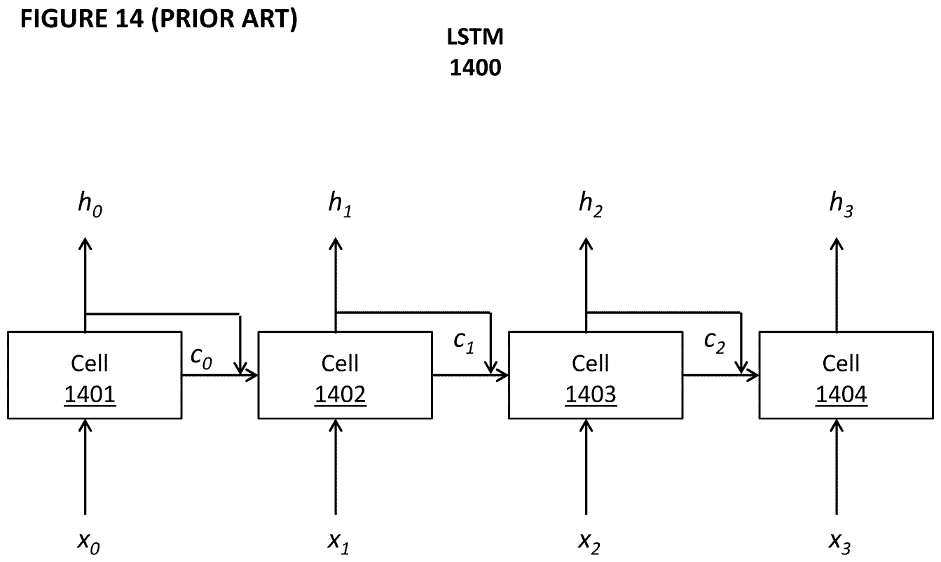

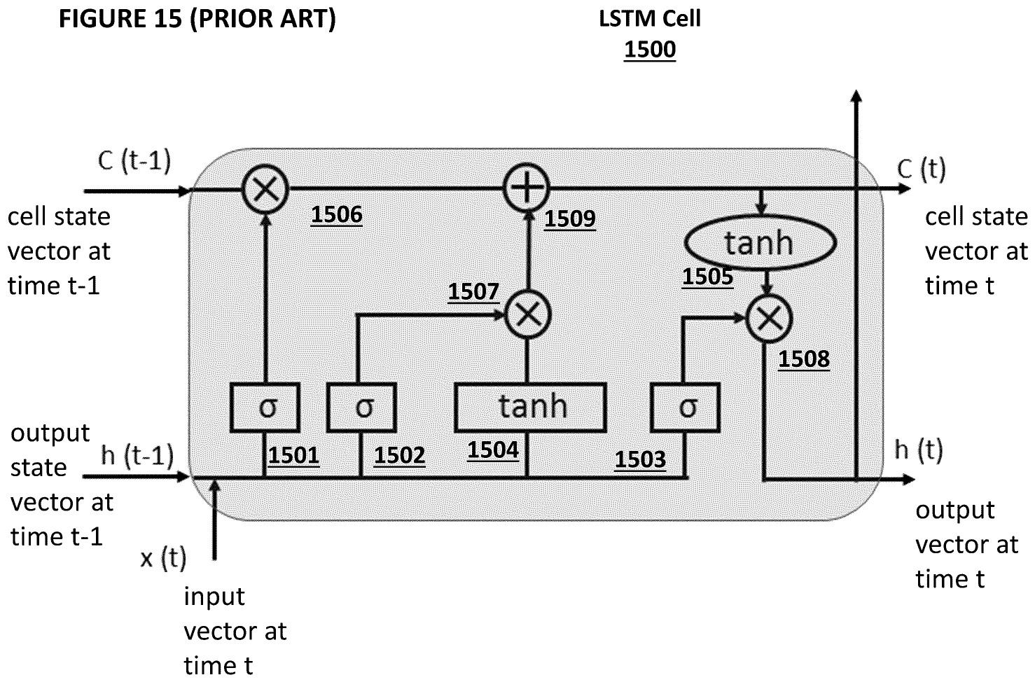

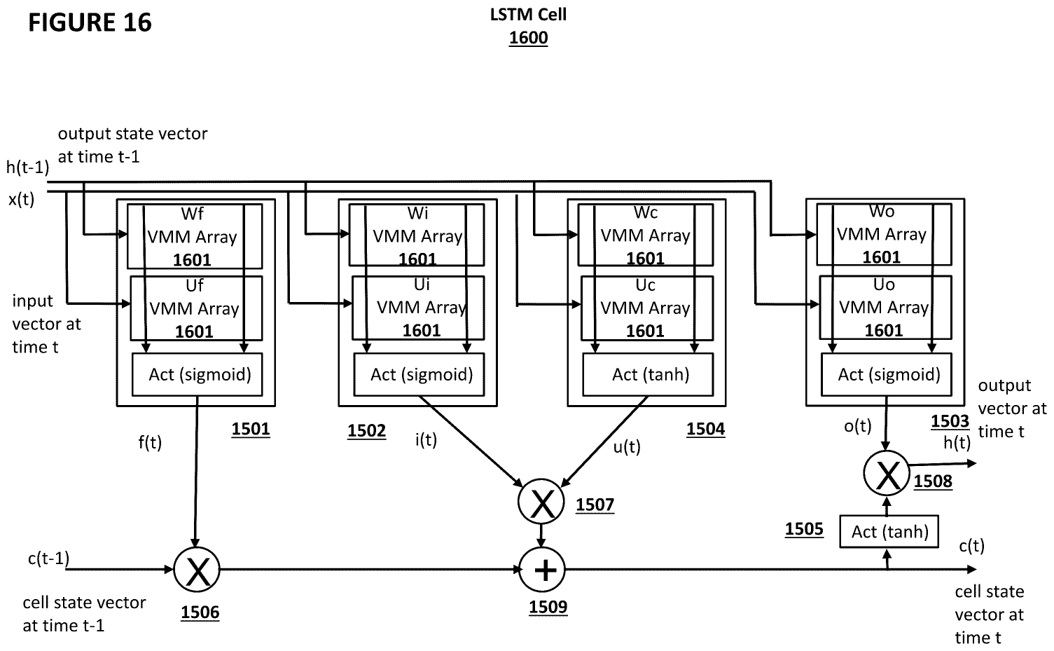

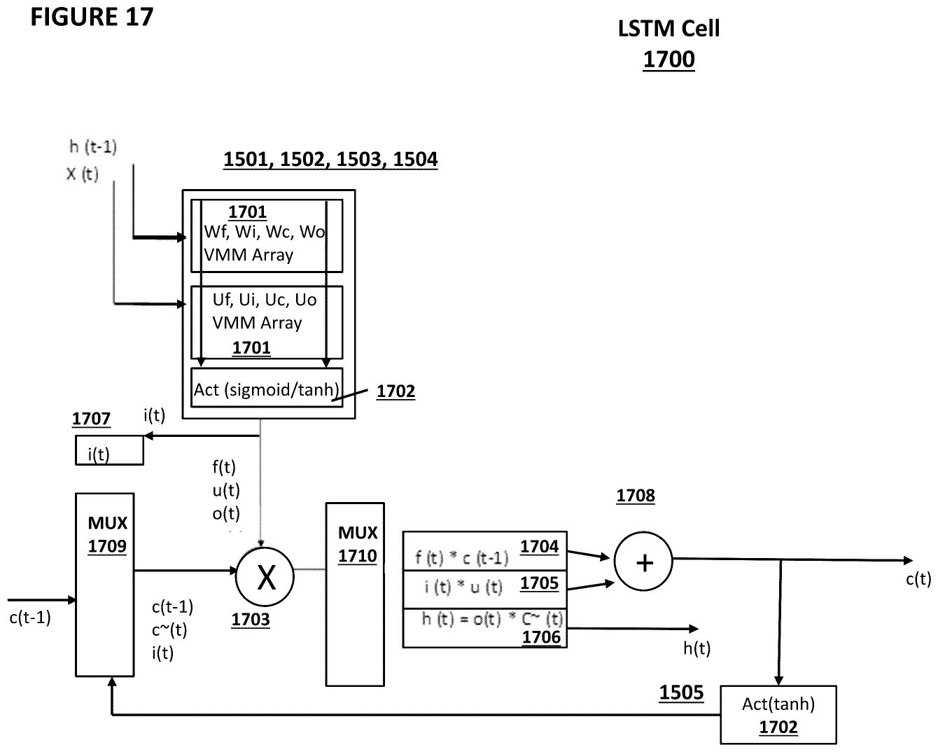

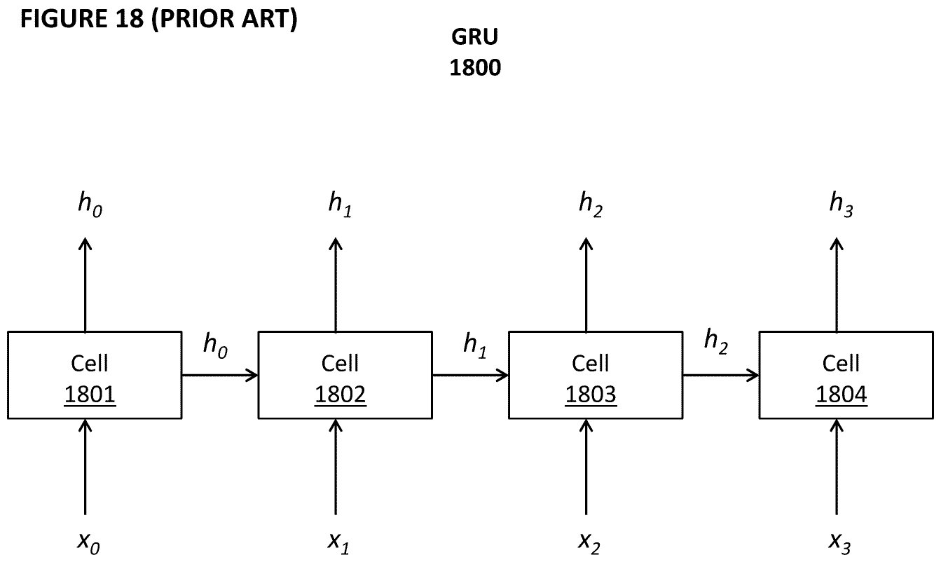

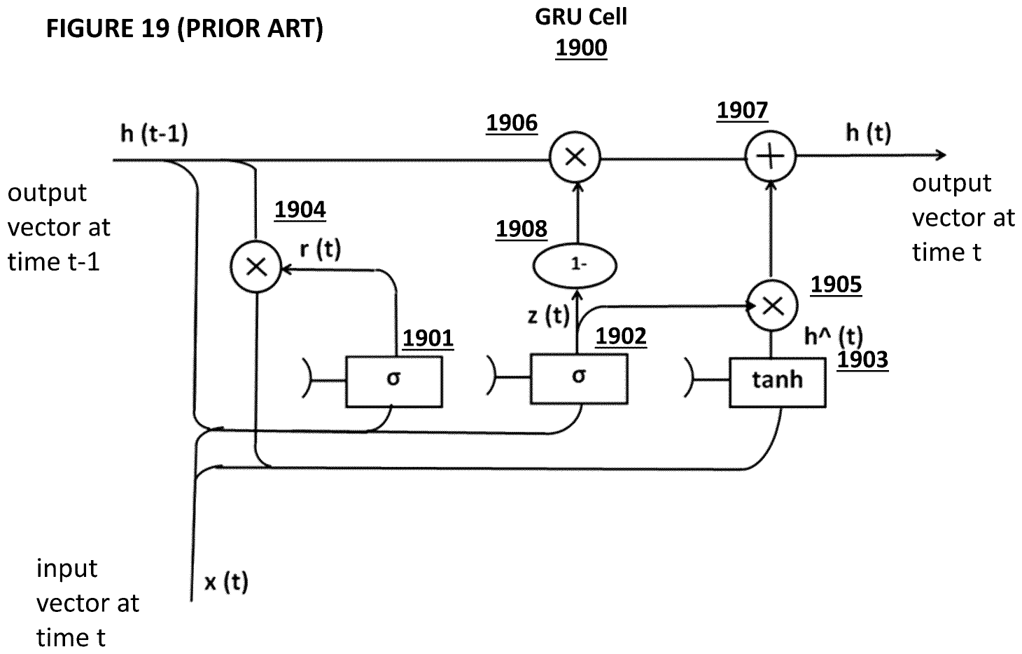

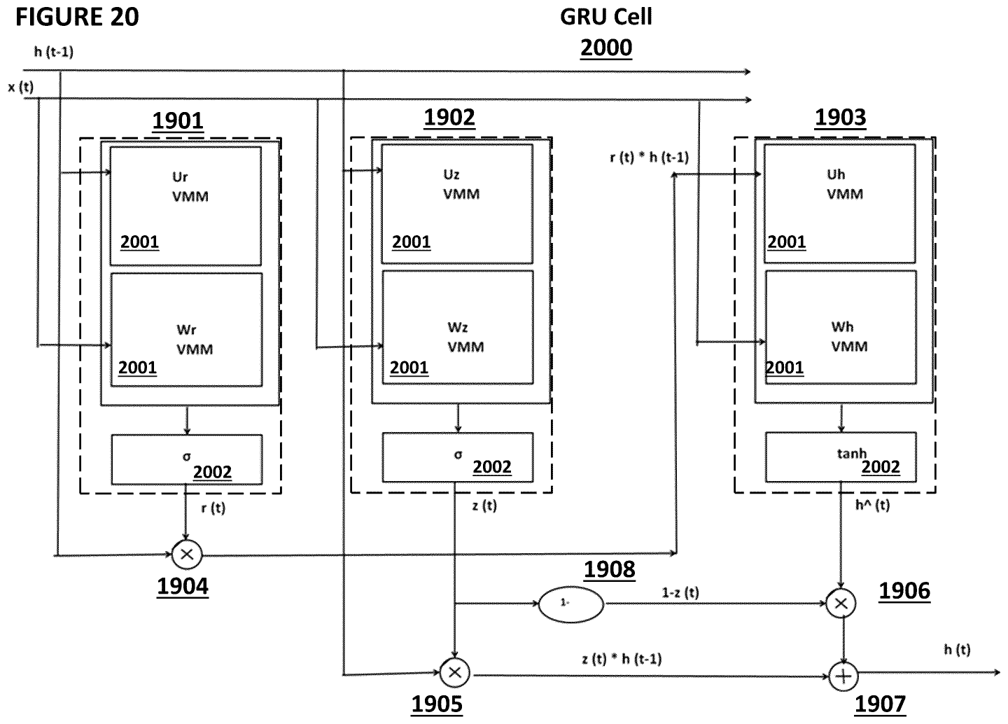

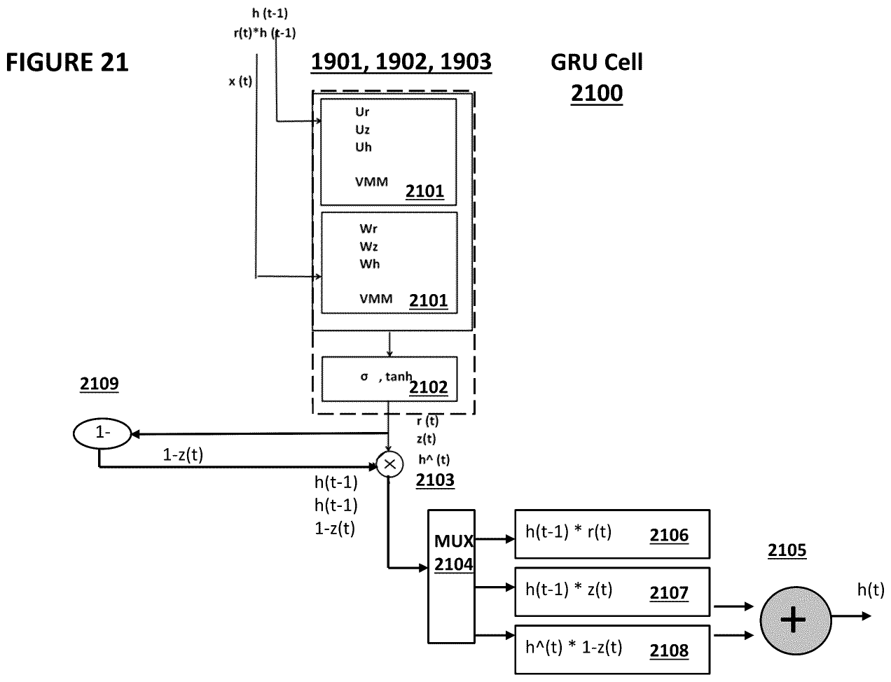

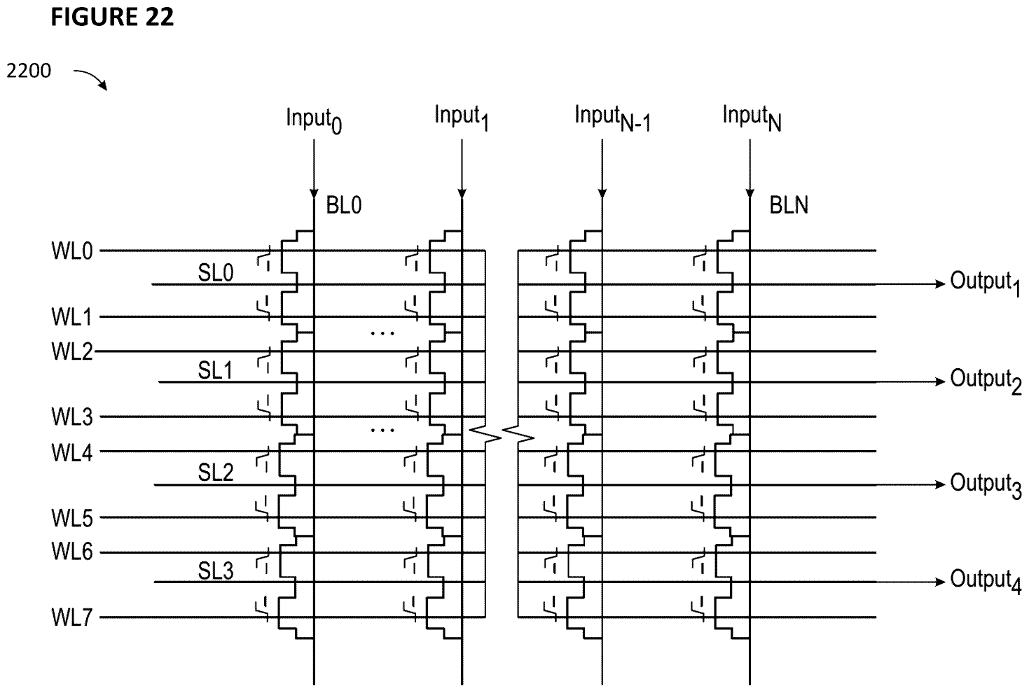

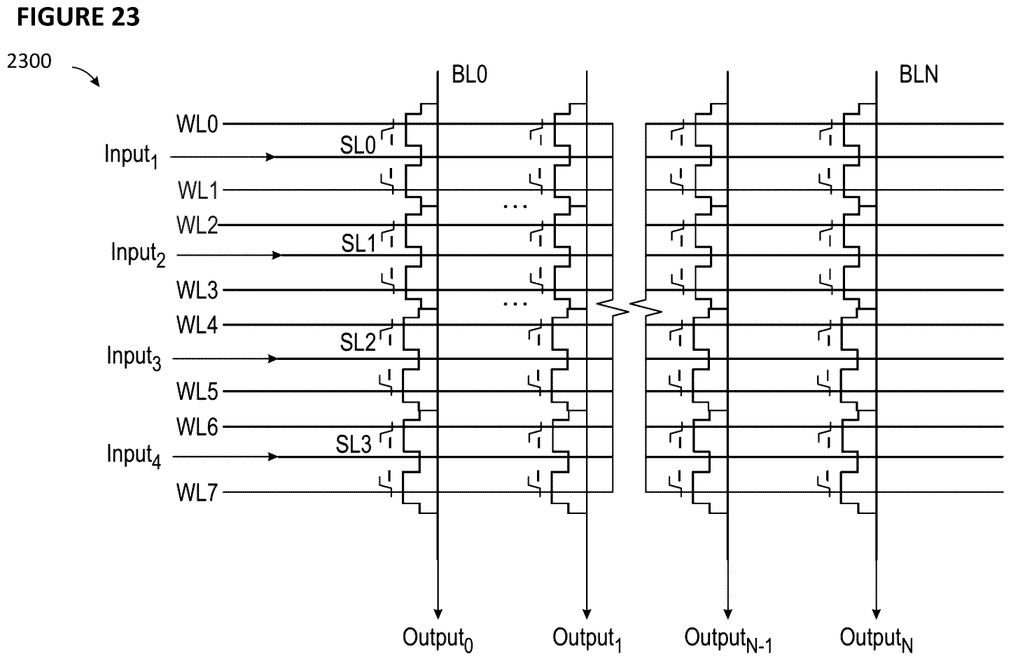

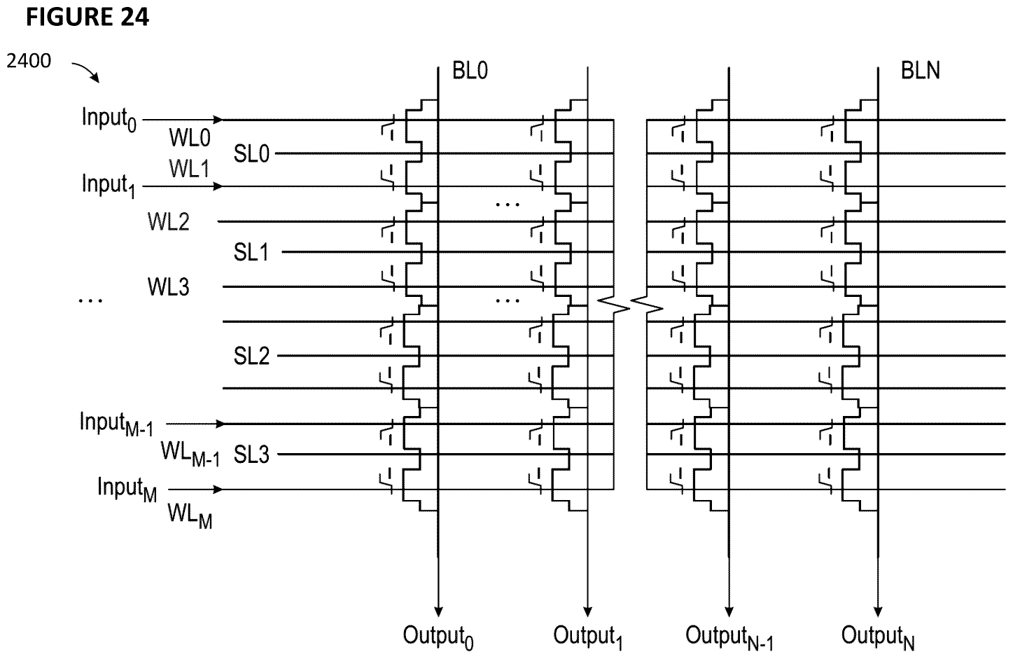

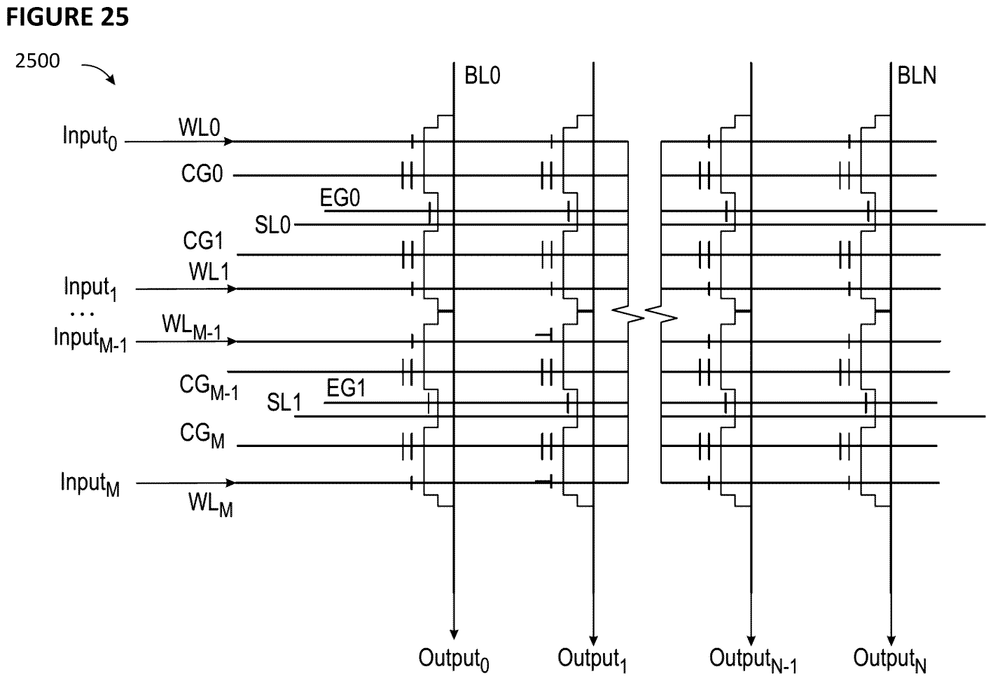

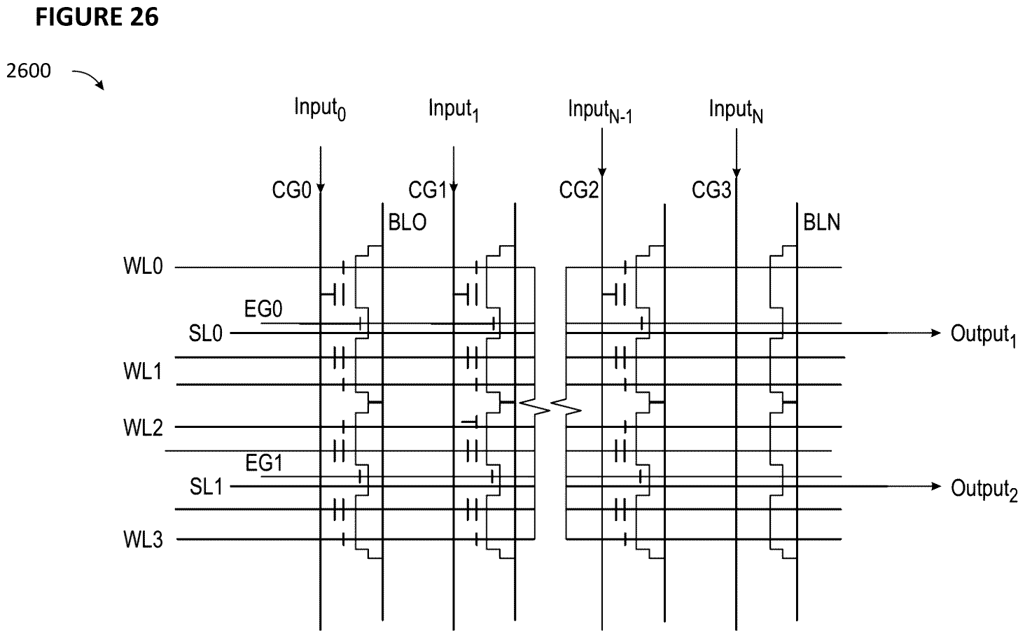

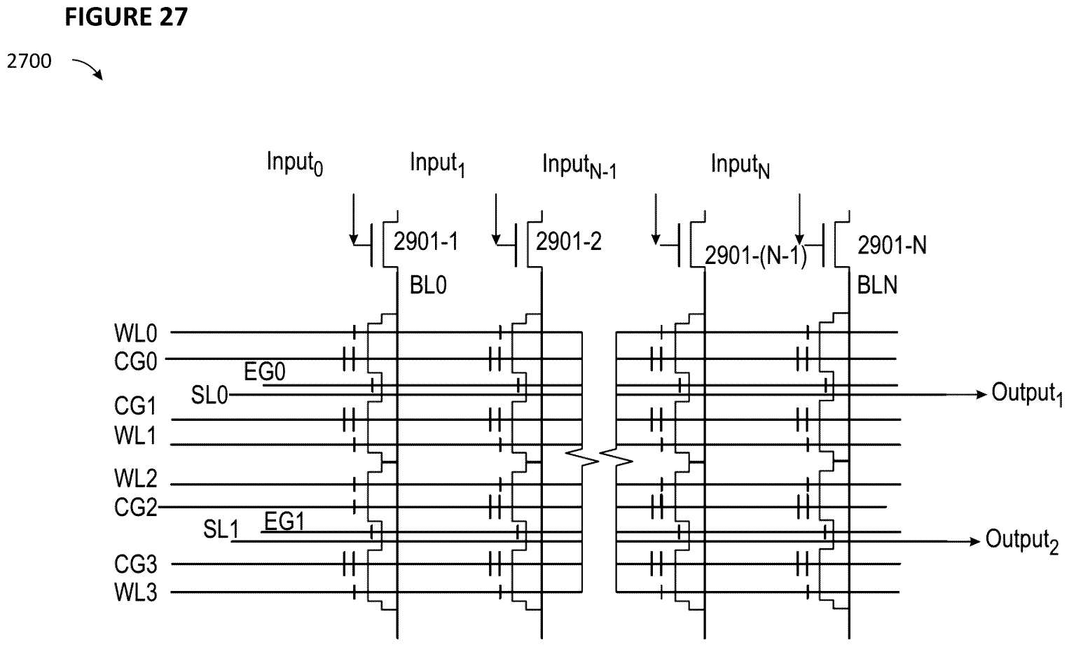

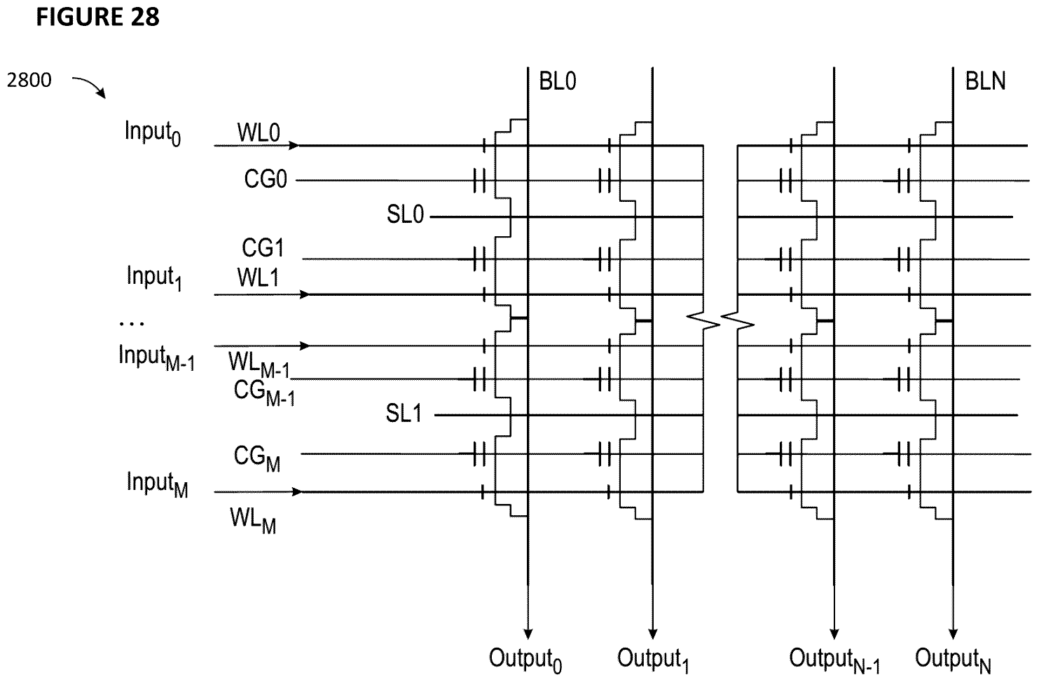

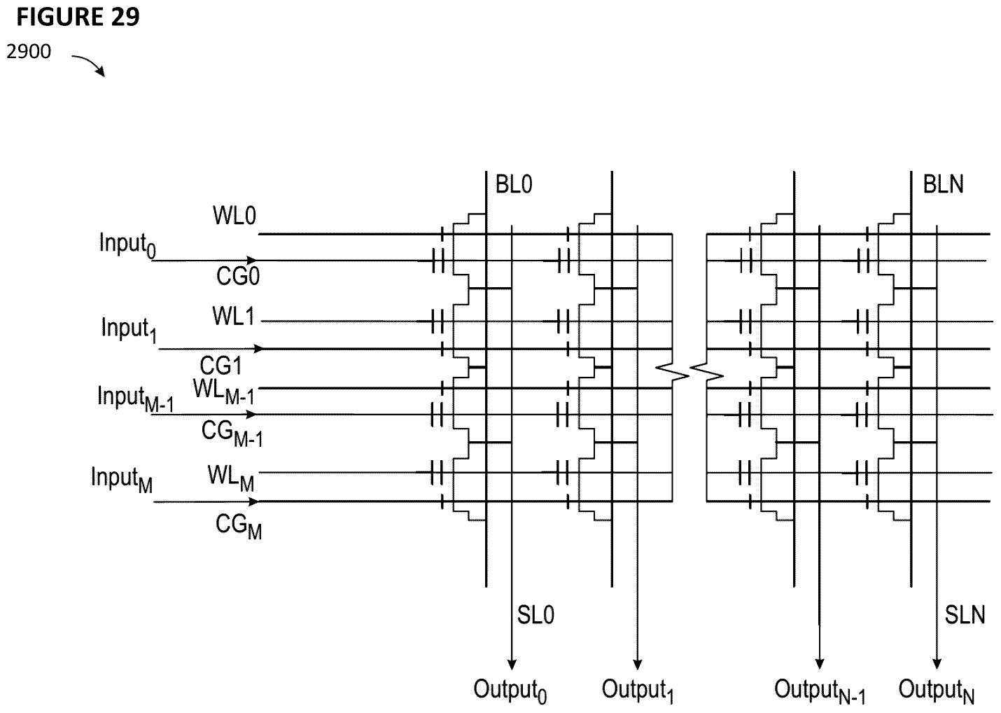

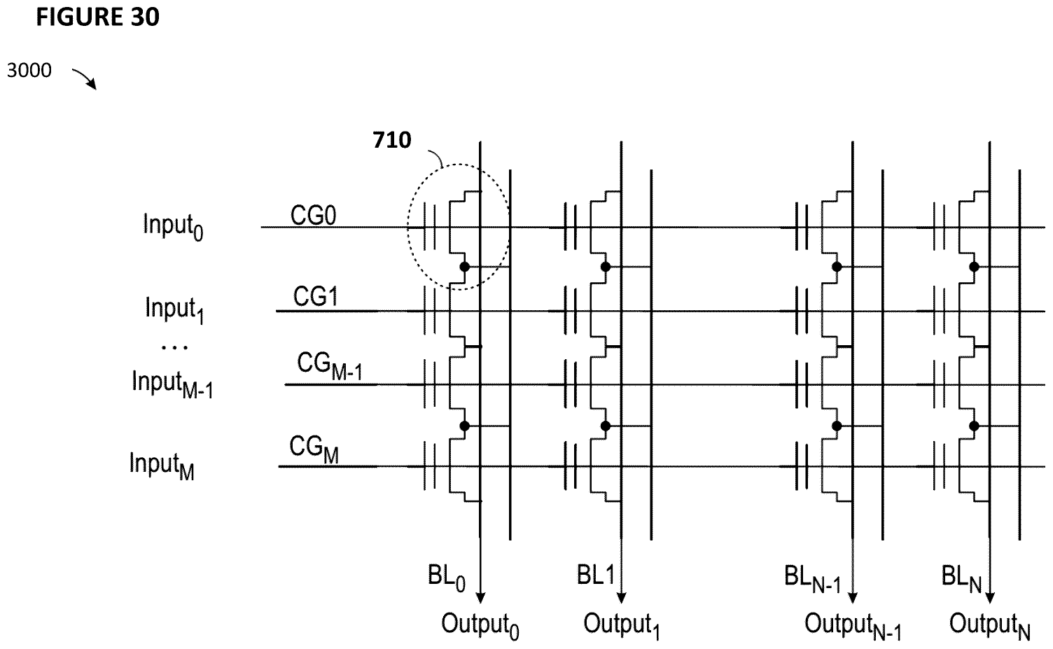

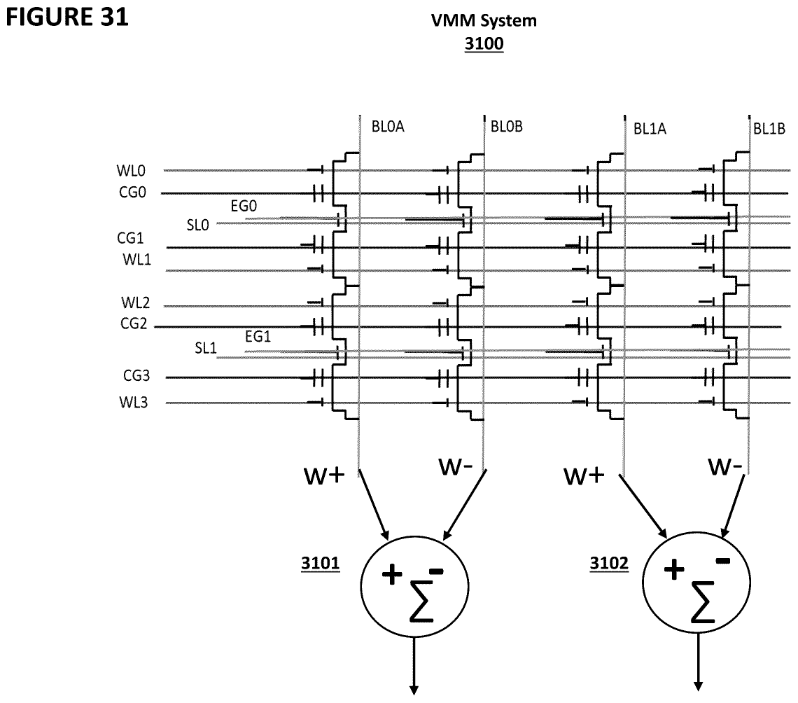

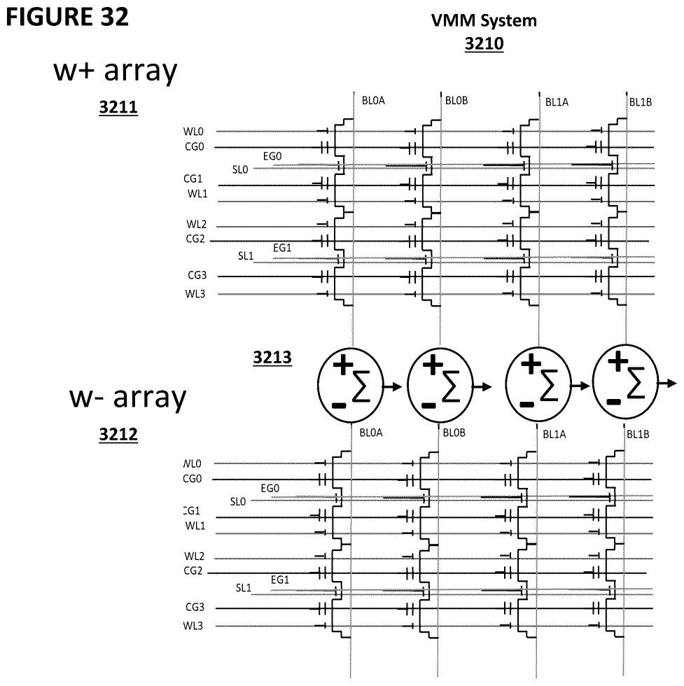

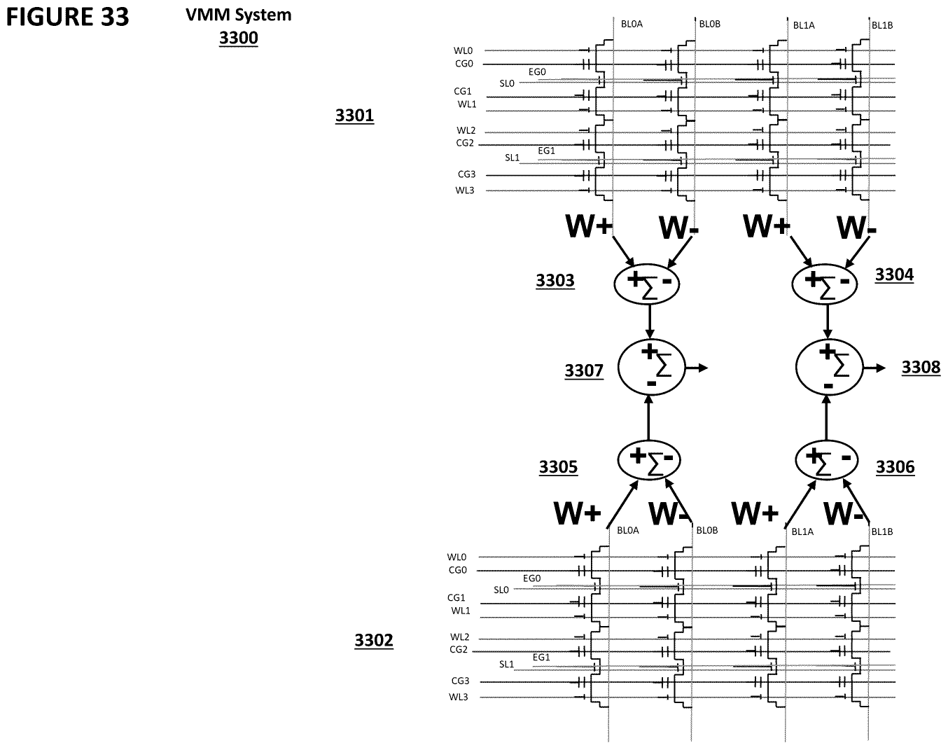

### DETAILED DESCRIPTION OF THE INVENTION

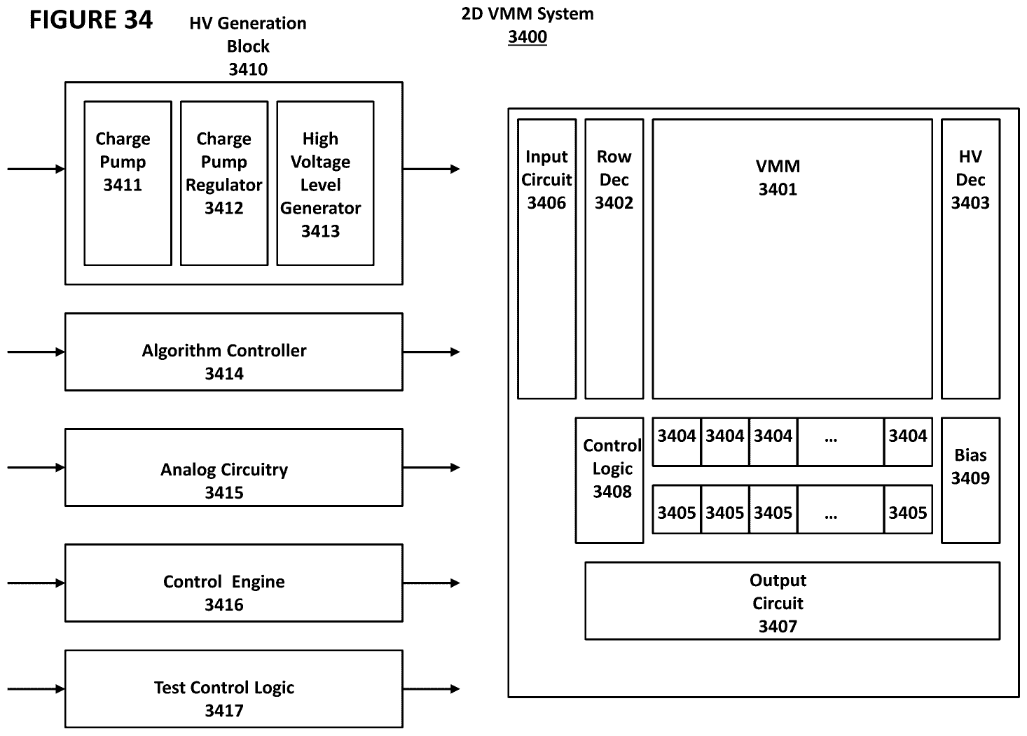

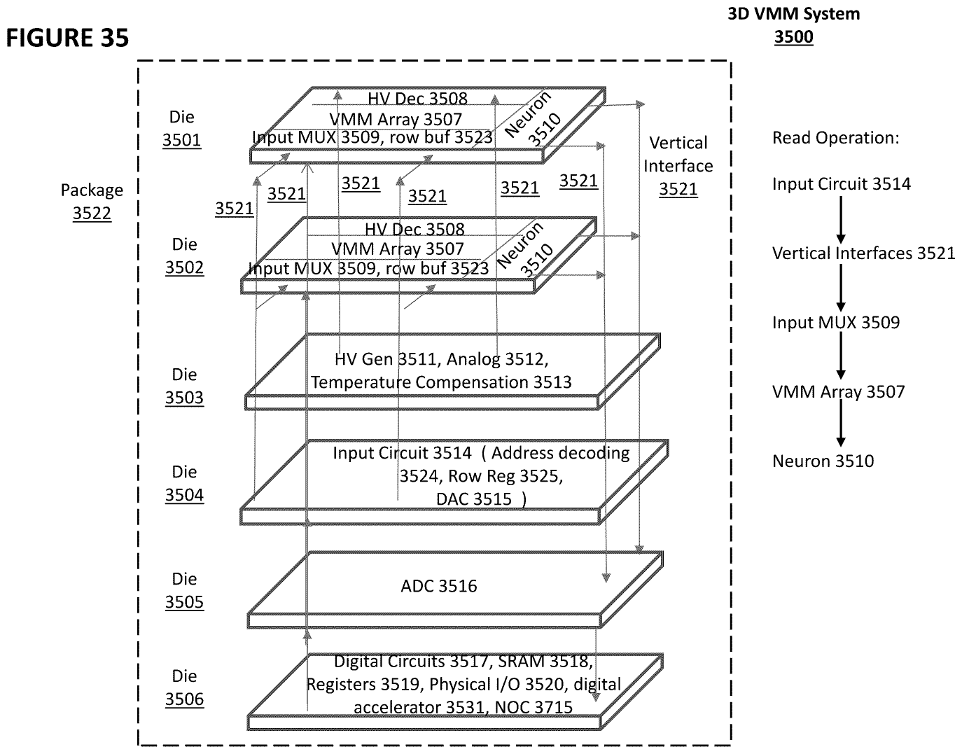

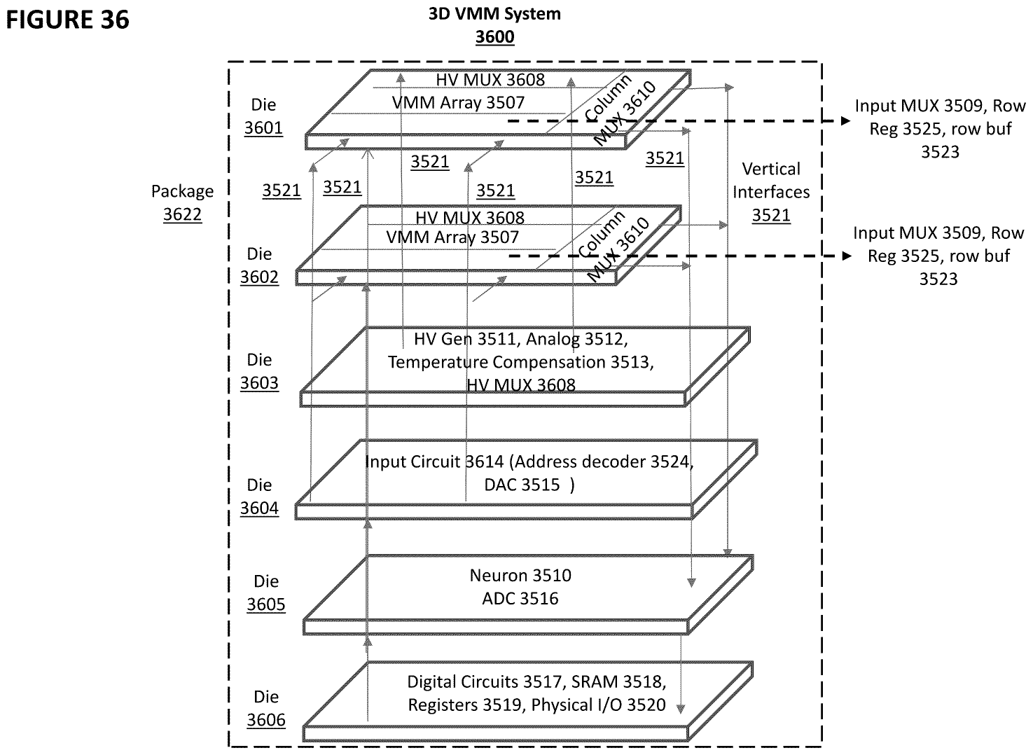

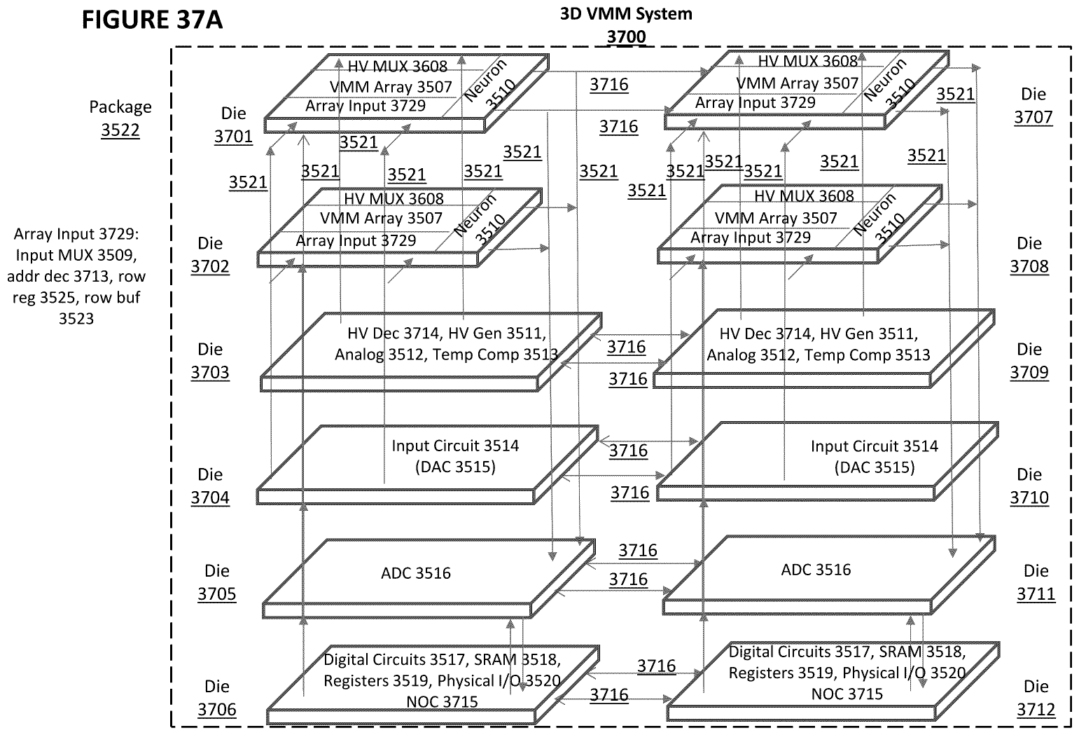

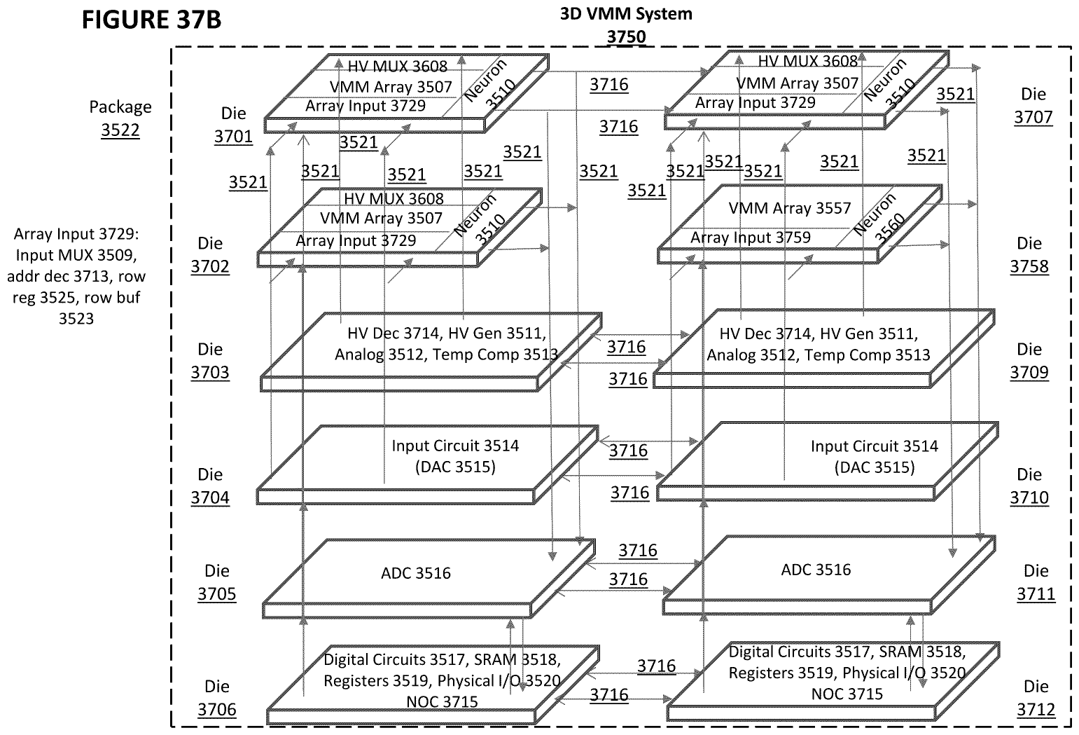

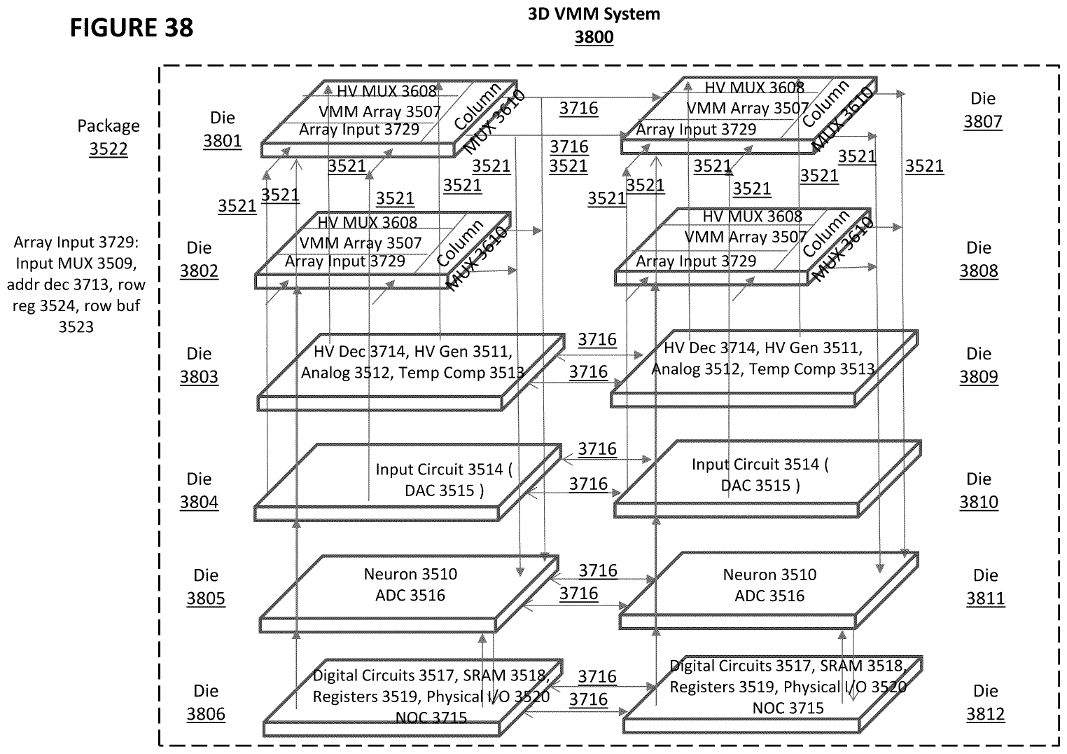

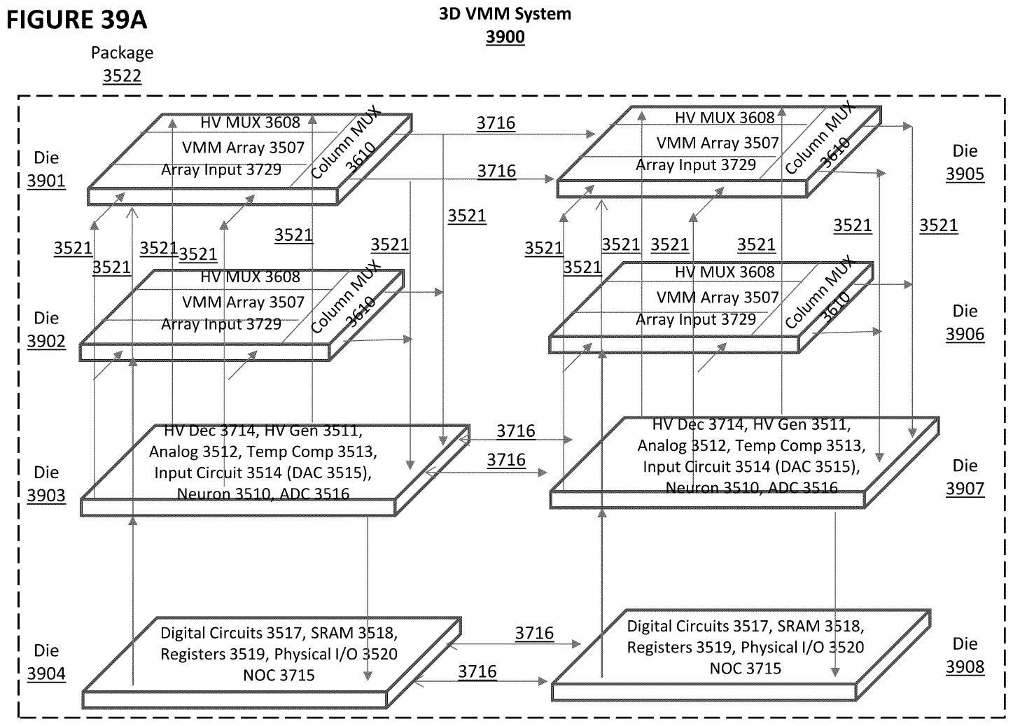

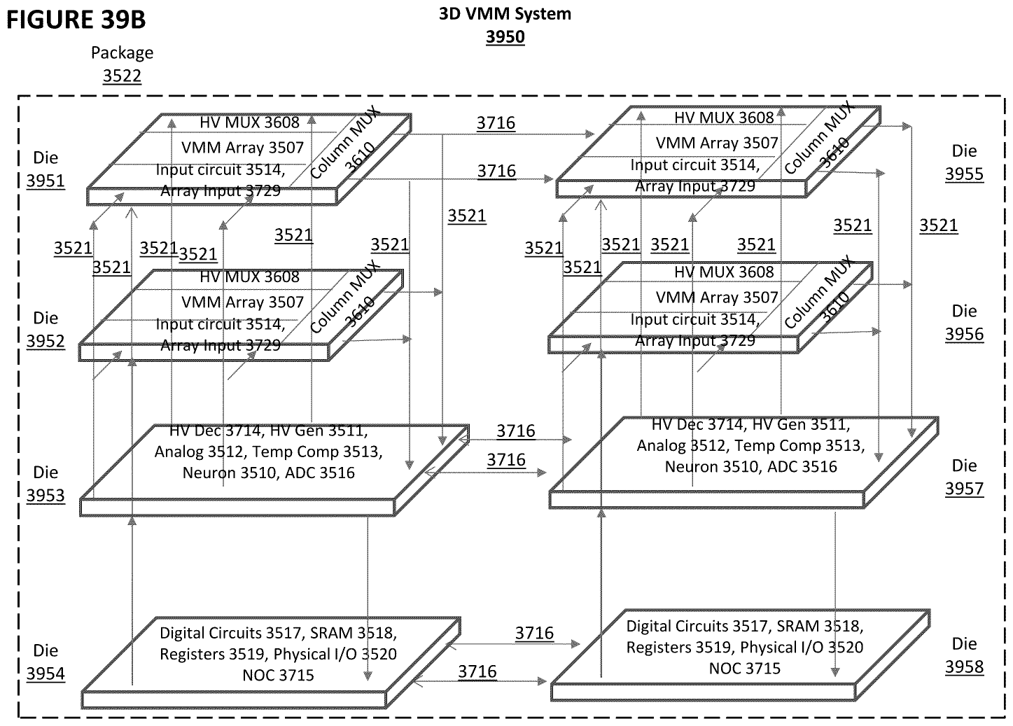

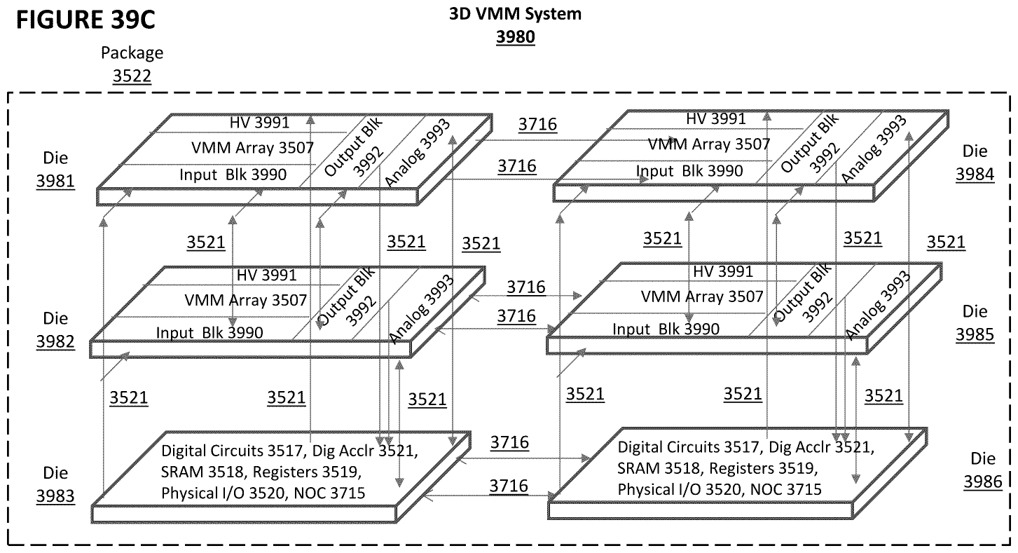

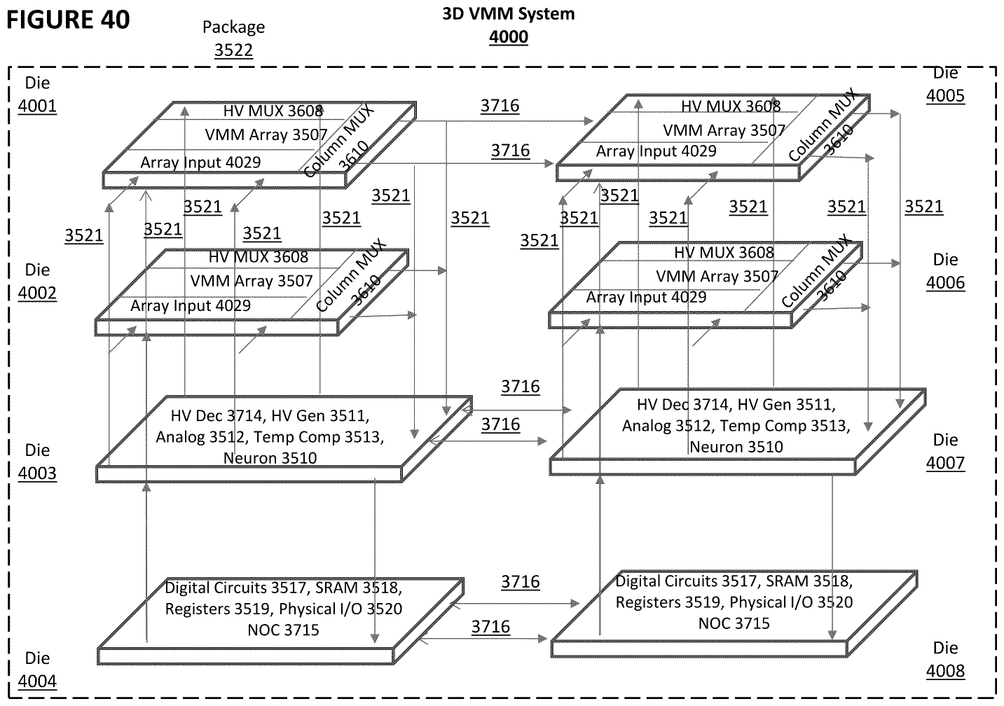

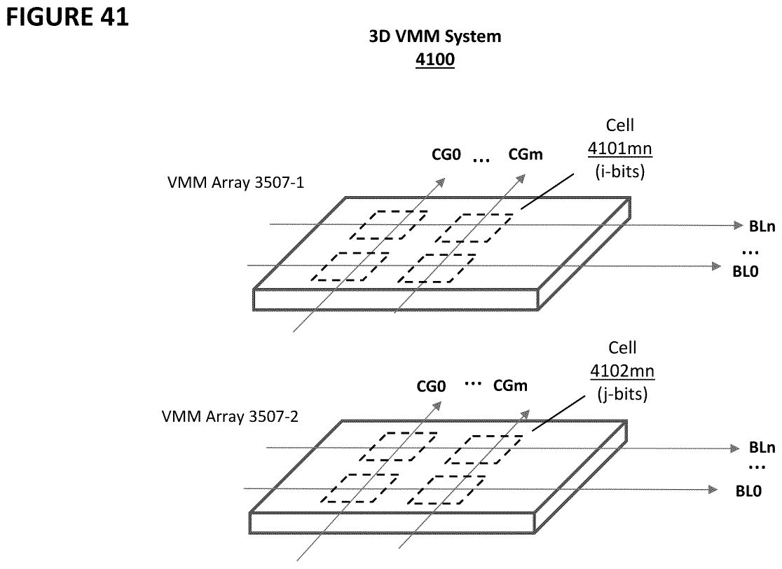

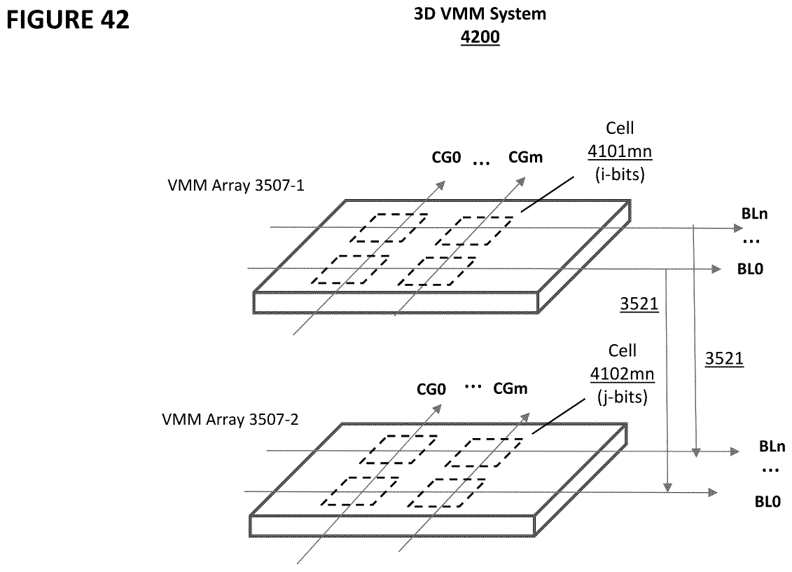

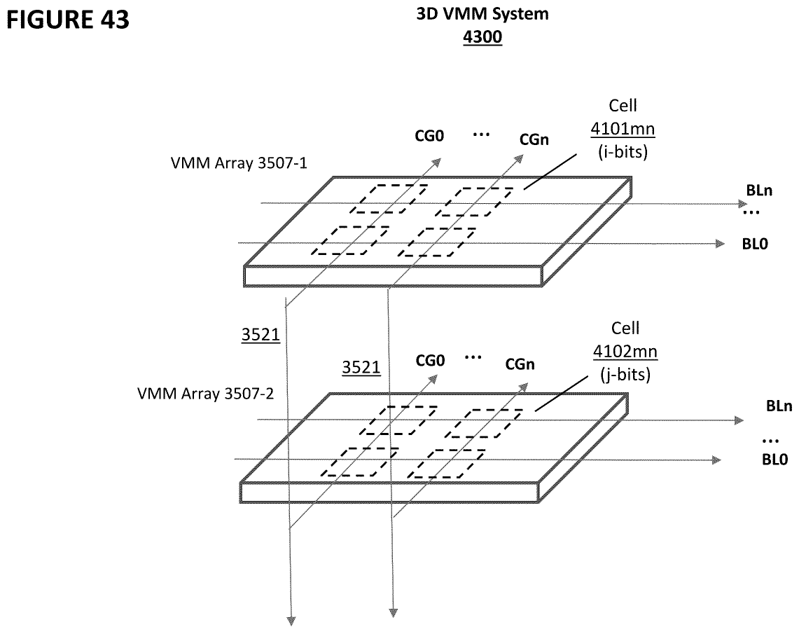

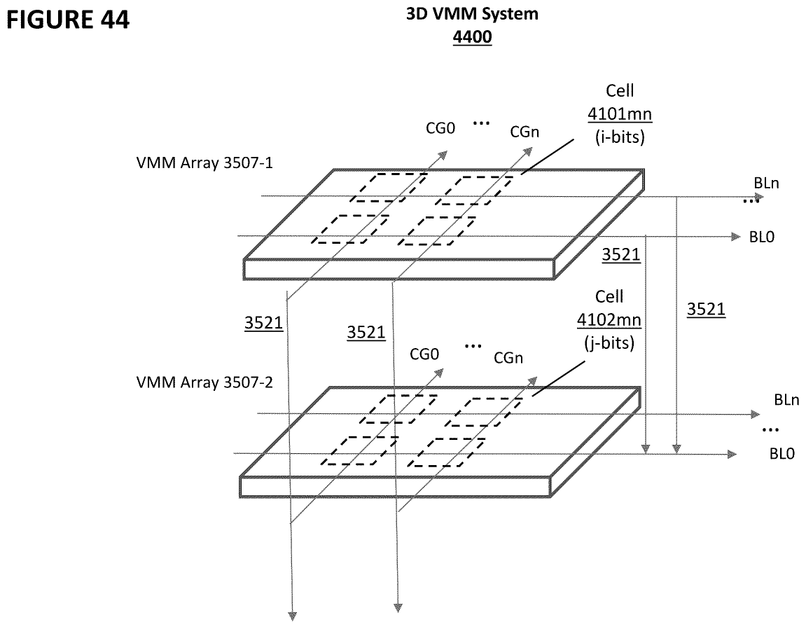

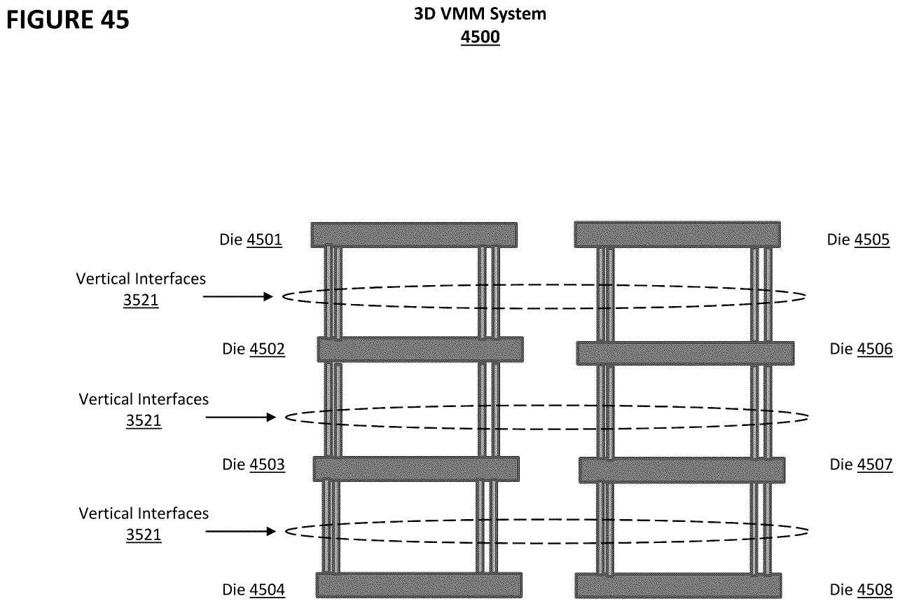

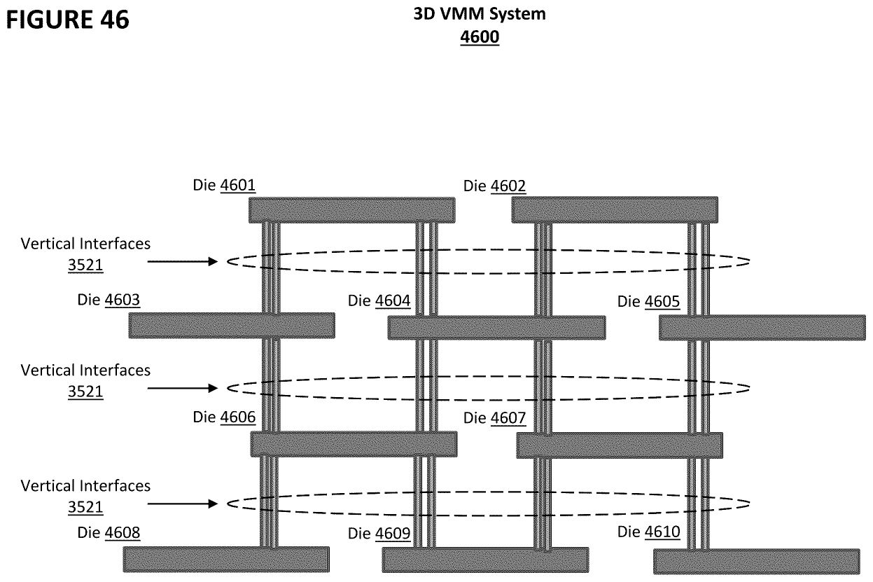

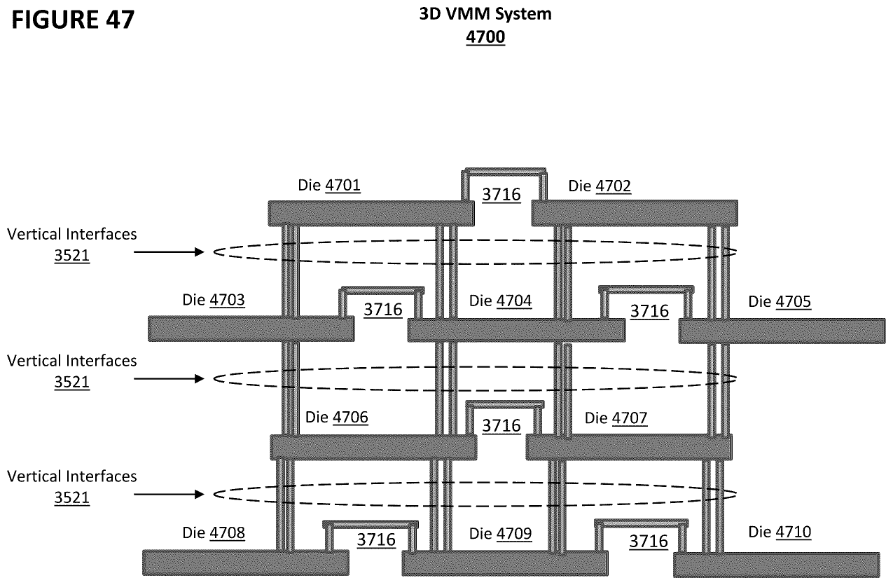

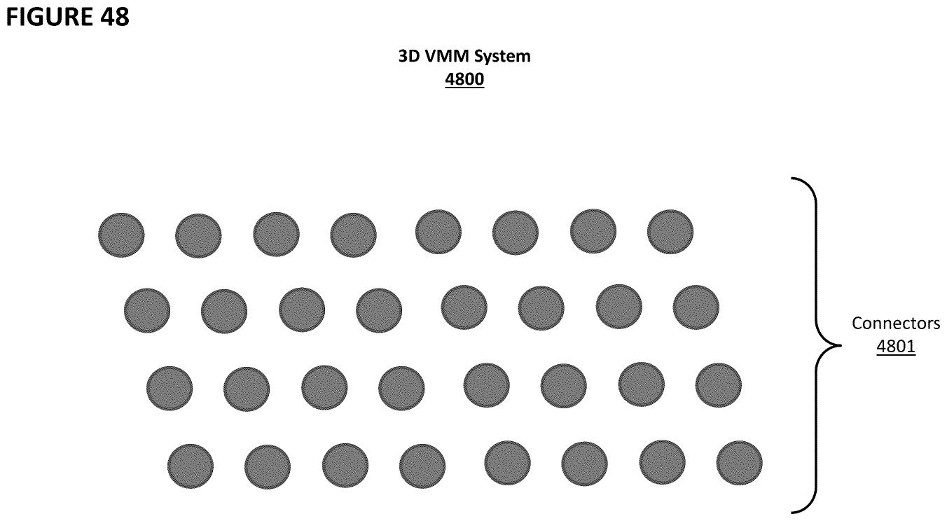

FIG. 49 depicts a block diagram of a 2D VMM system 4900. 2D VMM system 4900 contains many of the same components as 2D VMM system 3400 in FIG. 34, and those components will not be described again. 2D VMM system 4900 also comprises interface circuit 4901. Interface circuit 4901 couples 2D VMM system 4900 to one or more of other 2D VMM systems (not shown) and other devices (not shown) such as external processors or servers. Interface circuit 4901 may comprise a physical layer (PHY) 4902, which optionally can include a network-on-chip (NOC). 2D VMM system 4900 includes logic block 4903, which can comprise an embedded microcontroller (eMCU), embedded NPU (eNPU-a neural processing unit to implement vector processing operations in a single instruction multiple data or SIMD format), DMA (direct memory access) controller (e.g., which facilitates memory mapping from an external address, such as from a DRAM or SRAM, to an internal address of VMM array 3401), BIST (memory built-in self test), ACC (accumulator unit), or Act (activation function), and other circuits.

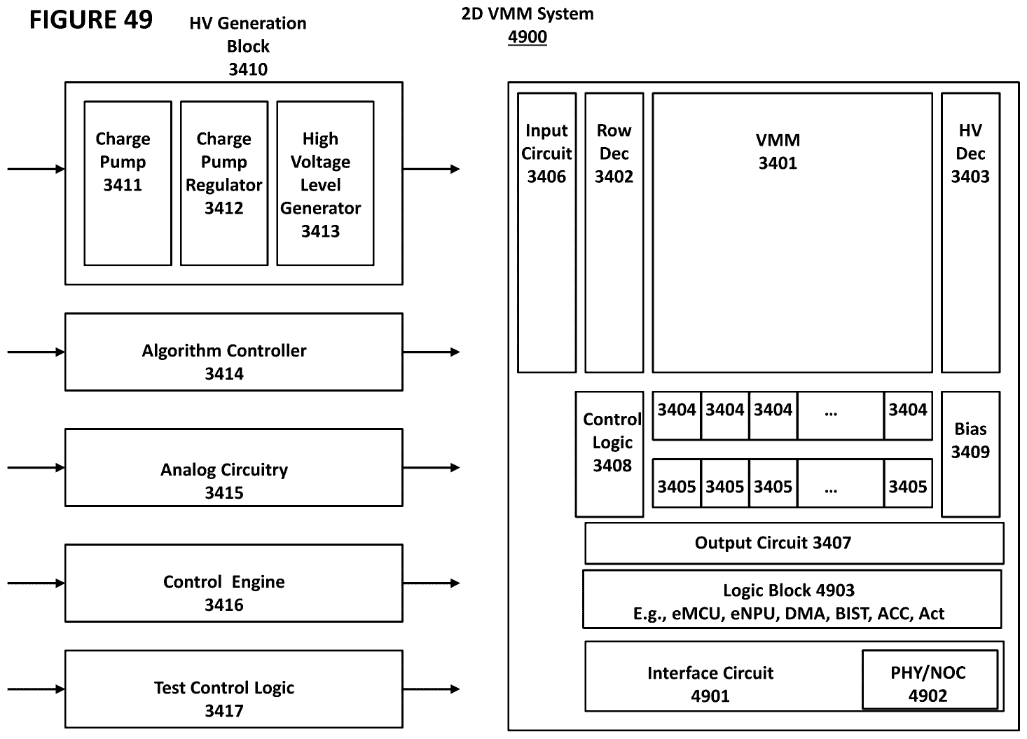

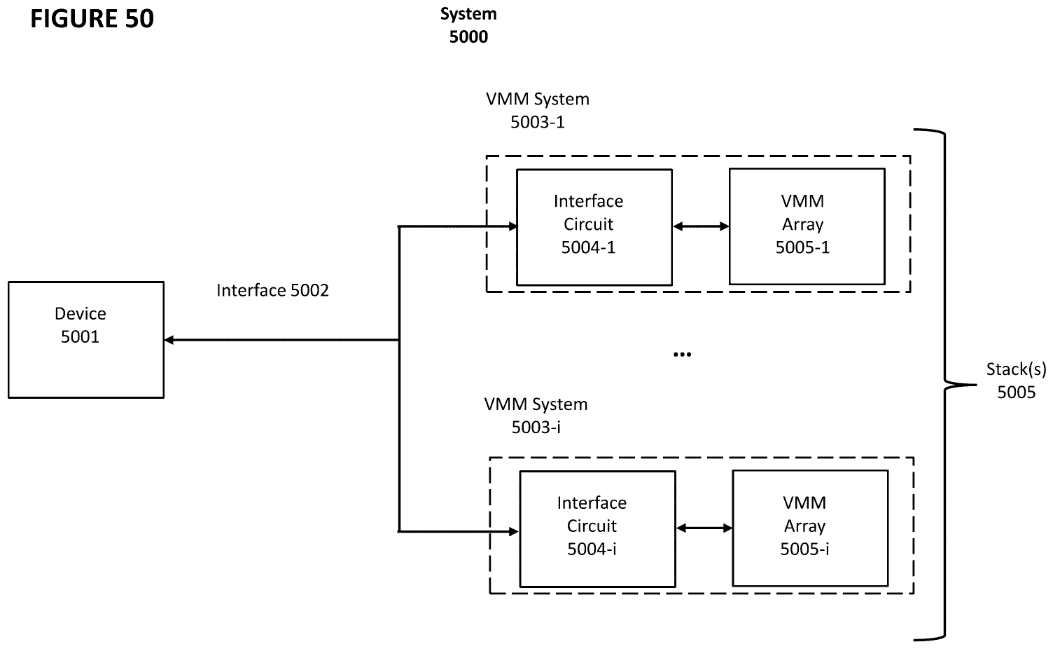

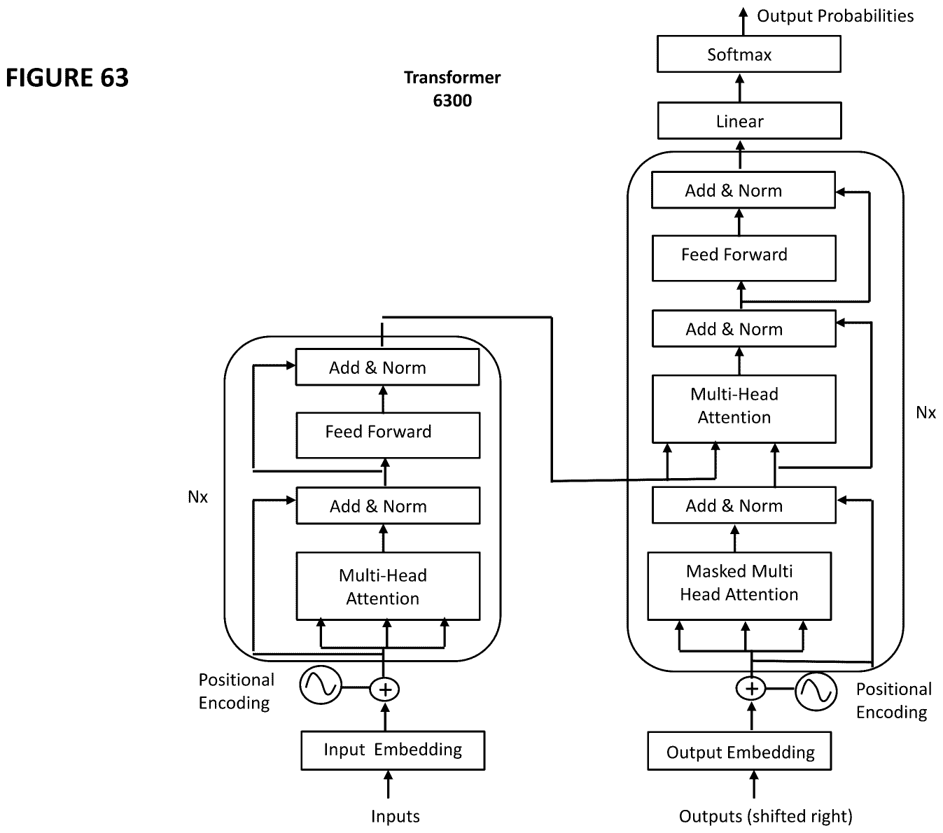

FIG. 50 depicts system 5000. System 5000 comprises device 5001, interface 5002, and VMM systems 5003-1, . . . , 5003-i, where i is an integer and is the number of VMM systems present in system 5000. VMM systems 5003-1, . . . , 5003-i are contained in one or more stacks 5004. Optionally, one or more of VMM systems 5003-1, . . . , 5003-i can implement a static matrix multiplier and one or more of VMM systems 5003-1, . . . , 5003-i can implement a dynamic matrix multiplier. Optionally, such a dynamic matrix multiplier can perform a multiplication Q*K_{T}, where Q is a matrix representing a query, K is a matrix of keys, V is a matrix of values where each value forms a key-value pair with a key in K. Optionally, such a dynamic matrix multiplier can implement a transformer neural network such as transformer neural network 6300 shown in FIG. 63.

Device 5001 is a device external to VMM systems 5003 such as one or more processors or servers. In one example, device 5001 is a device that may request an artificial neural network operation to be performed by one or more of VMM systems 5003. Device 5001 communicates with VMM systems 5003 over interface 5002. Optionally, VMM systems 5003 also can communicate with one another over interface 5002.

VMM systems 5003 can be an example instantiation of 2D VMM System 4900 shown in FIG. 49. VMM system 5003-1 comprises interface circuit 5004-1 (which is an example instantiation of interface circuit 4901 in FIG. 49) and VMM array 5005-1 (which is an example instantiation of VMM array 3401 in FIG. 49). Similarly, VMM system 5003-i comprises interface circuit 5004-i (which is an example instantiation of interface circuit 4901 in FIG. 49) and VMM array 5005-i (which is an example instantiation of VMM array 3401 in FIG. 49). Other VMM systems 5003 comprise the same components.

Interface 5002 enables device 5001 and VMM systems 5003 to exchange commands, addresses, data, and other information. In one example, interface 5002 is directly coupled to all VMM systems 5003. In another example, interface 5002 is directly coupled to a subset of the VMM systems 5003 and is indirectly coupled to the other VMM systems 5003 through one or more of the VMM systems 5003 to which interface 5002 is directly coupled.

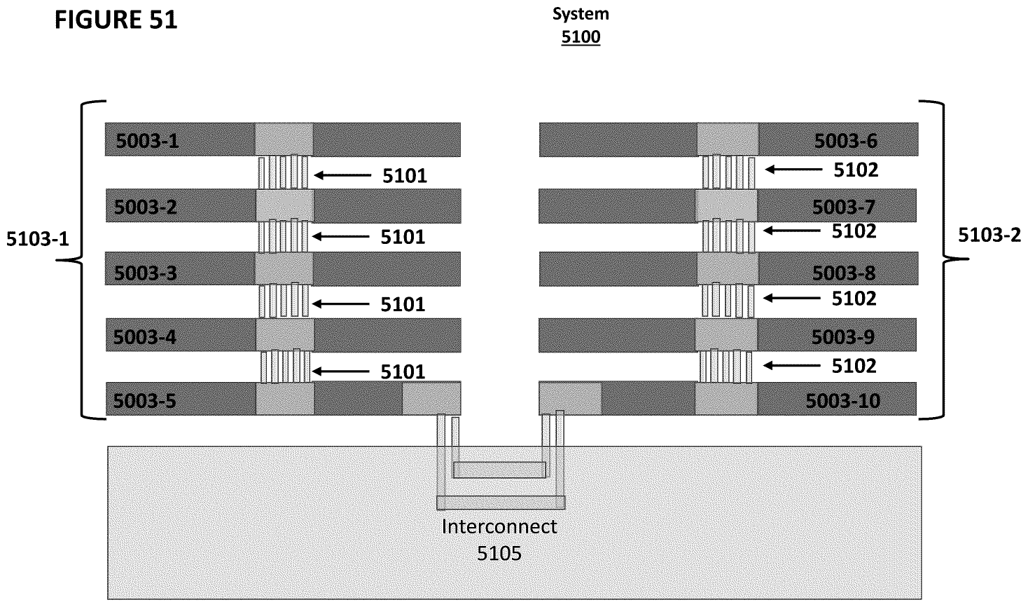

FIG. 51 depicts an example physical layout of system 5100, which is an example instantiation of system 5000 in FIG. 50. System 5100 comprises VMM stack 5103-1 and VMM stack 5103-2. VMM stack 5103-1 comprises VMM system 5003-1, 5003-2, 5003-3, 5003-4, and 5003-5 coupled together by TSVs (through-silica vias) 5101. VMM stack 5103-2 comprises VMM systems 5003-6, 5003-7, 5003-8, 5003-9, and 5003-10 coupled together by TSVs 5102. In one example, TSVs 5101 and 5102 utilize hybrid bonding. One type of hybrid bonding provides a permanent bond that combines a dielectric bond (SiOx) with embedded metal (Cu) to form interconnections. VMM systems 5003-5 and 5003-10 are directly coupled to interconnect 5105. The interconnect 5105 can comprise, for example, an RDL layer in a silicon interposer or a silicon bridge. All other VMM systems 5003 are indirectly coupled to interconnect 5105, and communicate with other VMM systems 5003 through VMM systems 5003-5 and 5003-10 using TSVs 5101 and/or 5102.

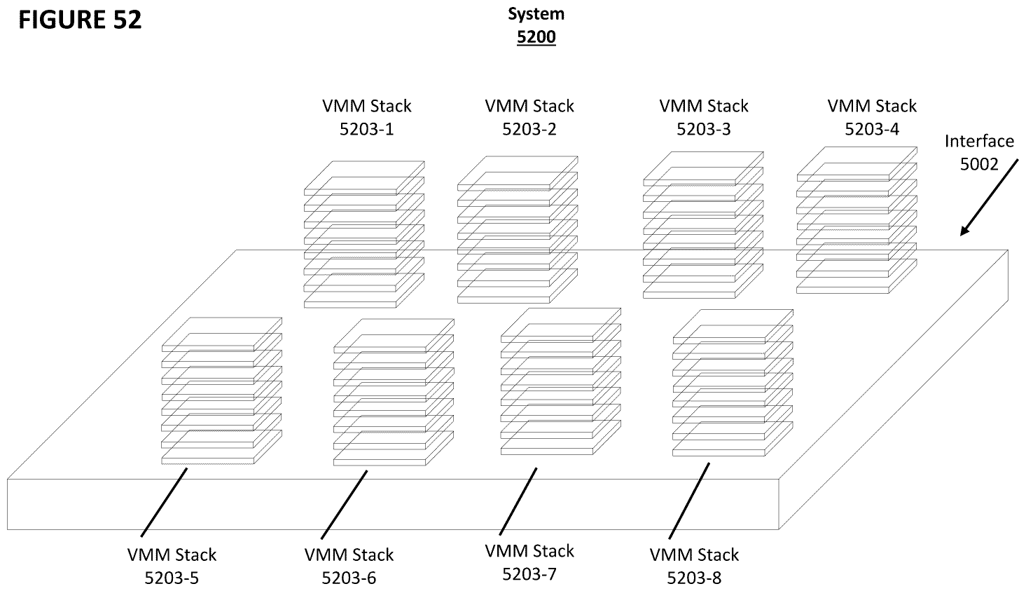

FIG. 52 depicts an example physical layout of system 5200, which is an example instantiation of system 5000 in FIG. 50. System 5200 comprises VMM stacks 5203-1, 5203-2, 5203-3, 5203-3, 5203-4, 5203-5, 5203-6, 5203-7, and 5203-8. Each VMM stack 5203 comprises a plurality of VMM systems coupled by TSVs in the same manner as VMM stacks 5103-1 and 5103-2 in FIG. 51. Each VMM stack 5203 is coupled to interface 5002. For example, the bottom VMM system of the respective VMM stacks 5203-1, 5203-2, 5203-3, 5203-3, 5203-4, 5203-5, 5203-6, 5203-7, and 5203-8 are directly coupled to interface 5002.

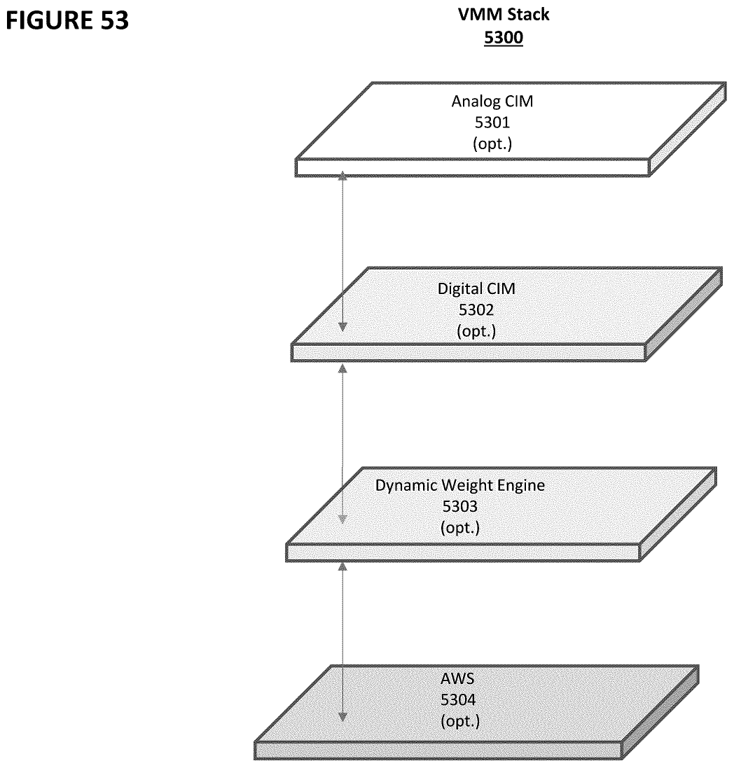

FIG. 53 depicts an example of VMM stack 5300, which is an example of a VMM stack that can be used as VMM stacks 5103 in FIG. 51 and VMM stacks 5203 in FIG. 52. The VMM systems in VMM stack 5300 optionally can implement an analog compute-in memory (CIM) system 5301, a digital CIM system 5302, a dynamic weight engine 5303, and an analog weight storage (AWS) 5304. Digital CIM system 5302 comprises a VMM array that operates in the digital domain where the values stored in respective non-volatile memory cells of the VMM array are binary values, meaning that the VMM array can comprise an SRAM, DRAM, or other memory array that stores binary values or a flash memory array or other array that can store binary values or analog values. Analog CIM system 5301 comprises a VMM array that operates in the analog domain where the values stored in each non-volatile memory cell are analog values, such as a VMM array comprising analog multi-level memory cells.

Interface 5002 in FIGS. 50 and 52 can be a parallel interface (such as a parallel memory interface) or a serial interface (such as a serial memory interface) and can comply in whole or in part with one or more legacy standards such as an AXI (Advanced extensible Interface) standard, a DDR (double data rate) standard, an MBMx (High Bandwidth Memory) standard, a PCIe (Peripheral Component Interconnect Express) standard, HBM (High Bandwidth Memory) standard, a UCIe (Universal Command Control Interface), or other standard, without limitation.

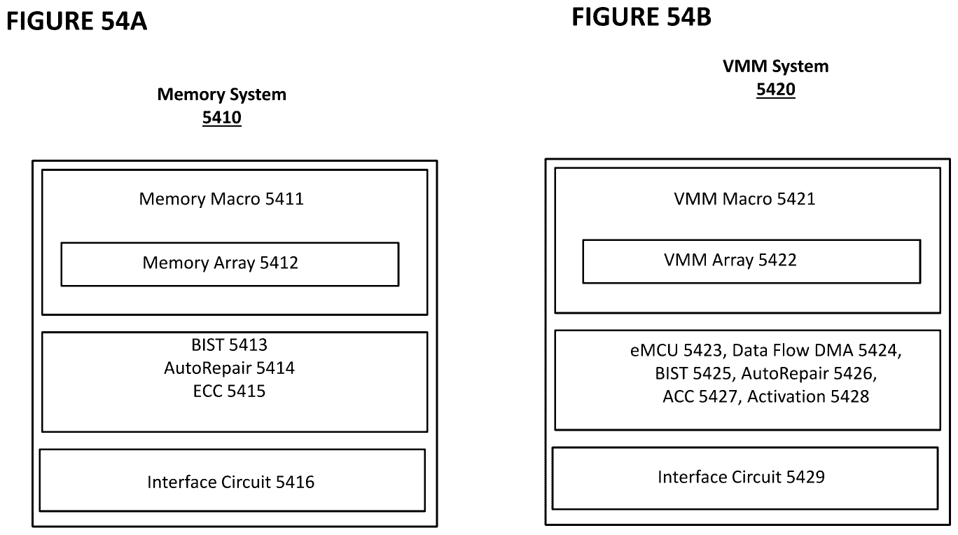

FIG. 54A depicts memory system 5410, which comprises memory macro 5411 (which memory macro 5411 comprises memory array 5412 and circuitry to support memory array 5412), BIST circuit 5413 (to perform testing during a calibration process), autorepair circuit 5414 (to apply redundancy when defective cells are detected), ECC circuit 5415 (to correct errors encountered during the read process), and interface circuit 5416. Memory array 5412 serves as a memory device that stores digital data in respective memory cells and is not configured to be a VMM array in this example. Memory macro 5411 comprises circuitry to support memory array 5412 such as a row decoder, column decoder, and sense amplifier.

FIG. 54B depicts VMM system 5420, which comprises VMM macro 5421 (which VMM macro 5412 comprises VMM array 5422), eMCU 5423 (to control operations), data flow DMA 5424 (to facilitate data transfers between system input and VMM array input), BIST circuit 5425, autorepair circuit 5426, accumulator circuit 5427, activation circuit 5428, and interface circuit 5429. VMM macro 5421 comprises circuitry to support VMM memory array 5422 such as a row decoder, column decoder, and sense amplifier.

Interface circuits 5416 and 5429 can be coupled to an interface such as interface 5002 in FIG. 50 or interconnect such as interconnect 5105 in FIG. 51.

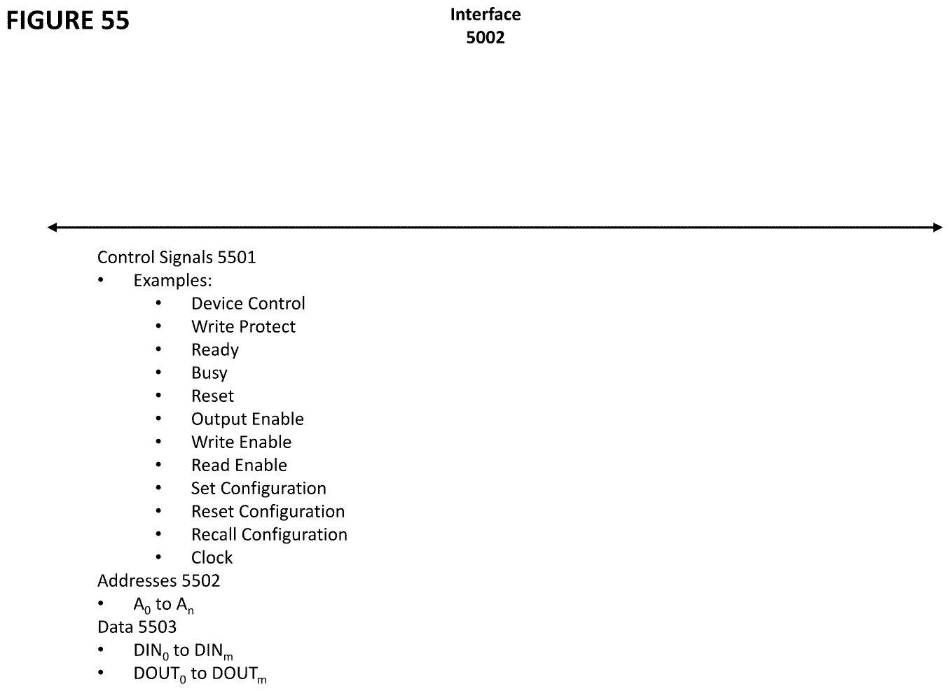

FIG. 55 depicts detail regarding a single instance of interface 5002. At the physical layer, interface 5002 comprises one or more electrical paths to carry control signals 5501, addresses 5502, and data 5503 in a parallel manner, a serial manner, or a combination of both.

Addresses 5502 comprises address bits A₀ to Aₙ, where each address comprises n+1 bits. Addresses can be used to read or write data from a specific location in a specific VMM array.

Data 5503 comprises data bits D₀ to Dₘ (D or data-in DIN, expressed as DIN₀ to DINₘ, or data-out DOUT, expressed as DOUT₀ to DOUTₘ), where each datum comprises m+1 bits. Data 5503 can comprise input data DIN (data send to a VMM system) or output data DOUT (data received from a VMM system). In one example, interface 5002 provides data 5503 in a parallel manner, for example, by providing data bits Do to Dm concurrently on different electrical paths. In another example, interface 5002 provides data 5503 in a serial manner, for example, by providing data bits Do to Dm on the same path in a time-multiplexed manner. In another aspect, in one example, interface 5002 can utilize the same path(s) for both input data and output data. In another example, interface 5002 comprises separate path(s) for input data and output data.

Control signals 5501 can comprise all or a subset of the control signals described in Table No. 9:

TABLE NO 9
CONTROL SIGNALS FOR INTERFACE 5002

| Command | Description |
|---|---|
| Device Control | Because interface 5002 is shared by a plurality of VMM |
| | systems, where each VMM system can be located on a |
| | different chip or a different die, a Device Control signal |
| | can be used to enable a chip or die containing the VMM |
| | system of interest for purposes of the commands that |
| | follow. In one example, the Device Control signal |
| | comprises p signal lines, where the number of chips or die |
| | coupled to interface 5002 is ≤ p. A particular chip or die is |
| | selected by setting its signal line to a first value (e.g., “1”) |
| | and the other chips or dies are deselected by setting their |
| | signal lines to a second value (e.g., “0”). In another |
| | example, the Device Control signal comprises q signal |
| | lines, where the q signal lines transmit an encoded |
| | sequence that can be decoded to uniquely identify a chip or |
| | die, where the number of chips or die coupled to interface |
| | 5002 is ≤ 2^{q}. For example, if there are 4 chips or die, then |
| | q can be 2, where the 4 chips or die are uniquely identified |
| | by the bit combinations 00, 01, 10, and 11 on the q signal |
| | lines. |
| Write Protect | A Write Protect signal is used to instruct a VMM system |
| | that no writes to the system are to be allowed. |
| Ready | A Ready signal is a signal from a VMM system indicating |
| | it is Ready to receive an operation. In one example, the |
| | Ready signal can include, or can be sent in conjunction |
| | with, a unique identifier for the VMM system that is |
| | sending the Ready signal. In another example, each VMM |
| | system has its own dedicated Ready signal. |
| Busy | A Busy signal is a signal from a VMM system indicating it |
| | is busy performing an operation and cannot perform a new |
| | operation. In one example, the Busy signal can include, or |
| | can be sent in conjunction with, a unique identifier for the |
| | VMM system that is sending the Busy signal. In another |
| | example, each VMM system has its own dedicated Busy |
| | signal. |
| Reset | A Reset signal is a signal to a VMM system instructing it |
| | to erase all of its stored data. |
| Output Enable | An Output Enable signal is a signal enabling a VMM |
| | system to provide output data on the data path. |
| Write Enable | A Write Enable signal is a signal enabling a VMM system |
| | to perform a write operation. |
| Read Enable | A Read Enable signal is a signal enabling a VMM system |
| | to perform a read operation. |
| Set Configuration | A Set Configuration signal is a signal to set the |
| | configuration of one or more VMM systems. For example, |
| | a Set Configuration signal can be used to set the bit-width |
| | of input and output operations (e.g., 8 bits, 16 bits). |
| Reset Configuration | A Reset Configuration signal is a signal to set the |
| | configuration of one or more VMM systems to a default |
| | configuration. |
| Recall Configuration | A Recall Configuration signal is a request from a device to |
| | a VMM system requesting the VMM system to provide its |
| | current configuration setting. |
| Clock | A Clock signal is a clock signal provided from the external |
| | device to the VMM systems. |

Optionally, interface 5002 can implement legacy interface standards, such as the AXI (Advanced extensible Interface), the HBM (High Bandwidth Memory), UCI (Universal Command Control Interface), or PCIex standards, without limitation. Optionally, interface 5002 can implement a legacy interface standard and can include one or more additional lines. For example, the one or more additional lines can be used to carry one or more control signals 5501 that are not already carried by the legacy interface standards, such as the Device Control signal.

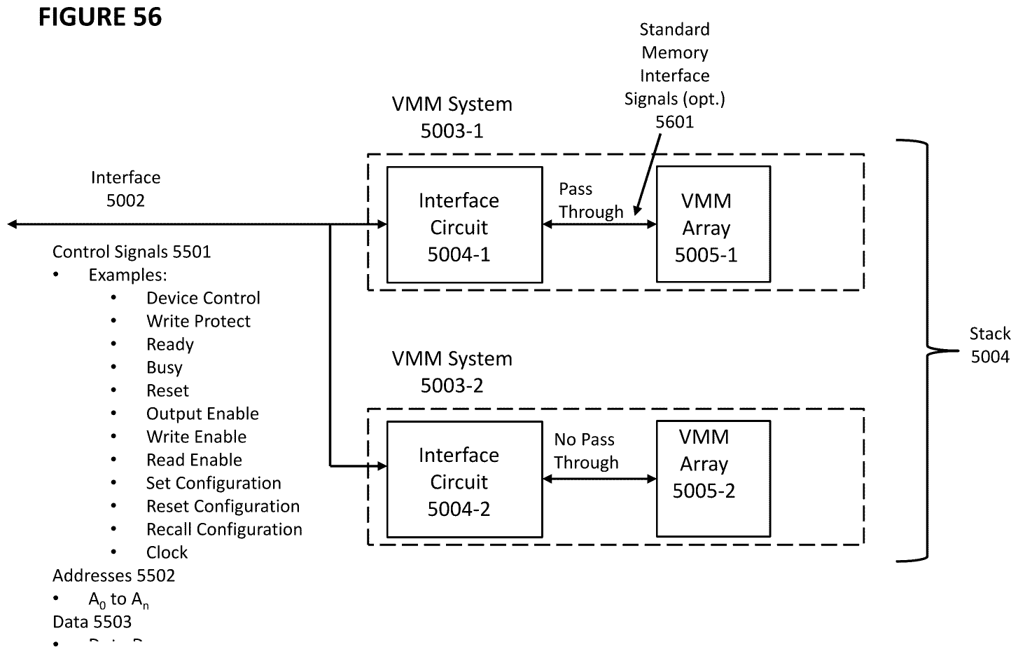

FIG. 56 depicts interface 5002 coupled to VMM systems 5003-1 and 5003-2. In this example, VMM systems 5003-1 and 5003-2 are contained in stack 5005. Alternatively, VMM systems 5003-1 and 5003-2 can be contained in different stacks 5005. Interface circuits 5004-1 and 5004-2 receive control signals 5501 from interface 5002 and determine whether the control signals 5501 are intended for the VMM system associated with the respective interface circuit 5004. In one example, interface circuits 5004-1 and 5004-2 receive a Device Control signal over interface 5002 and determine whether the Device Control signal enables or does not enable the device containing a VMM system associated with the interface circuit. In the example shown in FIG. 56, the Device Control signal enables a device (e.g., a chip or a die) containing VMM system 5003-1 and does not enable a device (e.g., a chip or a die) containing VMM system 5003-2. VMM System 5003-1 then performs the operation sent in conjunction with or subsequent to the Device Control signal. Optionally, interface circuits 5004-1 and 5004-2 can be respectively coupled to VMM arrays 5005-1 and 5005-2 over standard memory interfaces 5601 such as SPI (Serial Peripheral Interface) because the respective interface circuit 5004 controls one or a limited number of VMM arrays which are withing the capability of standard memory interfaces. This is because interface circuits 5004 perform interpretation of the Device Control signals and do not pass on that information to the VMM arrays.

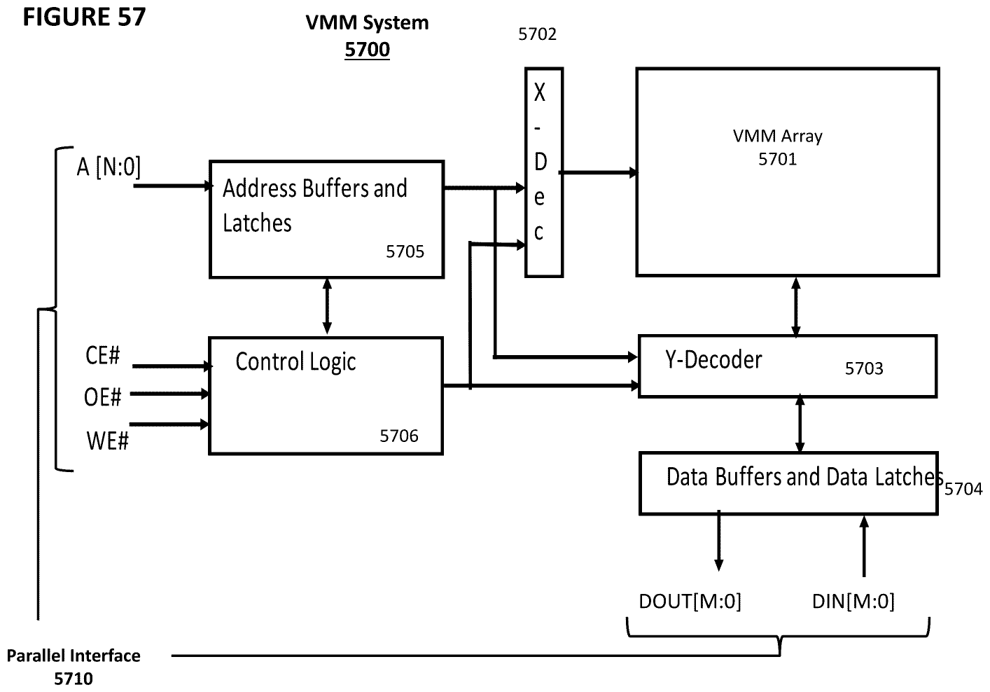

FIG. 57 depicts VMM system 5700 comprising parallel interface 5710 that can be used for interface 5002. Parallel interface 5710 is a modified version of a legacy parallel interface as described below in Table No. 10. VMM system 5700 comprises VMM array 5701, row decoder 5702, column decoder 5703, data buffers and data latches 5704, address buffers and latches 5705, and control logic 5706. Parallel interface 5710 comprises the following lines (which might comprise pins, balls, wires, electrical traces, or other electrical paths): address lines A[N:0] to carry N+1 address bits in parallel; CE #line to carry a chip enable signal (which notably is designed to enable only a single chip); OE #line to carry an output enable signal; WE #line to carry a write enable signal; data output lines DOUT [M:0] to carry M+1 output data bits in parallel; and data input lines DIN [M:0] to carry M+1 input data bits in parallel. Parallel interface 5710 comprises three control lines (CE #, OE #, and WE #) and carries few control signals than shown in FIG. 56 for interface 5002.

Table No. 10 contains line count information for various versions of parallel interface 5710 (listed as parallel interfaces 5710a, 5710b, 5710c, 5710d, 5710e, and 5710f) as well as for various legacy parallel interfaces.

TABLE NO 10
LINE COUNT FOR PARALLEL INTERFACES

| | Capacity | Address | Control | I/O | Total |
|---|---|---|---|---|---|
| | Mbit | Lines | Lines | Lines | Lines |
| Legacy Interface | 64 | 22 | 3 | 16 | 41 |
| Legacy Interface | 128 | 23 | 3 | 16 | 42 |
| Legacy Interface | 256 | 24 | 3 | 16 | 43 |
| Parallel Interface 5710a | 64 | 21 | 3 | 32 | 56 |
| Parallel Interface 5710b | 64 | 20 | 3 | 64 | 87 |
| Parallel Interface 5710c | 64 | 19 | 3 | 128 | 150 |
| Parallel Interface 5710d | 64 | 21 | 3 | 32 | 88 |
| Parallel Interface 5710e | 128 | 20 | 3 | 64 | 151 |
| Parallel Interface 5710f | 256 | 19 | 3 | 128 | 278 |

In Table No. 10, the Capacity column refers to the storage capacity of VMM array 5701; the Address Lines column refers to the number of address lines, meaning the value of N+1; the Control Lines column refers to the number of control lines (such as CE #, OE #, and WE #); I/O Lines refers to the total number of data output lines and data input lines, meaning the value of 2*(M+1); and the Total Lines column refers to the sum of the address lines value, the control lines value, and the I/O lines value, meaning the sum of the previous three columns. Power supply lines are not included in the total lines value. Parallel interfaces 5710a, 5710b, 5710c, 5710d, 5710e, and 5710f use a larger number of total lines than the legacy interfaces discussed in Table No. 10 but can perform I/O operations faster than the legacy interface since they have more lines for output operations and more lines for input operations.

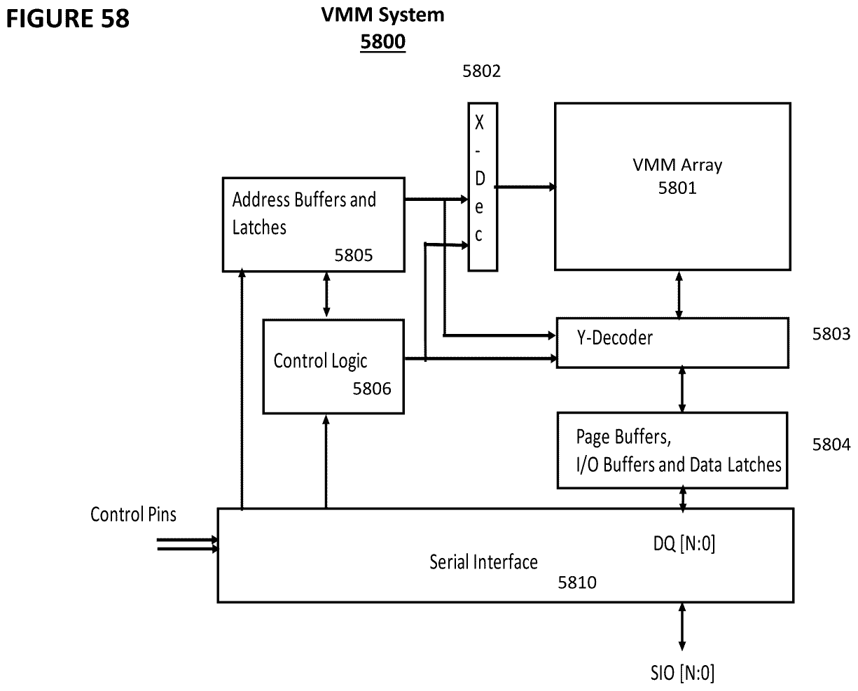

FIG. 58 depicts VMM system 5800 comprising serial interface 5810 that can be used for interface 5002. Serial interface 5810 is a modified version of legacy serial interfaces known as QSPI (Quad SPI) and OSPI (Octal SPI) to provide a wider I/O interface with higher transfer bandwidth as described below in Table No. 11. VMM system 5800 comprises VMM array 5801; row decoder 5802; column decoder 5803; page buffers, I/O buffers, and data latches 5804; address buffers and latches 5805; and control logic 5806. Serial interface 5810 comprises N+1 lines (which might comprise pins, balls, wires, electrical traces, or other electrical paths) to carry address signals, I/O signals (which include data input signals and data output signals in a time-multiplexed manner), and control signals. A version of serial interface 5810 based on the QSPI legacy serial interface can include control pins carrying signals CE #(chip enable), WP #(write protect), HOLD #(hold), SCK (clock) and 4 lines for I/O signals [3:0]. A version of serial interface 5810 based on the OSPI legacy serial interface can include control signals CE #(chip enable), WP #(write protect), HOLD #(hold), RESET #(reset), INT #(interrupt), DQS (data strobe), SCK (clock) and 8 lines for I/O signals [7:0].

Table No. 11 contains line count information for various versions of serial interface 5810 (listed as serial interfaces 5810a, 5810b, and 5810c) and for various versions of a legacy QSPI serial interface.

TABLE NO 11
LINE COUNT FOR SERIAL INTERFACES

| | Capacity | Control | SIO | Total |
|---|---|---|---|---|
| | Mbit | Lines | Lines | Lines |
| Legacy Interface | 64 | 7 | 4 | 11 |
| Legacy Interface | 128 | 7 | 4 | 11 |
| Legacy Interface | 256 | 7 | 4 | 11 |
| Serial Interface 5810a | 64 | 7 | 32 | 39 |
| Serial Interface 5810b | 128 | 7 | 64 | 71 |
| Serial Interface 5810c | 256 | 7 | 128 | 135 |

In Table No. 11, the Capacity column refers to the storage capacity of VMM array 5701; the Control Lines column refers to the number of control lines (such as CE #, OE #, and WE #); SIO Lines refers to the total number of serial IO lines; and the Total Lines column refers to the sum of the Control Lines and SIO Lines, meaning the sum of the previous two columns. Power supply lines are not included in the total lines value. Serial interfaces 5810a, 5810b, and 5810c use a larger number of total lines than the legacy interfaces discussed in Table No. 11 but can perform I/O bandwidth operations faster than the legacy interface since they have more lines for serial I/O output operations. Other SIO lines such as 8 or 16 are possible.

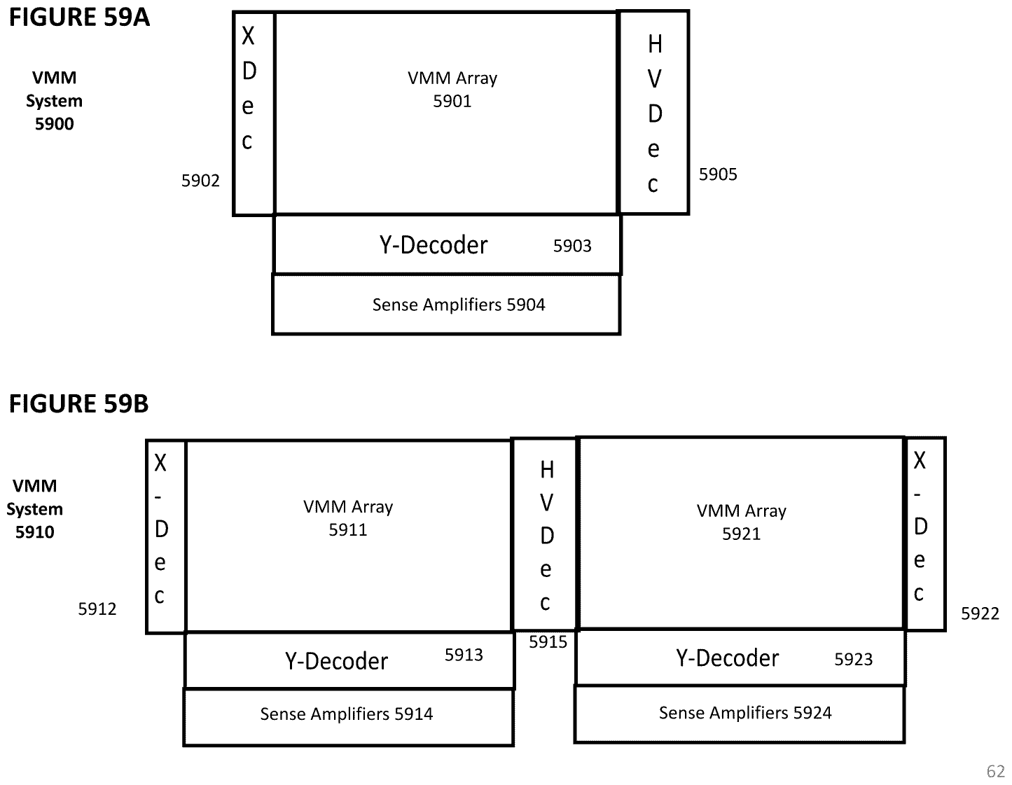

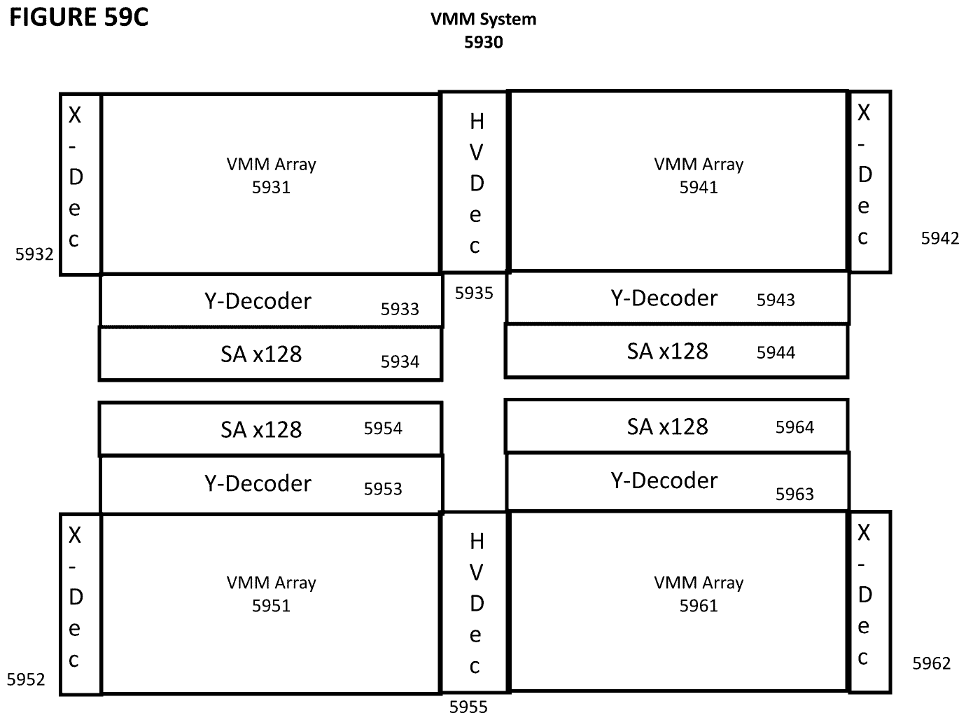

FIGS. 59A, 59B, and 59C depict various VMM system configurations that can utilize serial interface 5810 described previously with reference to FIG. 58.

FIG. 59A depicts VMM system 5900, which comprises VMM array 5901, row decoder 5902, column decoder 5903, sense amplifiers 5904, and high voltage decoder 5905.

FIG. 59B depicts VMM system 5910, which comprises VMM arrays 5911 and 5921, row decoders 5912 and 5922, column decoders 5913 and 5923, sense amplifiers 5914 and 5924, and shared high voltage decoder 5915.

FIG. 59C depicts VMM system 5930, which comprises VMM arrays 5931, 5941, 5951, and 5961; row decoders 5932, 5942, 5952, and 5962; column decoders 5933, 5943, 5953, and 5963; sense amplifiers 5934, 5944, 5954, and 5964; and shared high voltage decoders 5935 and 5955.

Table No. 12 contains line count and sense amplifier count information for VMM systems 5900, 5910, and 5930 compared to comparable legacy VMM systems.

TABLE NO 12
LINE COUNT AND SENSE AMPLIFIER
COUNT FOR VMM SYSTEMS

| | Capacity | SIO | Sense | IO WIDTH |
|---|---|---|---|---|
| | Mbit | Lines | Amplifiers | FOR PAGE |
| Legacy OSPI System | 64 | 4 | 16 | 128 |
| Legacy OSPI System | 128 | 8 | 32 | 128 |
| VMM System 5900 | 64 | 32 | 128 | 128 |
| VMM System 5910 | 128 | 64 | 256 | 128 |
| VMM System 5930 | 256 | 128 | 512 | 128 |

In Table No. 12, the Capacity column refers to the storage capacity of the VMM arrays; the SIO Lines column refers to the number of serial IO lines; the Sense Amplifiers column refers to the number of sense amplifiers; the IO Width For Page column refers to the IO width that is used for a page of data, where a page typically comprises data in two or more rows of memory cells. VMM systems 5900, 5910, and 5930 can perform I/O operations faster than the legacy OSPI systems since they have more lines for serial I/O output operations.

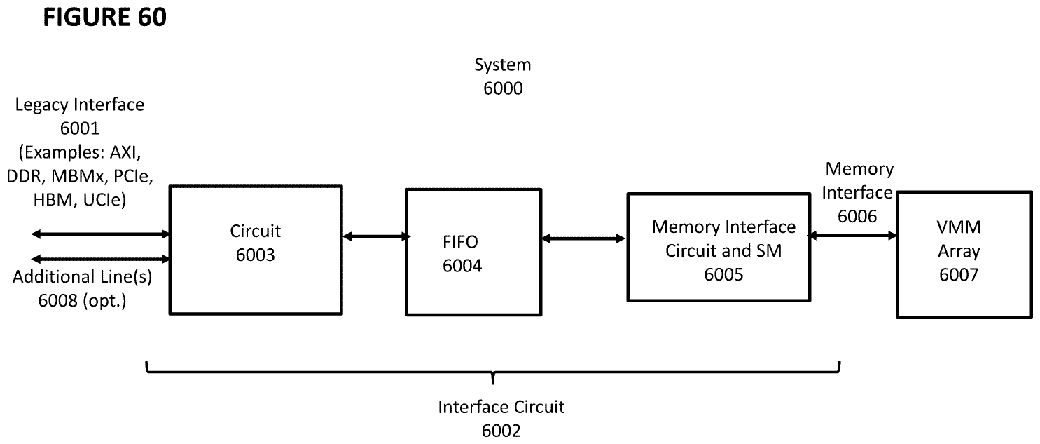

FIG. 60 depicts system 6000 that uses a legacy interface 6001 (such as an AXI, DDR, MBMx, PCIe, HBM, UCIe, or other interface) and, optionally, additional line(s) 6008, which together can be used for interface 5002 in FIG. 50, to interact with components outside of system 6000. For example, additional line(s) 6008 can be used to carry one or more control signals 5501 (not shown) that are not already carried by legacy interface 6001, such as Device Control signals discussed in Table No. 9, above. System 6000 comprises interface circuit 6002. Interface circuit 6002 comprises circuit 6003 to communicate with legacy interface 6001, FIFO 6004, memory interface circuit and state machine 6005, memory interface 6006 (such as a Serial Peripheral Interface), and VMM array 6007. Memory interface 6006 is a second legacy memory interface. Interface circuit 6002 translates communications received on legacy interface 6001 into communications that it sends on memory interface 6006, and interface circuit 6002 translates communications received on memory interface 6006 into communications that it sends on legacy interface 6001.

Table No. 13 contains the line count for legacy interface 6001 for an example where legacy interface 6001 comprises an AXI interface with various read and write line sizes.

TABLE NO 13
LINE COUNT FOR SYSTEM 600 OF VARIOUS R/W SIZES

| Address-R | Address-W | Control | DATA-R | DATA-W | |
|---|---|---|---|---|---|
| Lines | Lines | Lines | Lines | Lines | Total Lines |
| 32 | 32 | 36 | 16 | 16 | 137 |
| 32 | 32 | 36 | 32 | 32 | 171 |
| 32 | 32 | 36 | 64 | 64 | 239 |
| 32 | 32 | 36 | 128 | 128 | 375 |

In Table No. 13, the Address-R column indicates the line count for the read address lines; the Address-W column indicates the line count for the write address lines; the Controls column indicates the line count for the control lines; the DATA-R indicates the line count for read data; the DATA-W column indicates the line count for write data; and the total lines column indicates the total line count.

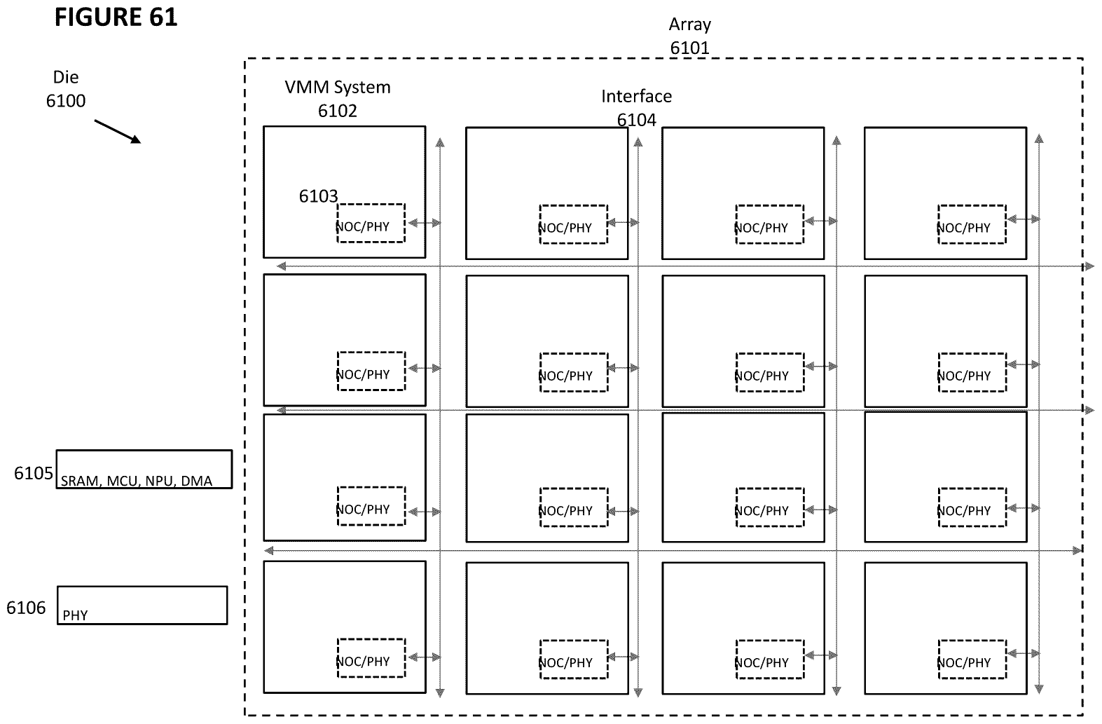

FIG. 61 depicts die 6100. Die 6100 comprises array 6101, which is an array of VMM systems arranged in rows and columns that are coupled by interface 6104. Example VMM system 6102 is illustrative of the VMM systems in array 6101. VMM system 6102 comprises PHY block 6103 (which optionally comprises a network-on-chip) that connects to interface 6104. Die 6100 comprises circuits 6105, that can include an SRAM, microcontroller, NPU, and DMA. Die 6100 comprises PHY block 6106 that connects to an interface outside of die 6100 over interface 5002 (not shown).

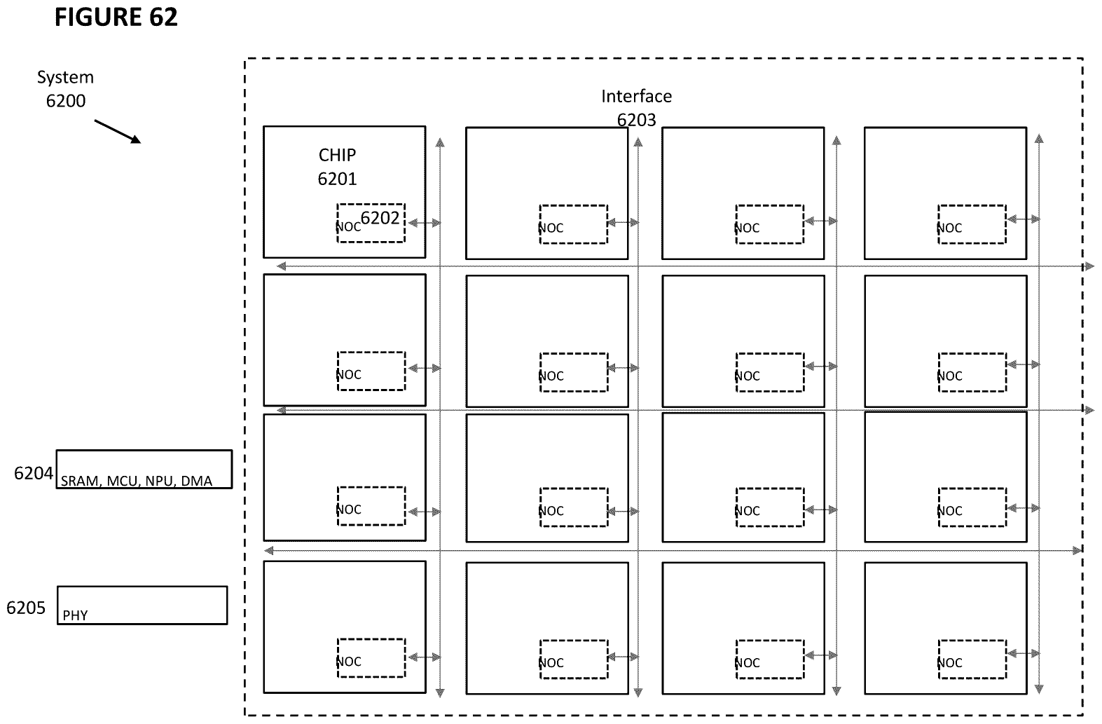

FIG. 62 depicts system 6200. System 6200 comprises a plurality of chips such as example chip 6201. Each chip comprises an NOC, such as NOC 6202 in chip 6201. The NOCs in each chip connect to one another over interface 6203, which can be a PCIex interface, UCIe interface, BOW interface, or any other interface. System 6200 also comprises circuits 6204, that can include an SRAM, microcontroller, NPU, and DMA. System 6200 also comprises PHY block 6205 that connects to interface 6203 as well as an interface outside of system 6200 over interface 5002 (not shown).

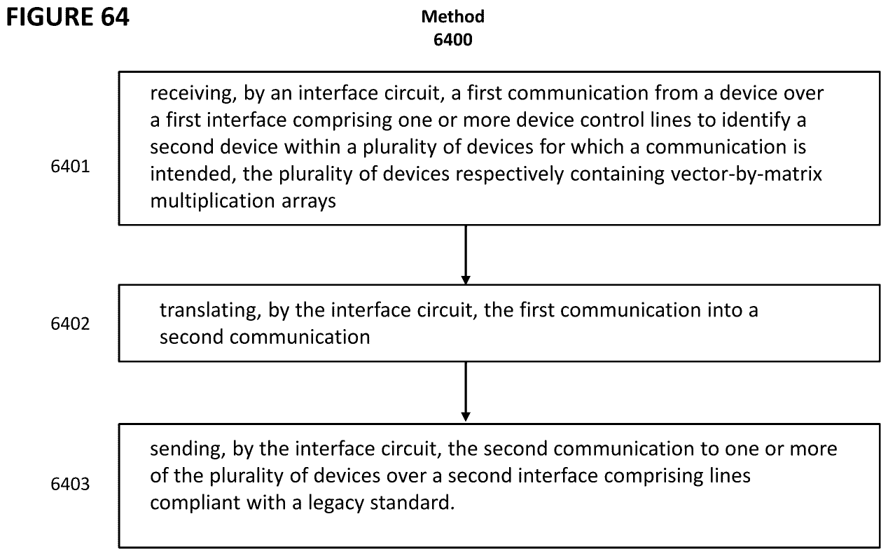

FIG. 64 depicts method 6400 that can be performed by any of interface circuits 4901, 5004, 5416, 5429, or 6002 described previously. The method comprises receiving, by an interface circuit, a first communication from a device over a first interface comprising one or more device control lines to identify a second device within a plurality of devices for which a communication is intended, the plurality of devices respectively containing vector-by-matrix multiplication arrays (6401); translating, by the interface circuit, the first communication into a second communication (6402); and sending, by the interface circuit, the second communication to one or more of the plurality of devices over a second interface comprising lines compliant with a legacy standard (6403). Optionally, the second communication can be sent only to the second device. Optionally, the second communication can be sent to the plurality of devices and all but the second device will ignore the second communication.

It should be noted that, as used herein, the terms “over” and “on” both inclusively include “directly on” (no intermediate materials, elements or space disposed therebetween) and “indirectly on” (intermediate materials, elements or space disposed therebetween). Likewise, the term “adjacent” includes “directly adjacent” (no intermediate materials, elements or space disposed therebetween) and “indirectly adjacent” (intermediate materials, elements or space disposed there between), “mounted to” includes “directly mounted to” (no intermediate materials, elements or space disposed there between) and “indirectly mounted to” (intermediate materials, elements or spaced disposed there between), and “electrically coupled” includes “directly electrically coupled to” (no intermediate materials or elements there between that electrically connect the elements together) and “indirectly electrically coupled to” (intermediate materials or elements there between that electrically connect the elements together). For example, forming an element “over a substrate” can include forming the element directly on the substrate with no intermediate materials/elements therebetween, as well as forming the element indirectly on the substrate with one or more intermediate materials/elements there between.

What is claimed is:

1. A system comprising:
a first device;
a first interface coupled to the first device and comprising one or more device control lines to identify a second device within a plurality of devices for which a communication is intended, the plurality of devices respectively containing vector-by-matrix multiplication arrays; and
a stack comprising an interface circuit coupled to the first interface, the plurality of devices, and a second interface comprising lines compliant with a legacy standard, the second interface coupled between the interface circuit and the plurality of devices.

2. The system of claim 1, wherein the second device is a chip.

3. The system of claim 1, wherein the second device is a die.

4. The system of claim 1, wherein the first interface is a serial interface.

5. The system of claim 1, wherein the first interface is a parallel interface.

6. The system of claim 1, wherein the second interface is a Serial Peripheral Interface.

7. The system of claim 1, wherein the vector-by-matrix multiplication arrays comprises a first vector-by-matrix multiplication array providing a digital compute-in-memory function and a second vector-by-matrix multiplication array providing an analog compute-in-memory function.

8. The system of claim 1, comprising:
a second stack comprising a second interface circuit coupled to the first interface, a second plurality of devices, and a third interface comprising lines compliant with a second legacy standard, the third interface coupled between the second interface circuit and the second plurality of devices.

9. The system of claim 8 comprising:
an interconnect between the stack and the second stack.

10. The system of claim 1, wherein the first device comprises a processor.

11. The system of claim 1, wherein the first device comprises a server.

12. The system of claim 1,
wherein one or more of the vector-by-matrix multiplication arrays implement a static matrix multiplier and one or more of the vector-by-matrix multiplication arrays implement a dynamic matrix multiplier.

13. The system of claim 12, wherein the dynamic matrix multiplier performs a multiplication Q*K_{T}, where Q is a matrix representing a query, K is a matrix of keys, V is a matrix of values where each value forms a key-value pair with a key in K.

14. The system of claim 12, wherein the dynamic matrix multiplier performs a multiplication (Q*K_{T})*V, where Q is a matrix representing a query, K is a matrix of keys, V is a matrix of values where each value forms a key-value pair with a key in K.

15. The system of claim 12, wherein the dynamic matrix multiplier implements a transformer neural network.

16. A method comprising:
receiving, by an interface circuit, a first communication from a first device over a first interface comprising one or more device control lines to identify a second device within a plurality of devices for which a communication is intended, the plurality of devices respectively containing vector-by-matrix multiplication arrays;
translating, by the interface circuit, the first communication into a second communication; and
sending, by the interface circuit, the second communication to one or more of the plurality of devices over a second interface comprising lines compliant with a legacy standard.

17. The method of claim 16, wherein the first interface is a serial interface.

18. The method of claim 16, wherein the first interface is a parallel interface.

19. The method of claim 16, wherein the second interface is a Serial Peripheral Interface.
